(19) United States
(12) Patent Application Publication
(10) Pub. No.: US 2015/0051948 A1
(43) Pub. Date: Feb. 19, 2015

(54) BEHAVIORAL ATTRIBUTE ANALYSIS METHOD AND DEVICE

(71) Applicant: Hitachi, Ltd., Tokyo (JP)

(72) Inventors: Toshiko Aizono, Tokyo (JP); Kei Suzuki, Tokyo (JP)

(21) Appl. No.: 14/367,422

(22) PCT Filed: Dec. 6, 2012
(86) PCT No.: PCT/JP2012/081662

§ 371 Date: Jun. 20, 2014

(30) Foreign Application Priority Data
Dec. 22, 2011 (JP) 2011-282015

(51) Int. Cl. G06Q 30/02

(52) U.S. Cl. CPC G06Q 30/0201
USPC 705/7.29

(57) ABSTRACT

Provided is a technology for extracting a user behavior pattern from history data accumulating personal behaviors, and enabling exhaustive and efficient analysis of a user behavior tendency or features from various aspects, such as location and time, using the pattern. A behavioral characteristics analysis device according to the present invention expresses a behavior pattern by scene vectors describing behaviors of a set of persons as scene values in each time band, extracts a life pattern included in all of the set of persons by clustering the scene vectors, and performs classification based on to which life pattern each person belongs (see FIG. 1).

### TECHNICAL FIELD

The present invention relates to methods and devices for classifying an analysis object using personal behavioral characteristics.

### BACKGROUND ART

Wireless communication records between portable communication devices, such as portable telephones, and their base station, or automobile probe information in road traffic systems represent a history of movement of persons. Similarly, the utilization history of transit-system IC cards may be said to represent personal movement history. When the transit-system IC card has an electronic money function, the card may be considered to be accumulating personal behavior history in terms of shopping as well as movement history. From the aspect of shopping, the credit card utilization history is also a personal behavior history. Personal biological information (such as body temperature, pulse, and arm acceleration) measured using sensor terminals that can be attached to a person provide personal behavior history from a physiological aspect.

These histories represent what persons did and when and where they did it, although what remains in the history of the daily life may differ among persons because of different purposes or means of the record. Services for extracting personal behavior patterns from these various personal behavior histories and providing information that matches individual users, and technologies for using the information for marketing are disclosed in the following Patent Literature 1 and Patent Literature 2.

Patent Literature 1 discloses a technology for extracting user movement or shopping behavior patterns from the utilization history of a transit-system IC card, and for providing information that matches the behavior of the user by using the patterns. In Patent Literature 1, the behavior pattern refers to a list of stations or shops that the user of the transit-system IC card used. By using the pattern, the user's movement or shopping tendency can be learned.

Patent Literature 2 discloses a technology where a user's shop-visit history is accumulated by using a mobile terminal carried by the user and wireless stations installed at shops, the technology extracting the user's shop transition pattern from the shop-visit history, and delivering to the user information about a shop the user is likely to visit next based on the pattern user. In Patent Literature 2, the behavior pattern refers to a list of the IDs (identifiers) of the shops that the user visited next with regard to certain shops, the number of times of visits to the shops, and the shop-to-shop transition probabilities based on the number of times of visits to the shops. By creating the behavior pattern for each user, the user's shop utilization tendency can be learned.

### CITATION LIST

### Patent Literature

Patent Literature 1: JP Patent Publication (Kokai) 2010-157055A
Patent Literature 2: JP Patent Publication (Kokai) 2004-070419A

### SUMMARY OF THE INVENTION

### Technical Problem

While the use of the behavior patterns disclosed in the Patent Literatures 1 and 2 makes it possible to learn the user's behavior tendency for movement or shopping and to realize personally matched services, the technologies have the following problem.

### (Problem No. 1)

The behavior patterns described in Patent Literatures 1 and 2 do not take into consideration “when” the user utilized the station, facility, or shop name. For example, in the case where users of a certain station utilize a convenience store in the station building, the purpose of utilization may be considered different between a user who utilizes the store early morning, a user who utilizes the store during daytime, and a user who utilizes the shop only on weekday or holiday. However, in Patent Literatures 1 and 2, the various behavior patterns are handled as the same pattern. Thus, what can be learned from the user's behavior pattern is only from the “location” aspect, i.e., the station, facility, or shop, and it is difficult to learn the user's tendency from the “time” aspect in terms of early morning, daytime, weekday/holiday, and the like.

### (Problem No. 2)

As the number of users or the period in which the behavior history is acquired increases, the number of behavior patterns increases explosively, making it difficult to learn the user's tendency exhaustively. The behavior patterns described in Patent Literature 1 have the stations, facilities, and shop names that the users utilized as the patterns' characteristics. The behavior pattern described in Patent Literature 2 has a code of the shop or facility as the pattern's characteristics. Thus, the patterns are different for different stations, facilities, or shops. Accordingly, by the technologies described in these literatures, innumerable behavior patterns are generated. Practically, therefore, only those “common”, i.e., highly frequent, patterns are used as the analysis objects based on the patterns' frequency of appearance. In this case, however, it is difficult to notice a pattern where shops with different shop names but of the same type are repeatedly utilized, or a pattern where, although the utilization frequency by individual users is low, a specific overall tendency can be observed (such as going out by train after a visit to a barber's shop).

In order to extract users' behavior patterns from the users' behavior histories and use them for providing information or for marketing, it is desirable to be able to analyze the users' behavior on more than a certain scale (such as more than 10,000 persons) and in an exhaustive manner. However, the technologies described in Patent Literatures 1 and 2 suffer from the problem of aspect diversity and process efficiency.

The present invention was made to solve the above problem and provides a technology for extracting user behavior patterns from history data in which personal behaviors are accumulated, and for analyzing, using the patterns, user behavior tendencies or features based on various aspects such as location and time, in an exhaustive and efficient manner.

### Solution to the Problem

A behavioral characteristics analysis device according to the present invention expresses behavior patterns by scene vectors describing behaviors of a set of persons as scene values in each time band, extracts life patterns included in the entire set of the persons by clustering the scene vectors, and performs classification based on to which life pattern each person corresponds.

### Advantageous Effects of Invention

The behavioral characteristics analysis device according to the present invention enables an exhaustive and efficient analysis of user behavior tendency or features from various aspects, such as location and time.

### BRIEF DESCRIPTION OF THE DRAWINGS

FIG. 1 illustrates a configuration of a behavioral characteristics analysis device 1 according to embodiment 1.

FIG. 2 illustrates a hardware configuration of the behavioral characteristics analysis device 1.

FIG. 3 illustrates a data configuration of an IC card utilization history 103.

FIG. 4 illustrates a data configuration of a credit card utilization history 104.

FIG. 5 illustrates a data configuration of a scene list 105.

FIG. 6 illustrates a data configuration of an event list 106.

FIG. 7 illustrates a data configuration of a scene vector table 107.

FIG. 8 illustrates a data configuration of a target scene vector table 205.

FIG. 9 illustrates a data configuration of a life pattern table 206.

FIG. 10 illustrates a data configuration of user information 209.

FIG. 11 illustrates a data configuration of location information 210.

FIG. 12 illustrates a data configuration of calendar information 211.

FIG. 13 illustrates a data configuration of a feature vector table 305.

FIG. 14 illustrates a data configuration of a cluster table 306.

FIG. 15 illustrates an example of an extraction condition 207.

FIG. 16 illustrates an example of an extraction parameter 208.

FIG. 17 illustrates an example of an analysis condition 307.

FIG. 18 illustrates an example of an analysis parameter 308.

FIG. 19 is a flowchart of a process sequence of the behavioral characteristics analysis device 1 according to embodiment 1.

FIG. 20 is a flowchart of a process sequence of step S10.

FIG. 21 is a flowchart of a process sequence of step S20.

FIG. 22 is a flowchart of a process sequence of step S30.

FIG. 23 is a chart describing numerical values representing scene extraction rules and scenes in the behavioral characteristics analysis device 1.

FIG. 24 is a flowchart of a detailed process sequence of step S101 implemented by a scene extraction unit 101.

FIG. 25 is a flowchart of a detailed process sequence of step S201 implemented by a life pattern extraction condition setting unit 201.

FIG. 26 illustrates an example of a life pattern extraction condition setting screen displayed by the life pattern extraction condition setting unit 201.

FIG. 27 illustrates an example of a weighting setting screen displayed by the life pattern extraction condition setting unit 201.

FIG. 28 illustrates an example of a characteristics addition setting screen displayed by the life pattern extraction condition setting unit 201.

FIG. 29 illustrates an example of a parameter setting screen displayed by the life pattern extraction condition setting unit 201.

FIG. 30 illustrates an example of a screen for displaying an extracted life patterns.

FIG. 31 is a flowchart of a detailed process sequence of step S301 implemented by a cluster analysis condition setting unit 301.

FIG. 32 illustrates an example of a life pattern cluster analysis condition setting screen displayed by the cluster analysis condition setting unit 301 in step S301.

FIG. 33 illustrates an example of a life pattern extraction condition display screen displayed when an extraction condition display button 301112 is clicked.

FIG. 34 illustrates an example of a parameter setting screen displayed when a parameter setting instruction button 301131 is clicked.

FIG. 35 is a flowchart of a detailed process sequence of step S302 implemented by a feature vector generation unit 302.

FIG. 36 illustrates an example of a screen for a cluster display unit 304 to display a cluster.

FIG. 37 illustrates an example of a detailed analysis screen.

FIG. 38 illustrates an example of a detailed analysis screen.

FIG. 39 illustrates an example of a circle graph display.

FIG. 40 illustrates an example of a matrix display.

FIG. 41 illustrates a configuration of the behavioral characteristics analysis device 1 according to embodiment 2.

FIG. 42 illustrates a data configuration of a pattern vector table 405.

FIG. 43 illustrates a data configuration of a periodic life pattern table 406.

FIG. 44 illustrates an example of an extraction condition 407.

FIG. 45 illustrates an example of an extraction parameter 408.

FIG. 46 is a flowchart of a process sequence of the behavioral characteristics analysis device 1 according to embodiment 2.

FIG. 47 is a flowchart of a process sequence of a periodic life pattern extraction unit 40.

FIG. 48 illustrates an example of a periodic life pattern extraction condition setting screen in a pattern extraction condition setting unit 401.

FIG. 49 illustrates an example of a parameter setting screen displayed when a parameter setting instruction button 40141 is clicked.

FIG. 50 illustrates an example of a screen on which generated clusters are expressed by a periodic life pattern display unit 404 as the day's pattern transition and displayed to an analyst.

FIG. 51 illustrates an overall configuration of the behavioral characteristics analysis device 1 according to embodiment 3.

### DESCRIPTION OF EMBODIMENTS

In the following, the concept of the present invention will be initially described, and then specific embodiments will be described.

### <Outline of the Present Invention>

In the present invention, an analysis object is analyzed using the behavioral characteristics of a set of persons, using three techniques of (1) scene vector generation to (3) life pattern cluster analysis. In the (1) scene vector generation, a behavior history is expressed as a scene vector as will be described later. In the (2) life pattern extraction, life patterns are extracted from a set of scene vectors. In the (3) life pattern cluster analysis, classification is performed based on to which life pattern the analysis object belongs. In the following, the outline of each technique will be described.

### (1) Scene Vector Generation

In the present invention, in order to enable the learning of user behavior tendency not just in terms of location but also from various aspects, such as time and purpose of behavior, the day of the user is considered to be a transition of “scenes”, and the personal behavior is expressed by vectors (referred to as “scene vectors”) having time (or a time band) as an element number and values representing the scene as element values. For example, when the user's behavior is expressed as a scene transition on an hourly basis, the scene vector has 24 (corresponding to the 24 hours of the day) elements, with the element values representing the scenes that the user went through on an hourly basis. Specifically, the scene vectors are generated by the following process.

### (1.1) Scene Extraction

The scenes refer to the times that a person spent at certain locations with certain purposes, such as “spending time at home”, “spending time at work or school”, or “going out for fun”. The number of scenes the person goes through in a day is considered to be 10 at most. According to the present invention, the scenes are estimated and extracted based on the time of movement, the duration that the person stayed at the location to which he moved, the frequency of stay at the location, and the like that are recorded in the user's behavior history. Specifically, the location at which he stayed for a long time from morning till evening/night on a weekday is estimated to be “WORKPLACE” or “SCHOOL”; the location at which he stayed from evening/night to the morning of the next day regardless of the day of the week is estimated to be “HOUSE”; and the location at which he stayed for a short time during the daytime or evening of a holiday is considered to be a location for “SHOPPING” or “LEISURE/REST”. In this case, it is considered that the user went through the respective scenes of “WORK”, “HOME”, and “PRIVATE”. The scenes that can be extracted differ depending on the characteristics of the behavior history that is utilized. For example, when the utilization history of a transit-system IC card with a student ID card or employee ID card function is utilized, scenes such as “spending time in library”, “spending time in 5F living room”, or “spending time in 6F conference room” may be extracted from the entry/exit control record.

Some of the “scenes” that a person goes through with a certain purpose at a certain location may take hours, and some others may take only a few seconds or several tens of minutes, such as “make a phone call”, “buy something (pay)”, “have (simple) meal”. According to the present invention, the latter mode of spending a relatively short time is referred to as an “event” as distinguished from the “scene”. The events that can be extracted from the personal behavior history may include, e.g., an event called “calling” from the portable telephone movement history, or an event called “payment” from the utilization history of the transit-system IC card with the electronic money function. If the users can be associated with them, an event may be extracted from a plurality of behavior histories. For example, when an automobile user is a member of a fee-based service using probe information (such as “provision of information by an operator”), and if the payment of the fee is done using a credit card affiliated with an automobile company, the automobile user and the credit card user can be tied to each other. Thus, by utilizing the automobile probe information as a personal behavior history, and by further utilizing the credit card utilization history as a second history, a “payment” at a shop may be extracted as an event in addition to the scene estimated from the movement. By thus associating a main behavior history with the user, various histories may be utilized as the second history for extracting events. Examples are the utilization history of a membership card or point card of a shop (for events such as shop-visits and purchases), and the Web access history of a membership HP (for events such as Web viewing and ordering for Internet shopping). The associating of the users that appear in the respective histories, i.e., name-based aggregation, can be realized by utilizing registered information, such as name, sex, and address.

The scene transition of the day basically comprises hourly scenes as the objects, and an “event” is considered to take place in a “scene”. For example, “shopping” is an event that takes place in the scene “going out for fun”. However, depending on the purpose of analysis, an event lasting several tens of minutes may be handled as a scene. For example, when it is desired to analyze how an employee spent a day by focusing on the employee's company life by using the utilization history of the aforementioned transit-system IC card with the employee ID card function, the spending of time of “having a meal in company cafeteria” may be handled as a scene.

The extracted scenes and events are expressed by elements of “who” went through “what” scene/event “when” and “where”. The specific value of each element is determined by the characteristics of the behavior history from which the scene and event have been extracted. In the case of the utilization history of the transit-system IC card, “who” corresponds to the user ID of the IC card; “when” to the time at which the IC card touched a ticket gate or a card terminal machine; “where” to the name of station where the ticket gate is located or the name of a shop at which the terminal machine is installed; and “what scene” to the name of the scene or event that can be extracted from the utilization history of the IC card. When the wireless communication record of a portable telephone with its base station, or automobile probe information is utilized, “where” may correspond to the position information (latitude/longitude) of the base station or the automobile. In the case of the “payment” event extracted from the utilization history of the credit card as described above, “where” corresponds to the shop name, so that “how much” (amount) can be extracted in addition to the four elements.

### (1.2) Conversion of Scene to Numerical Value

Then, in order to express the day using the scene vectors, the extracted scenes are converted into numerical values. The conversion of the scenes to numerical values may be performed by the following method, for example. First, when the number of extractable scenes is set to N, the value of the scene with the highest frequency of appearance is “1”, and the value of the scene with the next highest frequency of appearance is set to “N”. The value of the scene with the next highest frequency is set to “N-1”, and further the value of the scene with the next highest frequency is set to “N-2”, and similarly the values of N scenes are set. In this way, during the clustering for life pattern extraction as will be described below, of the scenes that appeared at the same time, the scenes with high frequency of appearance can be located at spaced-apart positions on a vector space.

The values of the scenes are not limited to “1”, “N”, “N-1”, and so on. The value of the scene with the highest frequency may be set to “N”, and the values of the scenes with the next highest frequencies may be set to “1”, “2”, “3”, and so on, or to fractional values between 1 and 0. As described above, the order of determination of the values of the scenes is the order of decreasing frequency of appearance. However, the frequency that a plurality of scenes appear simultaneously on the same day may be calculated as a co-occurring frequency or a co-occurring probability, and, when the value of the scene with the highest frequency of appearance is “1”, the value of a scene that tends to appear simultaneously with that scene may be set to “N”, and the value of a scene that tends to appear simultaneously with this scene may be set to “N-1”, and so on.

Alternatively, the value corresponding to each scene may be set arbitrarily by the analysis system administrator taking the meaning of each scene into consideration. Specifically, “HOME” and “PRIVATE”, which relate to private scenes, may be assigned “1” and “2”, respectively, while “WORK” may be assigned “5” so as to distinguish from the private scenes.

### (1.3) Setting of Scene Vector Values

According to the present invention, in order to capture the day of the users in terms of scene transition, the day of the users is expressed by the scene vector by having the time (or time band) as the element number. The range of the day may be defined in various ways, such as from 0 a.m. to the next 0 a.m., or 4 in the morning to 4 in the morning of the next day. The time may be on an hourly basis, half-hour basis, and the like, and may not be in units of a certain length; for example, the time may be on a half-hour basis for daytime when there is much activity, while it may be on a two-hour basis for late at night. The vectors are generated by setting the numerical value representing the scenes that the users went through at each time of the scene vector.

In order to allow for an efficient analysis of the user behavior tendency or features from various aspects, the scene vectors may be generated from the behavior history in advance, and then life patterns may be extracted by performing extraction or processing using the scene vectors as basic data in accordance with the purpose of analysis.

It is considered that the day's scene transition will have a somewhat similar tendency for the same person, or even for different persons as long as the occupation (company employee, student, etc.), the generation, sex, and the like are the same. In this case, it can be expected that the data would be redundant if the scene vector data is generated on a user-by-user basis or on a daily basis. Accordingly, a unique scene vector list may be generated in advance, and user-by-user data or daily data may comprise pointers to the list. In this way, a vast amount of data can be efficiently accumulated.

### (2) Life Pattern Extraction.

It is expected that the day's scene transition will have several typical patterns, such as being at home at night and being at work or school during daytime. Thus, according to the present invention, the scene vectors representing the day's scene transition are clustered, and patterns of the day's scene transition (referred to as “life patterns”) are extracted. By this process, it can be roughly learned what life patterns exist in the set of persons. Specifically, the life patterns are extracted by the following process.

### (2.1) Setting of Life Pattern Extraction Conditions

First, conditions for narrowing the object persons from which the life pattern is desired to be extracted are set. Specifically, the conditions are set by using the following information.

### (2.1.1) User Characteristics

If user information such as the users' generation, sex, and address is available, the information may be utilized as life pattern extraction conditions. For example, when the object persons are set as “males in their 30's” or “females in their 20's living in the metropolitan area”, the typical ways of going through the day, namely, the life patterns, can be extracted for those of persons in the set of persons that match the conditions.

### (2.1.2) Scene Characteristics

As described above, the scene is expressed by “who” went through “what” and “when” and “where” he went through it. Such characteristics of the scene can be used as life pattern extraction conditions. Example are “persons who have home in the area of latitude x longitude y” (when, what); “persons who came to—station on—month—day” (when, where); and “persons who work on weekday” (when, what). Use of these conditions in the above example enables the extraction of the typical ways that the “persons who have home in the area of latitude x longitude y” go through in the day (such as going to work from home and then coming straight home, or stopping off somewhere on the way home).

### (2.1.3) Event Characteristics

The event is also expressed by “who” went through “what” and “when” and “where” he went through it, as in the case of the scene. In addition, an element that depends on the history of “how much” (amount) may also be present. Examples of the extraction conditions using those are “persons who did shopping in—month—day at—department store” (when, where, what), and “persons who utilized company cafeteria—times or more in—month” (when, where).

### (2.2) Scene Vector Extraction

In accordance with the life pattern extraction conditions described in (2.1), the scene vectors that match the conditions are extracted, and the scene vectors are processed so as to facilitate the extraction of the life patterns matching the purpose of the analysis. Then, the scene vectors as the clustering objects (referred to as “target scene vector”) are generated. The scene vectors matching the conditions can be extracted by referring to the characteristics of the scene/event included in the user information or the vectors. The scene vector processing techniques include, for example, weighting of the scene values and characteristics addition to the scene vectors. These processes may be implemented only when particularly setting the extraction conditions. In the following, scene value weighting and characteristics addition will be described.

### (2.2.1) Scene Vector Weighting

The scene vector weighting refers to a process of converting the scene value so that the scene vectors matching the conditions for narrowing the object person from which the life patterns are desired to be extracted as described in (2.1) have values different from those of the scene vectors that do not match the conditions. In this way, from among the scene vectors that have similar tendencies and that would be lost in the same life pattern as they are, ones that match the extraction conditions can be significantly extracted. As an example of the scene vector weighting, the following describes weighting from the two aspects of weighting by the scene and weighting by the event.

### (a) Weighting by the Scene

According to the present invention, when the day is expressed by the scene transition, namely, by the vectors having as their values numerical values representing the scenes, the scene that the analyst is focusing on is weighted. For example, when the purpose of the analysis is “with respect to users who came to—station in—month—day, what scenes the users went through at the—station”, the scene vectors (the day's scene transition) including the scenes with the date of “—month—day” and the location of “—station” (type of scene does not matter) are initially acquired, and only the scene values with the location “—station” are weighted. For example, the weighting multiplies the values by a factor of 10. Alternatively, in the case of “with respect to users who came to—station in—month, when it is desired to analyze what scenes the users went through at the—station on weekday and holiday separately”, a method may be employed by which, as in the above example, the scene vectors of “users who came to the—station in—month” are acquired and the scenes with the location “—station” are weighted, and further all of the values of the scene vectors with the date corresponding to a holiday (Saturday/Sunday) are multiplied by −1 so that the vectors of a weekday and the vectors of a holiday are spaced apart from each other on the vector space.

In the present example, as a specific means of weighting the scene that the analyst is focusing on, the scene value is multiplied by an integer or −1. However, this is not a limitation, and any means may be employed as long as the scene vectors matching the extraction conditions and other scene vectors can be distinguished. Various weighting means taking the position of the scene vectors on the vector space into consideration may be conceivable.

### (b) Weighting by Event

The scene vector is configured from scene transition, while the events, which indicate the way a relatively short time is spent, are not expressed on the scene vector. In contrast, when the analyst desires to perform an analysis focusing on an event, the scenes in which the event took place, or the time at which the event took place is weighted in the scene vectors.

For example, when the analyst focuses on the event of “payment” by credit card, and wishes to know “in what scene persons who came to—station in—month—day and did shopping at the A department store did the shopping” (in the course of “WORK”? or in the course of “PRIVATE”?), the scene vectors of “those who came to—station in—month—day and who have a credit card utilization history at the A department store” are extracted, and the scenes that include a credit card settlement time are weighted (such as by multiplying their values by a factor of 10). Further, when it is desired to know whether the “payment” event was toward the beginning or end of the scene, only the value at the time corresponding to the settlement time is weighted. For example, when a certain user went through a scene “PRIVATE” in—month—day at—station from 13:00 to 18:00, and when there is a credit card utilization history at 14:00 at the A department store, the value for 14:00 in the scene vectors is multiplied by a factor of 10. When the focused event is “payment”, weighting by the payment amount may be performed. For example, when the payment amount is 30,000 yen or more, the value of the scene is multiplied by a factor of 20, and the values for other amounts are multiplied by a factor of 10.

### (2.2.2) Addition of Vector Characteristics

When it is desired to extract the scene vectors matching the extraction conditions as being different from the other scene vectors, the weighting described in (2.2.1) is thought to be suitable. On the other hand, when it is desired to analyze in greater detail to see what patterns are present in the scene vectors that have once been extracted as the same life pattern (so-called drill-down analysis), it is believed better to add drilling-down preliminary characteristics to the scene vectors in advance, and then to further subdivide the life patterns by referring to the preliminary characteristics when drilling down is required, rather than processing the scene values themselves. The preliminary characteristics are referred to as scene vector characteristics in the present invention, as will be described in the following with reference to scenes where the scene vector characteristics are required.

When it is desired to extract the user life patterns by adding aspects other than the scene, characteristics may be added to the vectors and values corresponding to the aspects may be added. As an example, assume an analysis need that “it is desired to know if there is a generation by generation tendency in the persons who came to—station in—month—day”. In this case, a method may be conceivable by which “persons who came to—station in—month—day” are divided by generation and the respective life pattern is extracted. Specifically, the same number of life patterns (such as 10 patterns) are extracted by generation (such as the six generations of less than 20's, 20's, 30's, 40's, 50's, and 60's or above), and the extracted patterns are combined to provide the life patterns of “persons who came to—station in—month—day”.

However, in this method, the number of the extracted life patterns is large (six generations×10 pattern=60 patterns), and, because the number of users of each generation may be different, the granularity of the generated patterns becomes uneven (for example, when the number of users in their 60's or above is small, the generated patterns may come to have a smaller difference than the patterns of the other generations). With respect to this problem, a method may be conceivable by which, of the extracted life patterns, similar patterns common to the generation are combined. However, the combining would require calculation of similarity among patterns, or determination of the pattern-to-pattern similarity by manpower, thus requiring time and effort.

On the other hand, the analysis need that “among persons who came to—station in—month—day, it is desired to know if there is a tendency in terms of generation” may be interpreted to mean that “if there is a unique pattern to a certain generation, it is desired to extract that portion as the pattern of the generation, and to consolidate common patterns regardless of the generation into a single pattern”, rather than “it is desired to know tendencies of each generation”. In reality, it is believed that there is a strong need for obtaining clustering results flexibly depending on the status of the clustering object data.

In view of the above, it is believed that, for the above analysis need, it is desirable to extract the scene vectors as scene vectors of the same pattern and then drill down the extraction conditions as required, rather than weight the scene vectors and handle the scene vectors matching the extraction conditions as being different from the other scene vectors.

Thus, according to the present invention, in order to address the above need, characteristics are added to the clustering object scene vectors. Examples of the characteristics that may be added include user characteristics such as the user's generation, sex, and address. In the case of the above analysis need, six dimensions (characteristics) of “younger than 20's”, “20's”, “30's”, “40's”, “50's”, and “60's or above” representing the generations are added to the scene vectors, the generation of the users of the scene vectors is acquired by referring to user information and the like, and then “1” is set for the relevant characteristics value while “0” is set for the other characteristics values. Other characteristics that may be utilized for drilling down may include address (addition of five dimensions of “Tokyo”, “Kanagawa Prefecture”, “Saitama Prefecture”, “Chiba Prefecture”, and “others”), user preference obtained by some means (such as the result of a questionnaire; three dimensions of “satisfied with service”, “generally satisfied”, and “not satisfied”).

### (2.3) Scene Vector Clustering

The generated scene vectors are clustered. There are several existing clustering algorithms. For example, the k-means method is a representative algorithm for non-hierarchical clustering, but this is not a limitation. When an algorithm that requires specifying the number of clusters in advance, such as the k-means method, is used, clustering is implemented by setting a default value in advance. Alternatively, clustering may be tried several times while varying the number of clusters, and then the optimum number of clusters may be selected by using a generated cluster evaluation function.

By clustering the scene vectors, clusters combining the scene vectors with similar day's scene transitions are generated. The clusters are sets of scene vectors representing similar behavior patterns, which are referred to by the present invention as “life patterns”. A vector (representative vector) averaging the scene vectors belonging to the cluster may sometimes be referred to as a “life pattern”. Namely, the general tendency of similar scene vectors will be referred to as a “life pattern”. Examples of the life patterns of “persons who came to—station in—month—day” are as follows.

A pattern of leaving home in the morning and coming to—station for work.

A pattern of leaving home in the morning, going to work, and coming to—station for fun after work.

A pattern of leaving home at noon, and coming to—station for fun.

A pattern of leaving home in the evening, and coming to—station for fun.

### (2.4) Life Pattern Display

The life patterns extracted in (2.3) are displayed to the analyst. The result of clustering the scene vectors by the k-means method and the like provides the IDs of the clusters and a list of IDs of the scene vectors belonging to the clusters. If the list is displayed to the analyst as is, or if the center of gravity (average vector) of the cluster is displayed, it will be difficult for the analyst to understand right away what life patterns have been extracted. Thus, according to the present invention, in order to facilitate understanding by the analyst, a “representative scene vector” representing a feature of the cluster is generated, and a scene transition characteristic of each cluster, i.e., the life pattern, is visualized and displayed, as will be described in detailed below.

### (2.4.1) Generation of Representative Scene Vectors

The scene vectors represent a scene transition, the element number of the scene vectors represents each time of the day, and the element values represent the scenes at each time. This structure is also the same for the life patterns. Thus, a typical scene at each time is extracted from the scene vectors belonging to each cluster, and a scene vector having the scene's value as a characteristics value is generated, thus providing a “representative scene vector”. Because the scene vectors and the life patterns (clusters) have the same structure, the representative scene vector of the cluster can be considered the feature of the cluster. Specifically, the representative scene vector is generated through the following sequence.

First, the scene vectors belonging to the clusters are referenced, and the frequency of appearance of a scene or an event is tallied for each time. Of the scenes at each time, the scene (one or more) that has the highest frequency or that occupies a predetermined ratio or more (such as 50% or more) is considered the typical scene at that time, and a numerical value representing that scene is considered the scene value of the representative scene vector corresponding to the time. In this case, a frequency distribution of the scenes at each time may be recorded, and scene distribution information (such as a variance value) may be presented upon instruction by the analyst during the later visualization of the representative scene vector.

### (2.4.2) Visualization of Representative Scene Vector

When the generated representative scene vector is displayed, a color is set for each scene for display. In this way, the scene transition can be more visually grasped. Further, the scene transition may be displayed as a state transition diagram. Specifically, the color of nodes is set for each scene, and further the size of the nodes is set in accordance with the scene length (time length), and the transition between scenes is expressed by arrows. In this way, the feature of the cluster can be more visually grasped.

### (2.5) Supplementation

The life pattern extraction condition setting (2.1), the scene vector extraction (2.2), the scene vector clustering (2.3), and the life pattern display (2.4) are each not limited to single implementation. The behavioral characteristics analysis device 1 according to the present invention is configured such that a desired analysis result can be obtained by repeating trials, such as by re-extracting the scene vectors while varying the life pattern extraction conditions in response to the result of the life pattern display (2.4), and then carrying out clustering. Thus, the extracted life patterns are saved together with the extraction conditions unless there is a deletion instruction from the analyst.

In order to make the trials for pattern extraction by the analyst more efficient, a function for statistical analysis of pattern extraction conditions may be provided. Specifically, the number of scene vectors that match respective items included in an extraction condition may be displayed, or the items may be cross-tabulated and displayed. For example, “persons who came to x station from—month—day to—day” may be tabulated by “date” and “scene when staying at x station” and displayed in a matrix.

In the life pattern display (2.4), in order to allow for drill-down analysis of users matching the cluster of interest to the analyst, a function for enabling the output of the IDs of the users corresponding to the scene vectors belonging to the cluster is provided.

While the above description involved the setting of pattern extraction conditions and the extracting and clustering of the scene vectors, this is not a limitation. When there are basic extraction conditions, and it is desired to extract a life pattern by varying the conditions little by little, life patterns may be initially extracted using the basic extraction conditions, and in the next round and thereafter, scene vectors may be assigned to the life patterns extracted from the basic extraction conditions without clustering. For example, when “it is desired to know the personal life patterns of coming to a certain station on a monthly basis”, life patterns may be initially extracted from several months' worth of behavior history, and an average vector (center of gravity) of each cluster may be calculated. Then, after one month's worth of the latest behavior history has been accumulated, scene vectors as objects (“scene vectors of persons who came to the certain station”) are extracted, and the following process is implemented to each of the scene vectors. Namely, similarity between the scene vectors and the calculated average vector of each cluster is calculated, and the scene vectors are assigned to the cluster of the average vector with the highest similarity. When it becomes impossible to assign the scene vectors to the clusters evenly due to the presence of a bias in the numbers of scene vectors assigned to the clusters, or due to the presence of a scene vector having low similarity with any of the average vectors, the scene vectors may be re-clustered and life patterns may be re-extracted.

Further, scene vectors corresponding to the representative scene vectors of the life patterns may be generated by manpower, and the scene vectors matching life pattern extraction conditions may be assigned to the representative scene vectors generated by manpower. According to the present invention, the day's scene transition is expressed by vectors. Thus, the representative scene vector can be easily generated by the analyst specifying the type and order of the transitioning scenes, and the time of transition.

### (3) Life Pattern Cluster Analysis

The life patterns extracted by clustering represent the typical day persons go through. However, even for the same user, the way he goes through the day often varies, e.g., between a weekday and a holiday. On the other hand, when looked at in a certain period, a certain tendency may be observed in the typical day the users go through, representing the “personal character”. Or, persons who come to a specific location (city, shop, sightseeing spot, etc.) may have a certain tendency (such as “active salaried worker”, “someone who stays at home more often than not”), representing a “location character”.

Thus, according to the present invention, the frequency at which each life pattern appears in the behavior history is acquired for each user, and clustering is implemented using the frequency as a feature quantity of each user. When a location (such as the station or a facility at the center of a town) is the analysis object, the life patterns of the users of the location are collected, and the frequency of appearance of the patterns is considered the feature quantities of the location. These feature quantities express the life style indicating what scenes the users or the users of the certain location go through in what manner of transition and at what ratio. According to the present invention, the users or locations are clustered using the feature quantity, and the users or locations are classified based on the life style.

In the life pattern cluster analysis in the present step, first cluster analysis conditions are set, vectors characterizing the analysis objects are generated, and clustering is performed, followed by a display of results to the analyst. In the following, each step will be described.

### (3.1) Setting of Cluster Analysis Conditions

In accordance with the need of the analysis, the cluster analysis objects and a life pattern used for characterizing the object are set by the analyst. An example will be described.

### (3.1: Example 1 of Analysis Condition)

Analysis need: “it is desired to know everyday life of persons who came to—station in—month—day”

Analysis object: “persons who came to—station in—month—day for fun”

Utilized life pattern: “life patterns extracted from one month's worth of scene vectors of persons who came to—station in—month—day”

### (3.1: Example 2 of Analysis Condition)

Analysis need: “it is desired to know in what scenes females in their 20's living in the metropolitan area utilize convenience stores”

Analysis object: “convenience store”

Utilized life pattern: “life patterns extracted by weighting the scene vectors of females in their 20's who utilized convenience stores and who are living in the metropolitan area by the time of utilization”

In Example 1, because the analysis need is “everyday life of persons who came to—station in—month—day for fun”, the life patterns extracted from a long period, such as the whole month of—month, are used, for example, instead of from the life patterns of the day of the analysis object persons. On the other hand, in Example 2, because it is desired to know the way convenience stores are utilized, the life patterns extracted from the scene vectors of the day convenience stores were utilized are used, with the time of utilization of the convenience stores weighted.

### (3.2) Generation of Feature Vector

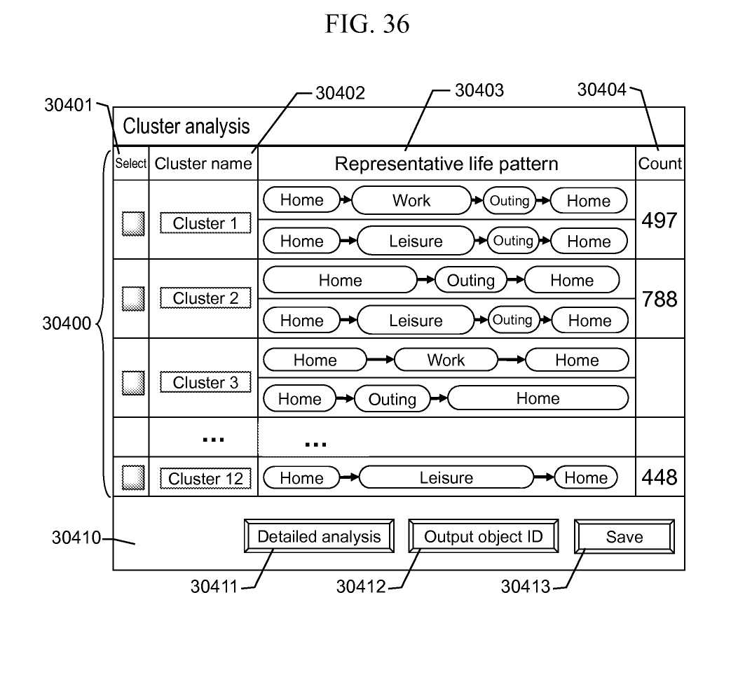

With respect to the cluster analysis objects set in (3.1) (such as “persons who came for fun” and “convenience store”), the frequency of appearance of the set life patterns is counted, and a feature vector having the number of the life patterns as the number of dimensions and the frequency of appearance of each life pattern as a value is generated (for a display example, see FIG. 36).

In this case, the frequency of appearance of the life patterns may be weighted. Some life patterns may appear commonly to the analysis objects, and some may appear only for a small number of the analysis objects. The former are life patterns that are not effective in characterizing the analysis objects and that may in fact create noise; the latter is the opposite. For this, the frequency of appearance of the life patterns may be weighted by the tf-idf method, for example.

### (3.3) Feature Vector Clustering

The analysis objects are clustered using the generated feature vectors. Namely, the analysis objects having similar frequencies of appearance of the life patterns are combined. Because the specific means of clustering is the same as that for scene vector clustering, its description will be omitted. Thus, clusters corresponding to the frequency of appearance of the life patterns are generated, such as a cluster of users with the frequent pattern of leaving home in the morning to work on weekdays while going out in the afternoon for fun on holidays, or a cluster of users with the frequent pattern of going out at noon for fun on both weekdays and holidays.

### (3.4) Cluster Display

As in the life pattern extraction, the clustering result is a list of automatically generated cluster IDs and the IDs of the feature vectors belonging to each cluster. In order to display these to the analyst in an easily understandable manner, the present invention provides the following means.

First, each cluster is characterized by the life pattern that appears in each cluster characteristically. Specifically, an average vector of the feature vectors belonging to each cluster is generated, and the characteristics in the average vector whose vector values are not less than a threshold value, i.e., the IDs of life patterns, are acquired and considered representative life patterns. Next, the representative scene vectors of the representative life patterns are acquired and displayed to the analyst as scene transitions. Description of the representative scene vectors and their visualization has been made with reference to the (2.4) life pattern display in the (2) life pattern extraction and is therefore omitted.

The present invention also provides the following means for enabling the analyst to easily implement drill-down analysis or slice and dice analysis for each cluster.

### (3.4.1) Graph Display Function

With respect to a cluster selected by the analyst, the details of the analysis objects belonging to the cluster are displayed in a graph. Specifically, when the analysis objects are users, the users' characteristics, such as sex, generation, and address are referenced. In the case of a location, characteristics such as address and location classification (such as station or shop) are referenced. Then, the contents of the analysis objects belonging to each life pattern cluster are displayed in a graph. The graph may be selected from several types, such as a circle graph and a bar graph. The characteristics utilized as the contents may not be provided by the system. User or location characteristics, such as the amount spent by using a credit card by each user, or the amount spent by using the credit card at a certain shop, that are obtained by the analyst using some means may be read into the system, and then the contents of the cluster may be displayed in a graph by referring to such information as characteristics.

### (3.4.2) Matrix Display

With regard to one or more life pattern clusters selected by the analyst, the details of the analysis objects belonging to the cluster are displayed in a matrix. Specifically, using a characteristic (such as the users' sex and generation; see above) selected by the analyst as an analysis axis, the number of analysis objects corresponding to the analysis axis is displayed in a matrix format on a life pattern cluster basis. An example is “Users belonging to life pattern cluster 1 are 51 males and 69 females”. The analysis axis may be set in a hierarchical manner. For example, the analyst can set sex as the analysis axis and further set generation as a subordinate analysis axis. In this case, the display in the matrix may read “Users belonging to life pattern cluster 1 are 51 males, of which 17 are those in their 30's, 12 are in their 40's, . . . ”. The characteristics read by the analyst as described above may also be set as an analysis axis. For example, “Users belonging to life pattern cluster 1 are 51 males, of which those with the amount spent using a credit card of 10,000 yen or more are 14, those with the amount of 30,000 yen or more are 9, . . . ” is displayed in a matrix. The matrix display may be provided with a function for statistically analyzing a correlation between the axes. Specifically, examples are a function for testing independence (χ squared test) or decorrelation between the analysis axes, or a function for generating a correlation matrix or a variance matrix.

### (3.5) Supplementation

The (3.1) setting of cluster analysis condition, (3.2) feature vector generation, (3.3) feature vector clustering, and (3.4) cluster display are not limited to single implementation. The behavioral characteristics analysis device 1 according to the present invention is configured such that a desired analysis result can be obtained by repeating trials, such as by varying the cluster analysis conditions in response to the result of (3.4) cluster display, and then re-generating feature vectors followed by clustering. Thus, the clusters generated by life pattern cluster analysis are saved together with the generation conditions in the absence of an instruction for deletion from the analyst. In (3.4) cluster display, a function enabling the output of the IDs of the analysis objects (user or location) belonging to each life pattern cluster is provided so that the analyst can perform drill-down analysis on the life pattern cluster of interest.

Further, the (2) life pattern extract and (3) life pattern cluster analysis are not each limited to a single implementation in a single analysis. In data analysis, it is common to analyze the same data from several different aspects, or to perform further analysis by narrowing the data based on the result of analysis of certain data. In the behavioral characteristics analysis device 1 according to the present invention, (2) life pattern extraction can be implemented again by varying the life pattern extraction conditions based on the result of (3) life pattern cluster analysis.

In the foregoing, the “two phase clustering” technique has been described where daily life patterns are extracted in (2) and the vectors having the frequency of appearance of the life patterns as a feature quantity are generated and users or locations are clustered in (3).

(4) Means Other than Two Phase Clustering

Clustering is not limited to two phases. In the following, as another means, a technique where the feature vectors of users or locations are classified by means other than clustering in the clustering of users or locations in (3) will be described. Further, a technique where users or locations are clustered by extracting life patterns of a certain period by using the day's life patterns extracted in (2) will be described.

### (4.1) User/Location Classification Utilizing Persona

In the above-described (3), analysis conditions for cluster analysis are set and then the feature vectors are generated and clustered. However, this does not limit the clustering technique. For example, when the analyst has a specific image of the users (persona) or of the way a location is used, and desires to classify the user/location accordingly, a feature vector may be artificially generated using the extracted life patterns, and the analysis objects may be classified by assigning the user/location characterized by the extracted life patterns to the artificially generated feature vector.

For example, a user image such as “users with a weekday life pattern of going directly and returning home directly most of the times, and a holiday life pattern of going out in the morning and coming home early in the evening”, or “users with a weekday life pattern of often stopping off somewhere on the way home, and a holiday life pattern of going out later and coming home late at night” is assumed in advance. In this case, when it is desired to classify users of a certain station against such a user image, the analyst expresses the user image in terms of a feature vector by using life patterns that have already been extracted. Specifically, the analyst selects life patterns that matches the user image, such as the weekday life pattern of going directly and returning home directly occurring a certain number of times, and the holiday life pattern of going out in the morning occurring a certain number of times a month, and specifies the frequency of their appearance in a period. With respect to the feature vector specified by the analyst, similarity with the feature vectors of the user/location of the analysis objects is calculated, and the user/location of the analysis objects is assigned to the user image with the highest similarity.

### (4.2) Multi-Phase Clustering

“Multi-phase clustering” refers to a technique where, by using daily life patterns, the life patterns in a certain period, such as a week or ten days, are extracted, and users or locations are clustered by generating vectors having the frequency of appearance of the patterns as a feature quantity. Description of the extraction of the day's life patterns in “multi-phase clustering” will be omitted as it is the same as in (2) life pattern extraction. By using the day's life patterns, a week's worth of life patterns of the users is generated, for example. Then, by using the week's worth of the frequency of appearance of the life patterns, feature vectors of the users are generated, and clustering is implemented. Description of this process will be omitted as it is similar to the process in (3) life pattern clustering analysis. The details of the process sequence of extracting a week's worth of life patterns will be described.

(4.2.1)

The life patterns generated by life pattern extraction are provided with identifiable IDs. While the cluster numbers are automatically assigned by an algorithm during clustering, the cluster numbers are reassigned based on the similarity between the clusters. Specifically, in a possible sequence, an average vector of each cluster (an average of the scene vectors belonging to the cluster) may be generated, the average vectors may be sorted in order of decreasing length, and IDs starting with 1 may be assigned in order of the results. In another possible sequence, an arbitrary one of the average vectors may be selected, similarity between the remaining vectors and the selected vector (such as Euclid distance) may be calculated, the remaining vectors may be sorted in order of decreasing value of the similarity, and IDs starting with 1 may be assigned in order of the results (the selected vector being the first).

(4.2.2)

While the cluster IDs automatically generated by clustering are assigned to the scene vectors as the objects during life pattern extraction, the cluster IDs are converted into the reassigned cluster IDs, and the scene vectors are sorted by the user as a first key and the date as a second key.

(4.2.3)

The following process is implemented for each user from which the life patterns have been extracted. First, the user's scene vectors are divided into 7 days in order of date, and characteristics vectors of 7 dimensions having the IDs (reassigned IDs) of the life patterns to which the scene vectors belong as characteristics values are generated. When the period in which the scene vectors were extracted is not a multiple of 7, a remainder of less than 7 days (7 dimensions) may be produced. Such remainder is disregarded herein. When there is a date where there are no relevant scene vectors, the value for the day is set to “0”.

(4.2.4)

A plurality of the characteristics vectors of the 7 dimensions are generated by implementing the process of (4.2.3) on all users, and the seven days of life patterns are extracted by clustering the characteristics vectors.

The outline of the present invention has been described above. In the following, specific embodiments will be described with reference to the drawings.

### Embodiment 1

In embodiment 1 of the present invention, a behavioral characteristics analysis device will be described that extracts the life patterns of users by using the utilization history of a transit-system IC card, and that clusters the users by using the life patterns.

### (Overall Configuration of System)

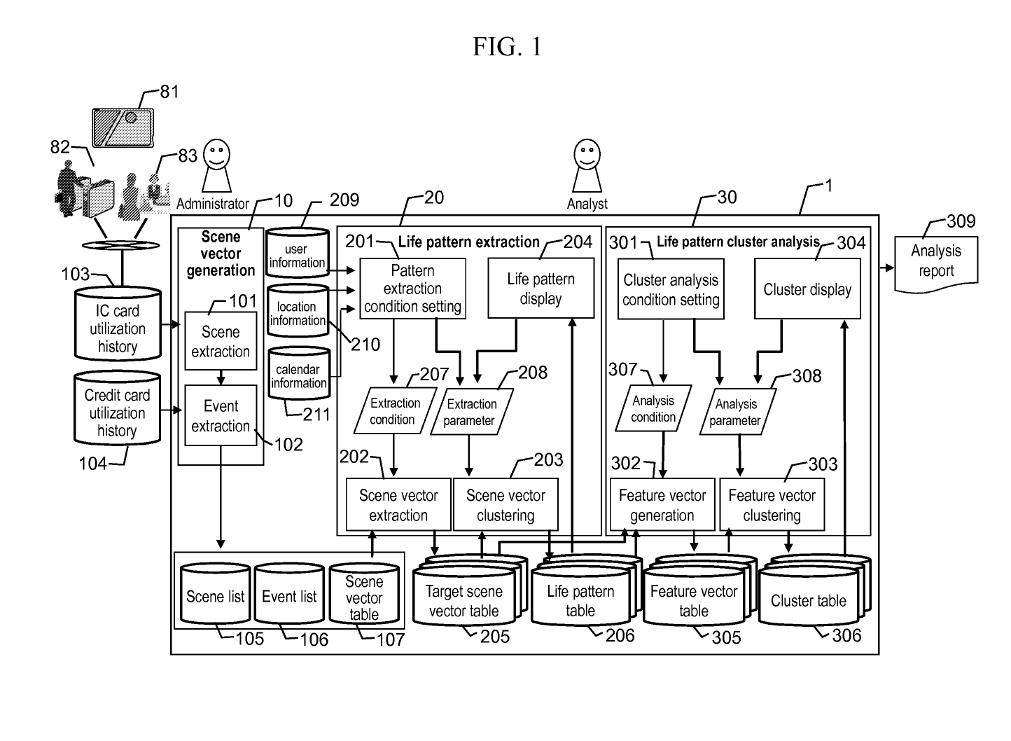

FIG. 1 illustrates a configuration of the behavioral characteristics analysis device 1 according to the present embodiment 1. The behavioral characteristics analysis device 1 receives an IC card utilization history 103 and a credit card utilization history 104 as inputs and outputs an analysis report 309. The IC card utilization history 103 is data storing the history of utilization of a transit-system IC card 81 in a ticket gate 82 at a station or a terminal machine 83 installed in a shop, by a user of the transit-system IC card 81. The credit card utilization history 104 is data storing the history of utilization of the credit card (not shown) for payment at the shop or the like. The analysis report 309 is a report storing the result of cluster analysis of the analysis objects.

The behavioral characteristics analysis device 1 is a device that classifies the analysis objects by using the behavioral characteristics of a set of persons, and comprises largely three functional units; namely, a scene vector generation unit 10, a life pattern extraction unit 20, and a life pattern cluster analysis unit 30.

### (Function Configuration of System: Scene Vector Generation Unit 10)

The scene vector generation unit 10 generates, from a personal behavior history, scene vectors that represent the transition of scenes of a user's day. The input to the unit is the data stored in the IC card utilization history 103 and the credit card utilization history 104, and the unit outputs data to a scene list 105, an event list 106, and a scene vector table 107. The details of the input and output of data will be described with reference to the drawings in connection with a description of data configuration.

The scene vector generation unit 10 further includes two functional units of a scene extraction unit 101 and an event extraction unit 102. The details of the functional units will be described with reference to a flow chart in connection with a description of a process sequence.

### (Function Configuration of System: Life Pattern Extraction Unit 20)

The life pattern extraction unit 20 extracts the scene vectors in accordance with extraction conditions set by the analyst, and implements clustering on the scene vector to extract life patterns. The life pattern extraction unit 20 receives the data stored in the scene list 105, the event list 106, and the scene vector table 107 as inputs, and outputs data to a target scene vector table 205 and a life pattern table 206. The life pattern extraction unit 20 also generates an extraction condition 207 and a parameter 208 as temporary data. The life pattern extraction unit 20 may also utilize data stored in user information 209, location information 210, or calendar information 211 as the reference data. The details of these input/output data and reference data, and an example of the temporary data will be described with reference to the drawings in connection with a description of data configuration and temporary data.

The life pattern extraction unit 20 further includes four functional units of a pattern extraction condition setting unit 201, a scene vector extraction unit 202, a scene vector clustering unit 203, and a life pattern display unit 204. The details of these functional units will be described with reference to a flow chart in connection with the description of a process sequence.

### (Function Configuration of System: Life Pattern Cluster Analysis Unit 30)

The life pattern cluster analysis unit 30 generates feature vectors of the analysis objects in accordance with the analysis conditions set by the analyst, and generates analysis object clusters by clustering. The life pattern cluster analysis unit 30 receives the data stored in the target scene vector table 205 and the life pattern table 206 as inputs, and outputs data to a feature vector table 305 and a cluster table 306. The life pattern cluster analysis unit 30 also generates an analysis condition 307 and a parameter 308 as temporary data. The details of the input/output data, and an example of the temporary data will be described with reference to the drawings in connection with a description of data configuration and temporary data.

The life pattern cluster analysis unit 30 further includes four functional units of a cluster analysis condition setting unit 301, a feature vector generation unit 302, a feature vector clustering unit 303, and a cluster display unit 304. The details of the functional units will be described with reference to a flow chart in connection with a description of a process sequence.

The respective functional units may be configured using hardware, such as circuit devices for realizing their functions, or using an operating device, such as a CPU (Central Processing Unit), and a program defining its operation. In the following, it is assumed that the respective functional units are implemented as a program. The various data, and data such as tables and lists, may be stored in a storage device, such as a hard disk.

### (Hardware Configuration)

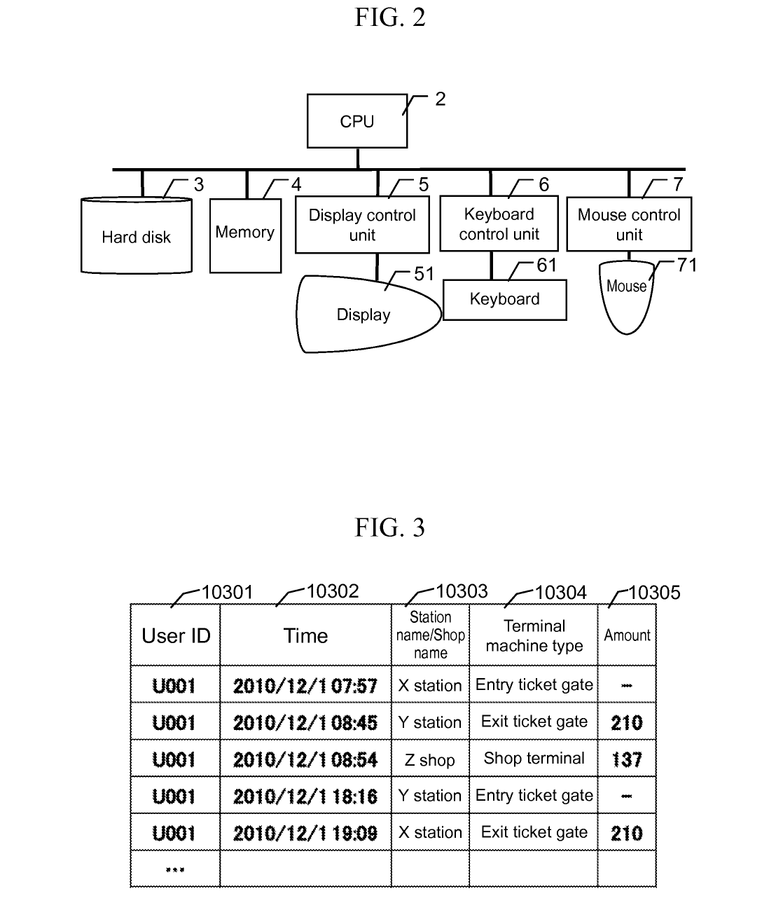

FIG. 2 illustrates a hardware configuration of the behavioral characteristics analysis device 1. As shown in FIG. 2, the behavioral characteristics analysis device 1 includes a CPU 2, a hard disk 3, a memory 4, a display control unit 5, display 51, keyboard control unit 6, a keyboard 61, a mouse control unit 7, and a mouse 71. The CPU 2 performs data input/output, read, and storage, and executes a program implementing the respective functional units described with reference to FIG. 1. The hard disk 3 is a storage device for saving the various data described with reference to FIG. 1. The memory 4 is a device for temporarily reading and storing programs and data. The display 51 is a device for displaying data to the user, and is controlled by the display control unit 5. The keyboard 61 and mouse 71 are devices for receiving inputs from the user, and are controlled by the keyboard control unit 6 and the mouse control unit 7, respectively.

### (Data Configuration)

Next, the configuration of the respective data described with reference to FIG. 1 will be described with reference to FIGS. 3 to 18.

### (Data Configuration: IC Card Utilization History 103)

FIG. 3 illustrates a data configuration of the IC card utilization history 103. The IC card utilization history 103 is the data storing the history of utilization of the transit-system IC card by the users, storing records of the users touching the card to the ticket gate or a fare adjustment machine at a station, or the terminal machine installed at a shop or the like.

The IC card utilization history 103 includes a user ID 10301, a time 10302, a station name/shop name 10303, a terminal machine type 10304, and an amount 10305. The user ID 10301 is an area for storing the ID of the user of the transit-system IC card 81, and is acquired by a reader/writer device in the ticket gate 82 or the terminal machine 83 reading the user ID stored in the IC card ticket 81. The time 10302 is an area for storing the time of utilization of the ticket gate 82 or the terminal machine 83 by the user. The station name/shop name 10303 is an area for storing the name of the station or the shop at which the transit-system IC card was utilized. The terminal machine type 10304 is an area for storing the type of the terminal machine on which the transit-system IC card was utilized. According to the present embodiment 1, the terminal machine type 10304 includes the four types of “entry ticket gate”, “exit ticket gate”, “shop terminal” and “charge terminal”. The amount 10305 is an area for storing the amount paid at the ticket gate 82 or in the terminal machine 83.

### (Data Configuration: Credit Card Utilization History 104)

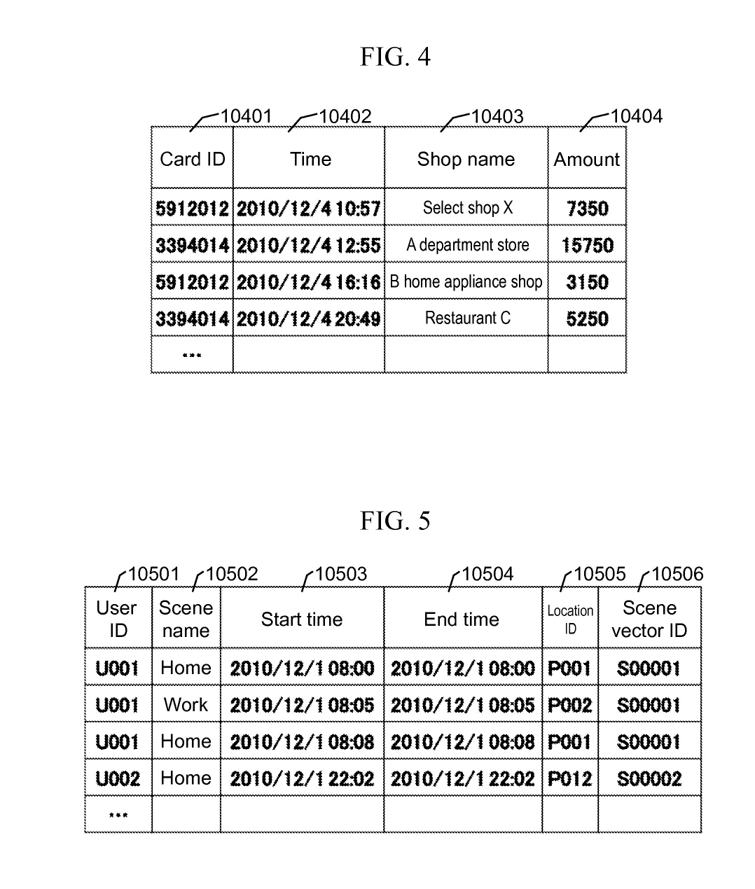

FIG. 4 illustrates a data configuration of the credit card utilization history 104. The credit card utilization history 104 is data storing the history of utilization of the credit card by the user, and is used as the user's second behavior history.

The credit card utilization history 104 includes a card ID 10401, a time 10402, a shop name 10403, and an amount 10404. The card ID 10401 is an area for storing the ID of the credit card. The time 10402 is an area for storing the time of utilization of the credit card. The shop name 10403 is an area for storing the name of the shop at which the credit card was utilized. The amount 10404 is an area for storing the amount settled by the user for utilization of the credit card.

### (Data Configuration: Scene List 105)

FIG. 5 illustrates a data configuration of the scene list 105. The scene list 105 is data storing the scenes that the user went through, and is generated by the scene extraction unit 101. The scene list 105 includes a user ID 10501, a scene name 10502, a start time 10503, an end time 10504, a location ID 10505, and a scene vector ID 10506.

The user ID 10501 is an area for storing the ID of the user of the transit-system IC card 81. The scene name 10502 is an area for storing the scene names extracted from the IC card utilization history 103. According to the present embodiment 1, the scenes include the four scenes of “HOME” where the user spends time from night to morning regardless of weekday/holiday; “WORK” where the user spends a long time during daytime of a weekday; “LEISURE” where the user spends a long time at a holiday destination; and “OUTING” where the user spends a short time at a destination regardless of weekday/holiday. The sequences for extraction of these scenes will be described below. The start time 10503 stores the time of start of a scene, and the end time 10504 stores the time of end of the scene. According to the present embodiment 1, it is envisioned that the scenes are switched upon passing of the ticket gate. Specifically, it is assumed that the current scene is switched to the next scene upon entry into a certain station. Generally, it can be considered that persons leave home in the morning and come home at night. Thus, according to the present embodiment 1, the initial scene of the day is “HOME”, which is switched to the next scene upon passing of (entry through) the initial ticket gate. Namely, the day's initial scene “HOME” ends at the time of passing of the day's initial ticket gate, and, assuming that the next scene is “WORK”, the scene “WORK” starts at the time of passing of the ticket gate. The user then arrives at the station nearest his place of work and passes (exits) the exit ticket gate. After the user stays at the place for some time, he passes (enters) the entry ticket gate at the same station when the scene “WORK” ends and the next scene starts. Thus, in the case of extraction of scenes from the utilization history of the transit-system IC card, the times of start and end of the scenes correspond to the times of passing of (entry through) the ticket gate, and the location of passing of the scene is the name of the station (name of the exit station). Accordingly, the location ID 10505 stores the location of passing of the scene by the user, i.e., the ID of the exit station. The scene vector ID 10506 stores the ID of the scene vector including the scene stored in the record.

While the scene list 105 comprehensively stores all of the scenes of all of the users that have been extracted, this is not a limitation. For example, the scenes may be stored by dividing them on a daily, weekly, or monthly period basis, on a user ID basis, or on a scene by scene basis.

### (Data Configuration: Event List 106)

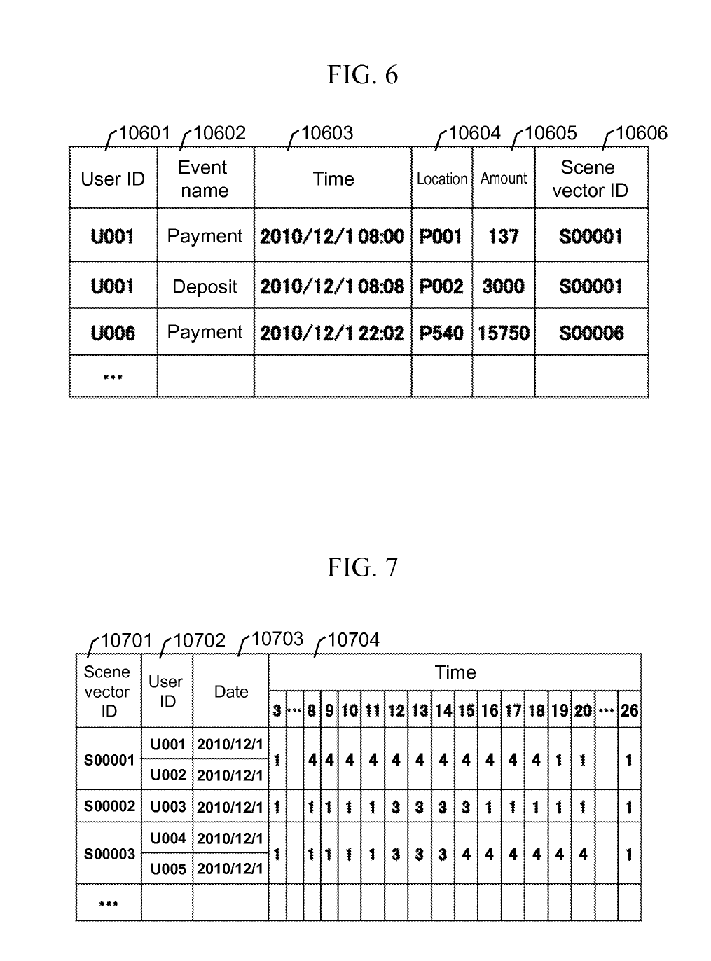

FIG. 6 illustrates a data configuration of the event list 106. The event list 106 is data storing the events that the user went through, and is generated by the event extraction unit 102. As shown in FIG. 6, the event list 106 includes a user ID 10601, an event name 10602, a time 10603, a location ID 10604, an amount 10605, and a scene vector ID 10606.

The user ID 10601 is an area for storing the ID of the user of the transit-system IC card. The event name 10602 stores designations of events extracted from the IC card utilization history 103 and the credit card utilization history 104. In the present embodiment 1, the event includes the two events of “payment” via an electronic money function of the transit-system IC card or a credit card, and “deposit” via a charge function of the transit-system IC card. The definitions of these events and extracting sequences will be described below. The time 10603 stores the time of occurrence of an event, and the location ID 10604 stores the ID of the location where the event took place. The amount 10605 stores the amount transacted by “payment” and “deposit”. The scene vector ID 10606 stores the ID of a scene vector with which an event stored in the record can be associated.

While the event list 106 in the present embodiment 1 comprehensively stores all of the events of all of the users that have been extracted, this is not a limitation. For example, the events may be stored by dividing them on a daily, weekly, or monthly period basis, or on a user ID basis, or on an event by event basis.

### (Data Configuration: Scene Vector Table 107)

FIG. 7 illustrates a data configuration of the scene vector table 107. The scene vector table 107 is data storing scene vectors, and is generated by the scene vector generation unit 10. In the present embodiment 1, a single day is defined as from 3 a.m. to 3 a.m. the next day, and the scene vectors are expressed as vectors of 24 dimensions on hourly unit basis. As described above, in the present embodiment 1, the scenes are the four of “HOME”, “WORK”, “LEISURE”, and “OUTING”, with scene-representing numerical values of “1”, “4”, “2”, and “3”. Thus, the scene vectors in the present embodiment 1 are vectors of 24 dimensions, with their values set to any of “1”, “4”, “2”, and “3”.

The scene vector table 107 includes a scene vector ID 10701, a user ID 10702, a date 10703, and a time 10704. The ID 10701 stores the IDs identifying the scene vectors. The user ID 10702 stores the IDs of users corresponding to the scene vectors. The date 10703 stores the dates corresponding to the scene vectors. The time 10704 stores the scene value at each time. The time 10704 is divided into 24 including area “3” for storing the value of the scene at 3 a.m. to area “26” for storing the value of the scene at 2 a.m. the next day.

While the scene vector table 107 in the present embodiment 1 comprehensively stores all of the scene vectors of all of the users that have been extracted, this is not a limitation. For example, the scene vectors may be stored by dividing them on a daily, weekly, or monthly period basis, or on a user ID basis.

### (Data Configuration: Target Scene Vector Table 205)

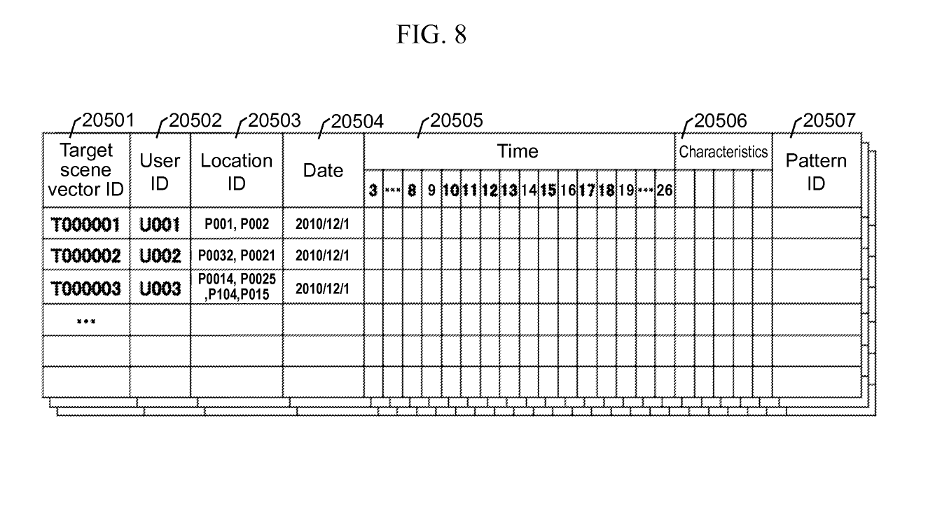

FIG. 8 illustrates a data configuration of the target scene vector table 205. The target scene vector table 205 is data resulting from the extraction of scene vectors (hereafter referred to as target scene vectors) as clustering objects by the life pattern extraction unit 20 in accordance with extraction conditions. In the target scene vector table 205, those of the scene vectors stored in the scene vector table 107 that match life pattern extraction conditions are stored. Depending on the life pattern extraction conditions, the vector values may be weighted, or characteristics may be added thereto.

The target scene vector table 205 includes a target scene vector ID 20501, a user ID 20502, a location ID 20503, a date 20504, a time 20505, a characteristics 20506, and a pattern ID 20507.

The target scene vector ID 20501 stores the IDs identifying the target scene vectors. The user ID 20502 stores the user IDs of the target scene vectors stored in the record. The location ID 20503 stores the IDs of the locations where the scene/event included in the target scene vectors stored in the record took place. The date 20504 stores dates. The time 20505 stores the value of the scene at each time, or the value of the weighted scene. The characteristics 20506 stores the characteristics added in accordance with the extraction conditions. The number of the characteristics may vary depending on the extraction conditions and is therefore indefinite. The pattern ID 20507 stores the ID (=life pattern ID) of the cluster to which the target scene vectors of the record ended up belonging to as a result of clustering of the target vectors by the scene vector clustering unit 203 of the life pattern extraction unit 20.

The target scene vector table 205 is generated each time a scene vector is extracted by the life pattern extraction unit 20. The generated target scene vector table 205 is identified by the target scene vector table ID, and is saved in the absence of a deletion instruction from the analyst.

### (Data Configuration: Life Pattern Table 206)

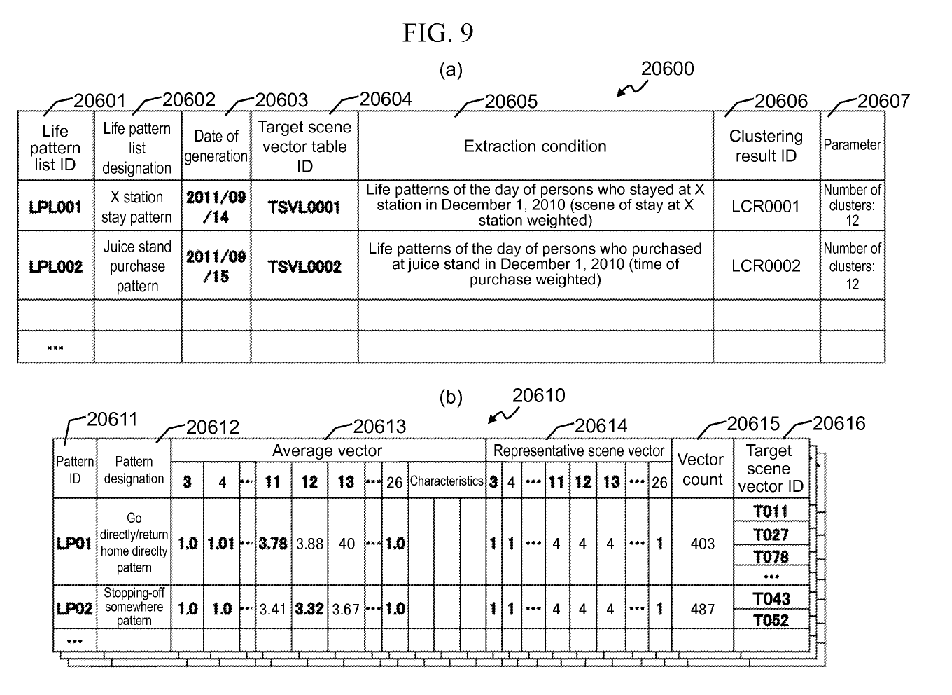

FIG. 9 illustrates a data configuration of the life pattern table 206. The life pattern table 206 is data storing the result of clustering of the target scene vectors. In the present embodiment 1, the k-means method is used as the clustering algorithm. The number of clusters generated is specified as a parameter of the life pattern extraction unit 20. While the ID of the generated cluster is automatically assigned by the algorithm, the ID is used as the ID of a life pattern corresponding to each cluster.

The life pattern table 206 includes a life pattern list table 20600 shown in FIG. 9(a) and a clustering result table 20610 shown in FIG. 9(b). The life pattern list table 20600 is data storing the extraction conditions of the life patterns that have been extracted and parameters and the like. The clustering result table 20610 is data storing the result of the target scene vector clustering. The clustering result table 20610 is generated each time the life pattern extraction unit 20 implements clustering. The generated clustering result table 20610 is identified by the clustering result ID, and is saved in the absence of a deletion instruction from the analyst.

The life pattern list table 20600 includes a life pattern list ID 20601, a life pattern list designation 20602, a date of generation 20603, a target scene vector table ID 20604, an extraction condition 20605, a clustering result ID 20606, and a parameter 20607.

The life pattern list ID 20601 stores the IDs identifying the scene vector extraction conditions stored in the life pattern list table 20600 and clustering results. The life pattern list designation 20602 stores designations assigned by the analyst to the scene vector extraction conditions or clustering results for ease of understanding. The life pattern list designation 20602, in an initial state, stores the life pattern list IDs. The date of generation 20603 stores the date of implementation of clustering. The target scene vector table ID 20604 stores the IDs identifying the target scene vector table 205 described with reference to the target scene vector table 205. The extraction condition 20605 stores conditions set by the analyst for target scene vector generation. In FIG. 9, the extraction conditions stored in in the extraction condition 20605 are described in natural sentences, such as “ . . . at X station in Dec. 1, 2010 . . . ”, this is merely for ease of understanding, and in practice they may comprise lists of groups of conditions and values set by the pattern extraction condition setting unit 201. The clustering result ID 20606 stores the IDs assigned to the clustering result table 20610 in which the results of target scene vector clustering are stored. The parameter 20607 stores the parameters set by the analyst for target scene vector clustering.

The clustering result table 20610 includes a pattern ID 20611, a pattern designation 20612, an average vector 20613, a representative scene vector 20614, a vector count 20615, and a target scene vector ID 20616.

The pattern ID 20611 stores the ID assigned to each cluster by the scene vector clustering unit 203. The pattern designation 20612 stores the designation assigned to each cluster by the analyst for ease of understanding. The pattern designation 20612 stores, in initial state, the pattern ID. The average vector 20613 stores the average vector of the scene vectors belonging to the cluster. The representative scene vector 20614 stores the representative scene vector of the cluster. The representative scene vector 20614 is a vector for display to the analyst that represents the feature of the cluster. Generation of the representative scene vector will be described below. The vector count 20615 stores the count of the target scene vectors belonging to the cluster. The target scene vector ID 20616 stores the IDs of the target scene vectors belonging to the cluster. The target scene vectors are stored in the target scene vector table 205 identified by the ID stored in the target scene vector table ID 20604 of the life pattern list table 20600.

### (Data Configuration: User Information 209)

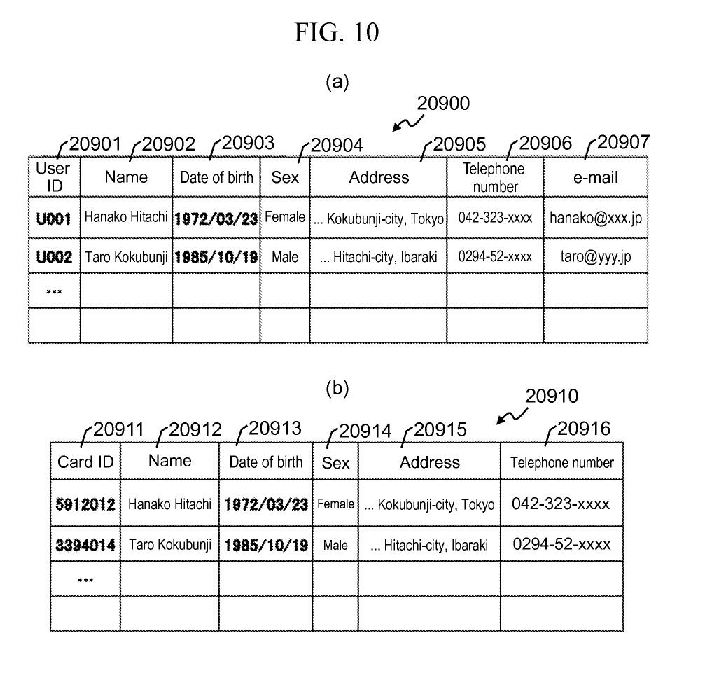

FIG. 10 illustrates a data configuration of the user information 209. The user information 209 is data storing the user characteristics information, such as the user's name, sex, and date of birth. In the present embodiment 1, the transit-system IC card utilization history and the credit card utilization history are used as the user's behavior history. Thus, in the user information 209, information about the user of the transit-system IC card and the credit card is stored.

The user information 209 includes transit-system IC card user information 20900 and credit card owner information 20910. FIG. 10(a) illustrates a data configuration of the transit-system IC card user information 20900. FIG. 10(b) illustrates a data configuration of the credit card owner information 20910.

The transit-system IC card user information 20900 includes a user ID 20901, a name 20902, a date of birth 20903, a sex 20904, an address 20905, a telephone number 20906, and an e-mail 20907. The user ID 20901 stores the ID of the user of the transit-system IC card. The name 20902 stores the name of the user. The date of birth 20903 stores the date of birth of the user. The sex 20904 stores the sex of the user. The address 20905 stores the address of the user. The telephone number 20906 stores the user's telephone number. The e-mail 20907 stores the user's mail address.

The credit card owner information 20910 includes a card ID 20911, a name 20912, a date of birth 20913, a sex 20914, an address 20915, and a telephone number 20916. The card ID 20911 stores the ID of the credit card. The name 20912 stores the name of the card owner. The date of birth 20913 stores the date of birth of the card owner. The sex 20914 stores the sex of the card owner. The address 20915 stores the address of the card owner. The telephone number 20916 stores the telephone number of the card owner.

### (Data Configuration: Location Information 210)

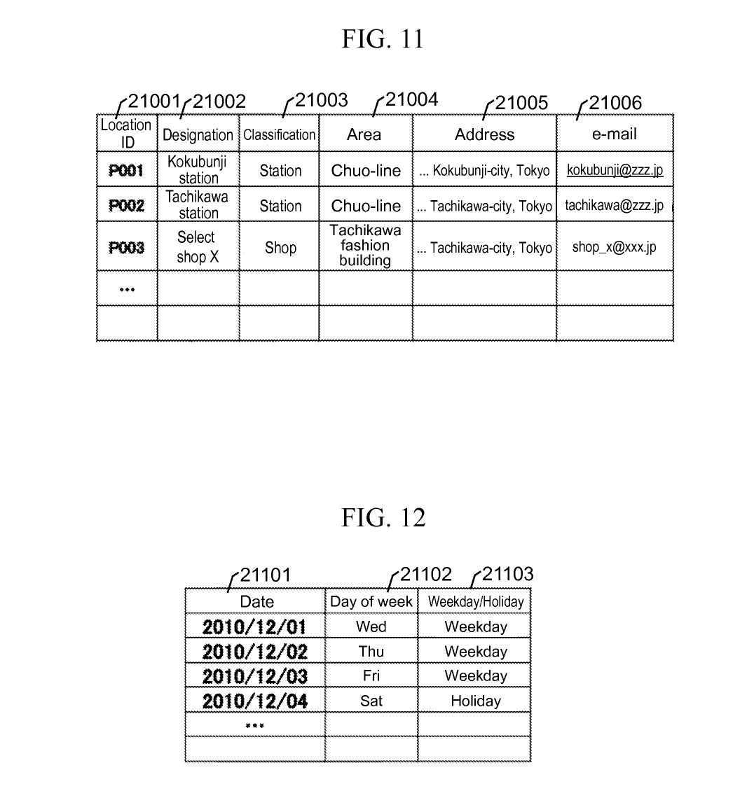

FIG. 11 illustrates a data configuration of the location information 210. The location information 210 is data storing the characteristics information about locations. In the present embodiment 1, the transit-system IC card utilization history and the credit card utilization history are used as the user's behavior history. Thus, in the location information 210, there are stored information about the stations or shops stored in the transit-system IC card history 103 and the credit card utilization history 104 where the transit-system IC card and the credit card can be utilized.

The location information 210 includes a location ID 21001, a designation 21002, a classification 21003, an area 21004, an address 21005, and an e-mail 21006. The location ID 21001 stores the ID of a location. The designation 21002 stores the designation of the location. The classification 21003 stores the classification of the location. In the present embodiment 1, the location includes the three types of “STATION”, “SHOP”, and “FACILITY”. The area 21004 stores the name of the area where a station, a shop, or a facility is located. In the case of stations, line names may be stored; in the case of shops or facilities, the designation of the building or area in which the shop is located may be stored. The address 21005 stores the address of the station or shop. The e-mail 21006 stores the mail address of the destination of information transmitted to the station or shop.

### (Data Configuration: Calendar Information 211)

FIG. 12 illustrates a data configuration of the calendar information 211. The calendar information 211 is data storing calendar information, such as the days of the week and holidays. In the present embodiment 1, the general Japanese calendar information is used. Namely, Monday through Friday are the weekdays, and Saturday, Sunday, and other public holidays are the holidays.

The calendar information 211 includes a date 21101, a day of the week 21102, and a weekday/holiday 21103. The date 21101 stores the dates of a period stored in the IC card utilization history 103. The day of the week 21102 stores the days of the week of the dates stored in the date 21101. The weekday/holiday 21103 stores information distinguishing whether the date stored in the date 21103 is a weekday or a holiday.

### (Data Configuration: Feature Vector Table 305)

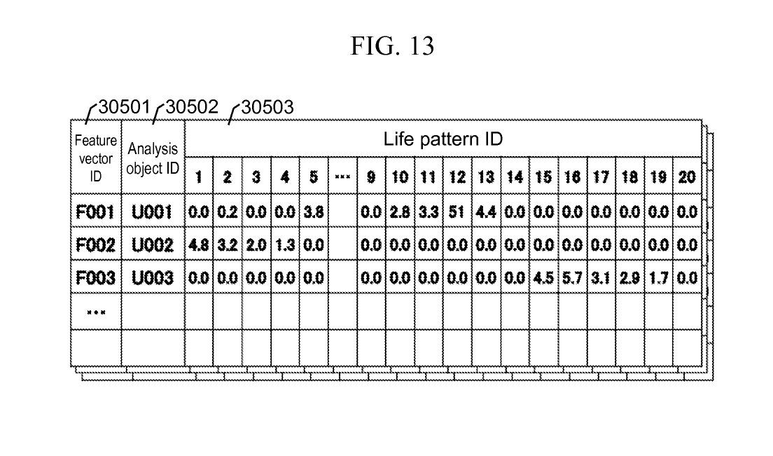

FIG. 13 illustrates a data configuration of the feature vector table 305. The feature vector table 305 is data storing the feature vectors as the analysis objects of the life pattern cluster analysis unit 30, such as user/location.

The feature vector table 305 includes a feature vector ID 30501, an analysis object ID 30502, and a life pattern ID 30503. The feature vector table 30501 stores the IDs identifying feature vectors. The analysis object ID 30502 stores the IDs identifying the object of life pattern cluster analysis. Specifically, when the analysis object is a user, the user's ID is stored; when the analysis object is a location, the location's ID is stored. The life pattern ID 30503 stores vectors having as the element number the life pattern ID characterizing the analysis object, and as the element value the frequency of appearance (weighted) of the ID. Specifically, the life pattern IDs stored in the pattern ID 20611 of the clustering result table 20610 of the life pattern table 206 may be taken as the element numbers.

The feature vector table 305 is generated each time the life pattern cluster analysis unit 30 generates a feature vector. The generated feature vector table 305 is identified by the feature vector list ID, and is saved in the absence of a deletion instruction from the analyst.

### (Data Configuration: Cluster Table 306)

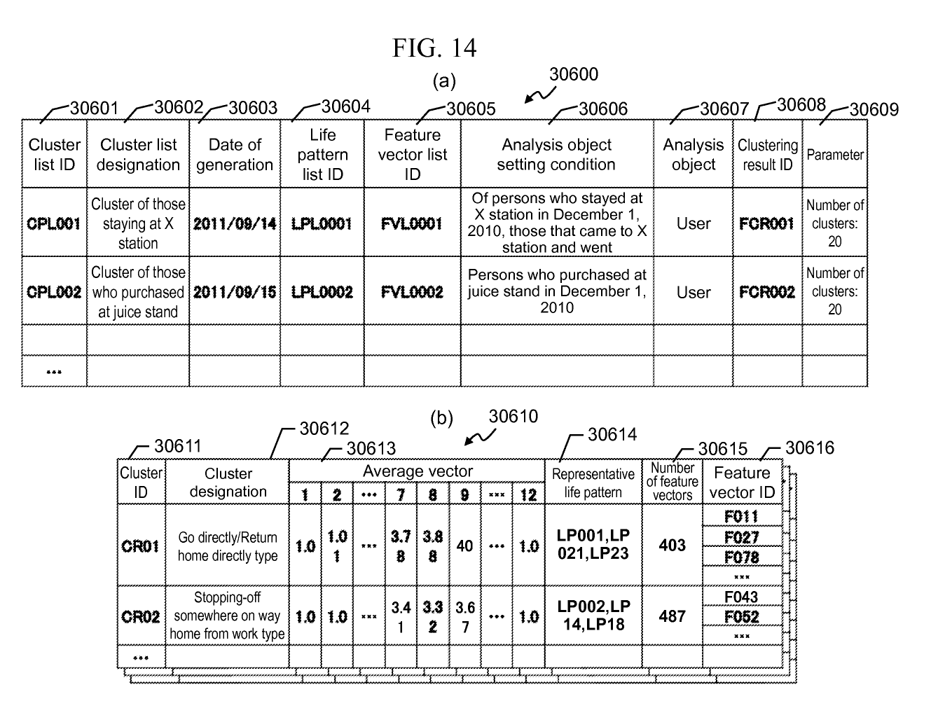

FIG. 14 illustrates a data configuration of the cluster table 306. The cluster table 306 stores the results of clustering of the feature vectors. In the present embodiment 1, the k-means method is used as a clustering algorithm. The number of the generated clusters is specified as a parameter of the life pattern cluster analysis unit 30. The IDs of the generated clusters are automatically assigned by the algorithm.

The cluster table 306 includes a cluster list table 30600 shown in FIG. 14(a), and a clustering result table 30610 shown in FIG. 14(b). The cluster list table 30600 is data storing generation conditions and parameters of clusters that have been generated. The clustering result table 30610 is data storing the results of clustering of feature vectors. The clustering result table 30610 is generated each time the life pattern cluster analysis unit 30 implements the clustering of feature vectors. The generated clustering result tables 30610 are identified by the IDs stored in the clustering result ID 30608 of the cluster list table 30600, and are saved in the absence of a deletion instruction from the analyst.

The cluster list table 30600 includes a cluster list ID 30601, a cluster list designation 30602, a date of generation 30603, a life pattern list ID 30604, a feature vector list ID 30605, an analysis object setting condition 30606, an analysis object 30607, a clustering result ID 30608, and a parameter 30609.

The cluster list ID 30601 stores the IDs identifying the analysis object setting conditions or clustering results stored in the cluster list table 30600. The cluster list designation 30602 stores the designations assigned by the analyst to the analysis object setting conditions or clustering results for ease of understanding. The cluster list designation 30602, in an initial state, stores the cluster list IDs. The date of generation 30603 stores the date of implementation of clustering. The life pattern list ID 30604 stores the life pattern list IDs utilized for characterizing the analysis objects. The feature vector list ID 30605 stores the ID of the feature vector table 305 storing the feature vectors characterizing the analysis objects using the life patterns. The analysis object setting condition 30606 stores the conditions set by the analyst for extracting the analysis objects. In FIG. 14, the setting conditions stored in the analysis object setting condition 30606 are described in natural sentences, such as “ . . . at X station in Dec. 1, 2010”, this is merely for ease of understanding. In practice, the setting conditions may be lists of groups of the conditions and values set by the cluster analysis condition setting unit 301. The analysis object 30607 stores data indicating whether the analysis object is a user or a location. When the cluster analysis condition setting unit 301 selects a user as the analysis object, “user” is stored; when a location is selected, “location” is stored. The clustering result ID 30608 stores the IDs of the clustering result tables in which the results of clustering of the feature vectors are stored. The parameter 30609 stores the parameters set by the analyst for clustering the feature vectors.

The clustering result table 30610 includes a cluster ID 30611, a cluster designation 30612, an average vector 30613, a representative life pattern 30614, a number of the feature vectors 30615, and a feature vector ID 30616.

The cluster ID 30611 stores the ID assigned to each cluster by the feature vector clustering unit 303. The cluster designation 30612 stores the designation assigned by analyst to each cluster for ease of understanding. The cluster designation 30612, in an initial state, stores the cluster IDs. The average vector 30613 stores the average vector of the feature vectors belonging to the cluster. The representative life pattern 30614 stores the IDs of the life patterns characterizing the cluster. Specifically, of the average vectors of the feature vectors belonging to the cluster, the top several IDs of the life patterns with greater weight, i.e., higher frequency of appearance, or the IDs of the life patterns with weights equal to or more than a threshold value, are stored. The number of the feature vectors 30615 stores the number of the feature vectors belonging to the cluster. In the feature vector ID 30616, the IDs of the feature vectors belonging to the cluster are stored.

### (Temporary Data)

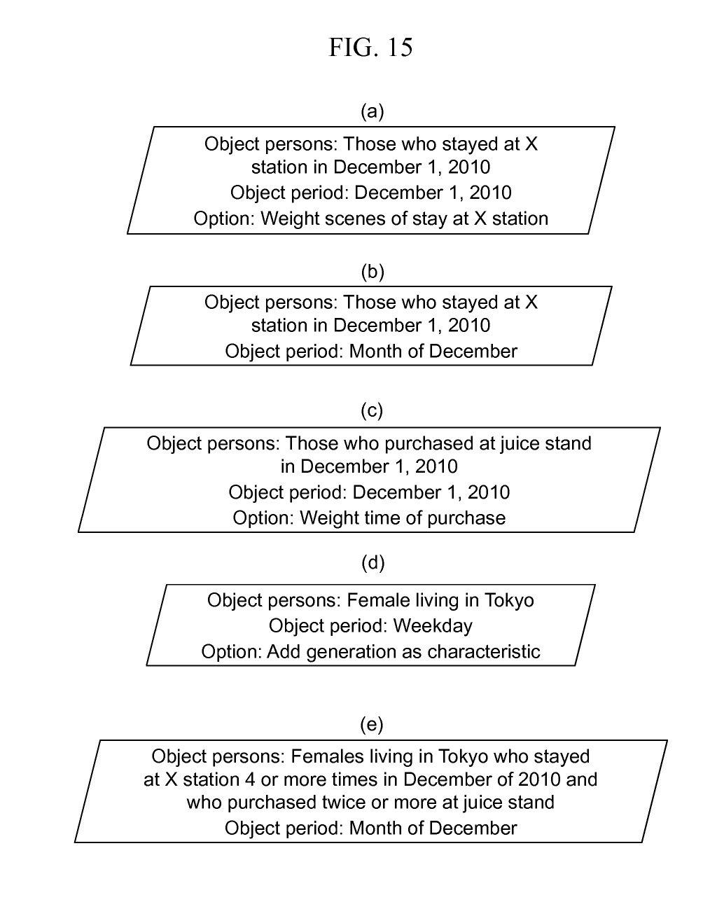

In the following, examples of the temporary data shown in FIG. 1 will be described with reference to FIGS. 15 to 18.

### (Temporary Data: Extraction Condition 207)

FIG. 15 illustrates an example of the extraction condition 207. The extraction condition 207 is temporary data storing the scene vector extraction conditions set in the life pattern extraction unit 20 by the analyst.

### (Temporary Data: Extraction Parameter 208)

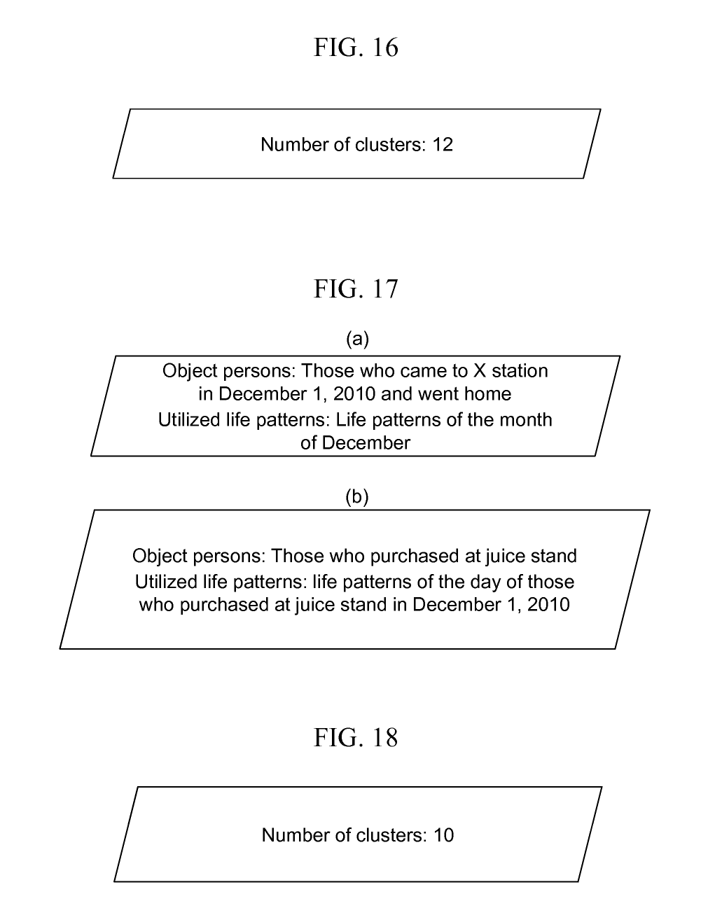

FIG. 16 illustrates an example of the extraction parameter 208. The extraction parameter 208 is temporary data storing the scene vector clustering conditions set in the life pattern extraction unit 20 by the analyst. Specifically, the number of generated clusters is stored.

### (Temporary Data: Analysis Condition 307)

FIG. 17 illustrates an example of the analysis condition 307. The analysis condition 307 is temporary data storing the feature vector generation conditions set in the life pattern cluster analysis unit 30 by the analyst.

### (Temporary Data: Analysis Parameter 308)

FIG. 18 illustrates an example of the analysis parameter 308. The analysis parameter 308 is temporary data storing the feature vector clustering conditions set in the life pattern cluster analysis unit 30 by the analyst. Specifically, the number of generated clusters is stored.

### (Process Sequence)

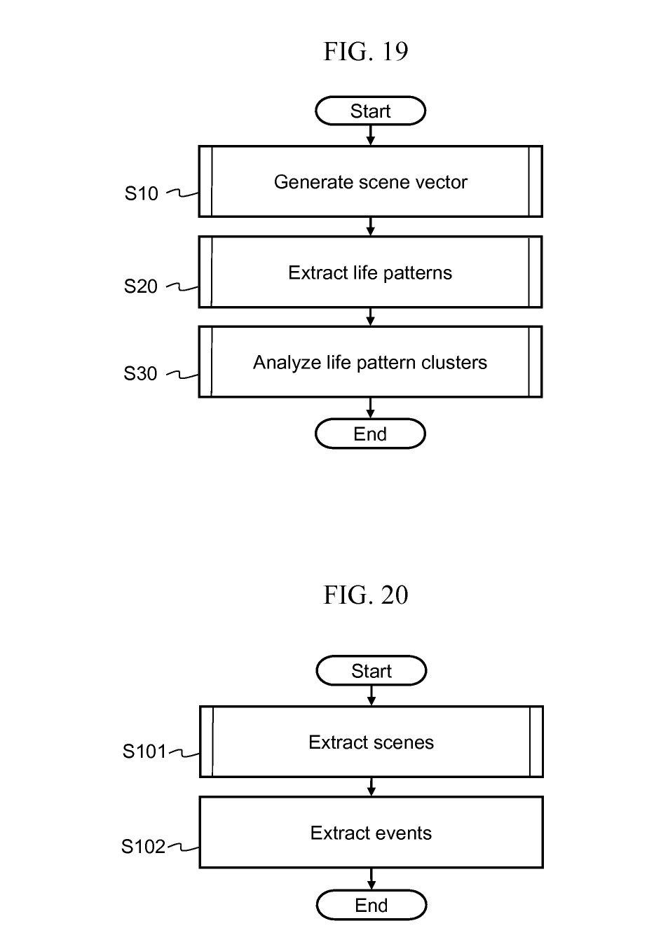

With reference to FIGS. 19 to 39, a process sequence of the behavioral characteristics analysis device 1 will be described.

### (Process Sequence: Overall Process Sequence)

FIG. 19 is a flowchart of the process sequence of the behavioral characteristics analysis device 1 in the present embodiment 1. Initially, the scene vector generation unit 10 generates scene vectors by using the IC card utilization history 103 and the credit card utilization history 104 in which the users' behavior histories are accumulated (S10). Then, the life pattern extraction unit 20 extracts the scene vectors matching the conditions specified by the analyst, and implements clustering, thus extracting life patterns (S20). The life pattern cluster analysis unit 30 then generates feature vectors of the analysis objects by using the life patterns extracted in step S20, and generates an analysis object cluster by implement clustering (S30). The details of each step will be described below.

### (Process Sequence of Scene Vector Generation Unit 10)

FIG. 20 is a flowchart of the process sequence in step S10. The scene extraction unit 101 of the scene vector generation unit 10 extracts scenes and events from the IC card utilization history 103, and stores them in the scene list 105 and the event list 106, while converting the extracted scenes into scene values and store them in the scene vector table 107 (S101). Next, the event extraction unit 102 extracts events from the credit card utilization history 104 and store them in the event list 106 (S102).

The process of the scene vector generation unit 10 in the present embodiment 1 is performed by a batch process. In the initial state, the above process is performed on all of the IC card utilization history 103 that has been accumulated. Subsequently, the process is performed every day on the utilization history that has been accumulated on the day, and scenes, events, and scene vectors are extracted and additionally stored in the scene list 105, the event list 106, and the scene vector table 107, respectively.

### (Process Sequence of Life Pattern Extraction Unit 20)

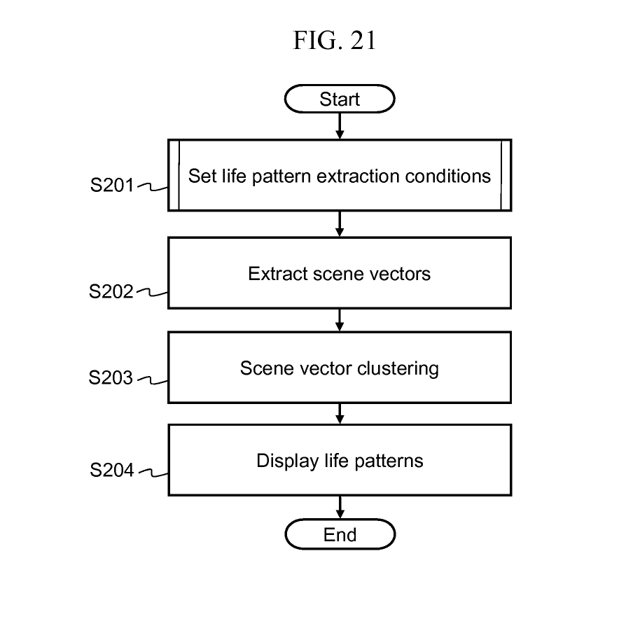

FIG. 21 is a flowchart of the process sequence in step S20. The pattern extraction condition setting unit 201 of the life pattern extraction unit 20 sets conditions for extracting the scene vectors as the objects of clustering that are specified by the analyst, and clustering parameters, and delivers the extraction conditions to the scene vector extraction unit 202 and the parameters to the scene vector clustering unit 203 (S201).

The scene vector extraction unit 202 extracts the scene vectors matching the delivered conditions from the scene vector table 107, processes the vectors in accordance with the conditions, and generates target scene vectors. The scene vector extraction unit 202 stores the target scene vectors in the target scene vector table 205, and delivers their IDs and the scene vector extraction conditions in the scene vector clustering unit 203 (S202).

The scene vector clustering unit 203 stores the delivered parameters, the target scene vector table IDs, the scene vector extraction conditions, and the date of implementation of clustering in the life pattern list table 20600 of the life pattern table 206, acquires the clustering object scene vectors from the target scene vector table 205 by using the table IDs of the target scene vectors as a key, and implements clustering in accordance with the parameters. The scene vector clustering unit 203 stores the result of clustering in the clustering result table 20610 of the life pattern table 206, and delivers a life pattern list ID to the life pattern display unit 204 (S203).

The life pattern display unit 204 acquires, using the delivered life pattern list ID as a key, a generated life pattern from the life pattern list table 20600 and the clustering result table 20610 of the life pattern table 206, and displays the pattern to the analyst (S204).

### (Process Sequence of Life Pattern Cluster Analysis Unit 30)

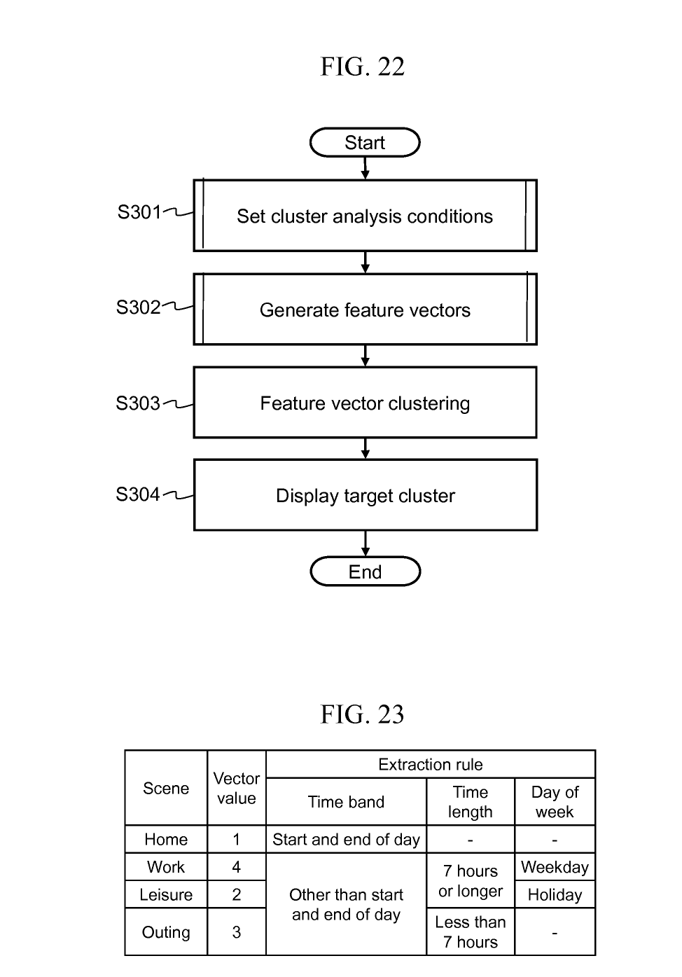

FIG. 22 is a flowchart of the process sequence in step S30. The cluster analysis condition setting unit 301 of the life pattern cluster analysis unit 30 first sets conditions for generating feature vectors as clustering objects specified by the analyst, and clustering parameters (S301). The feature vector generation unit 302 generates feature vectors in accordance with the set conditions (S302). The feature vector clustering unit 303 clusters the generated feature vectors and stores the result in the cluster table 306 (S303). The cluster display unit 304 displays the cluster to the analyst (S304).

### (Process Sequence: Detailed Process Sequence of Scene Vector Generation Unit 10)

The detailed process sequence of the scene vector generation unit 10 will be described.

### (Process Sequence: Detailed Process Sequence of Scene Extraction Unit 101 in Scene Vector Generation Unit 10)

FIG. 23 is a diagram for describing numerical values representing the scene extraction rules and scenes in the behavioral characteristics analysis device 1. As described above, in the present embodiment 1, the four scenes of “HOME”, “WORK”, “LEISURE”, “OUTING” are extracted. For extracting these scenes, according to the present embodiment 1, rules are defined using the time band in which the user went through the scene, its length, and the day of the week. Namely, the scene that appear at the start and end of the day is “HOME”; the scene that is at neither the day's start nor end and that lasts for 7 hours or longer on a weekday is “WORK”; the scene on a “holiday” is “LEISURE”; and other scenes are “OUTING”. The scenes are represented by the numerical values “1”, “4”, “2”, and “3”, respectively. The scene vector generation unit 10 extracts the scenes from the IC card utilization history 103 using the rules shown in FIG. 23, and stores them in the scene list 105, while generating scene vectors and storing them in the scene vector table 107.

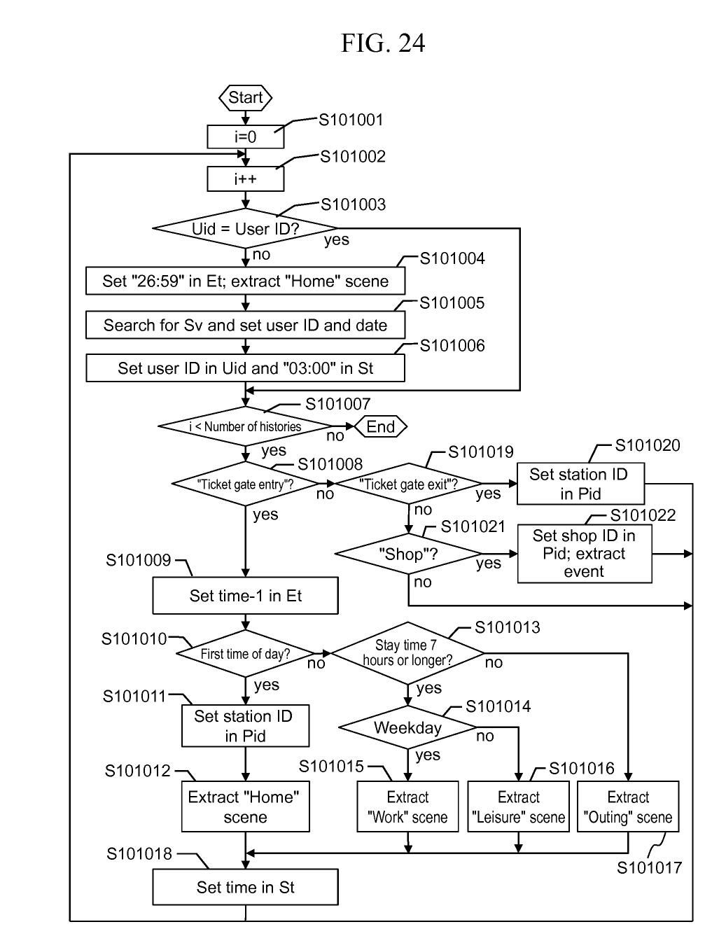

FIG. 24 is a flowchart of the detailed process sequence in step S101 implemented by the scene extraction unit 101. In FIG. 24, “i” is a variable indicating an index of the history stored in the IC card utilization history 103. In the present embodiment 1, the IC card utilization history 103 is sorted by using the user ID and the date as keys, and it is assumed that all of the stored histories are yet to be processed. Thus, 0 is set as the initial value of i. However, when scenes have been extracted from the past histories, and scenes are to be extracted from an added IC card utilization history, i indicates the index of the added history. Other variables include Uid, which is a variable setting the user ID, and Pid, which is a variable setting the location ID. Each variable is initialized by null. Sv is a variable setting scene vectors of 24 dimensions, and all of the vector values are initialized by null. St and Et are variables setting the start and end times of a scene, and are each initialized by null. Hereafter, each step in FIG. 24 will be described.

### (FIG. 24: Steps S101001 to S101003)

The scene extraction unit 101 sets 0 in i (S101001). The scene extraction unit 101 adds 1 to i (S101002), and skips to step S101007 if the i-th user ID 10301 of the utilization history in the IC card utilization history 103 is the same as Uid; otherwise, the scene extraction unit 101 goes to step S101004 (S101003).

### (FIG. 24: Step S101004)

The scene extraction unit 101, determining that the process ended for all of the utilization history of the user set in Uid, sets the day's final time “26:59” in the variable Et representing the end time of the scene, and extracts the “HOME” scene. Specifically, the scene extraction unit 101 sets Uid in the user ID 10501 at the end of the scene list 105, sets “HOME” in the scene name 10502, sets the value of St in the start time 10503, sets the value of Et in the end time 10504, sets the value of Pid (the location ID of the station exited at the end of the day) in the location ID 10505, and sets the numerical value “1” representing “HOME” in the values of time St to time Et of the scene vector Sv.

### (FIG. 24: Step S101005)

The scene extraction unit 101 refers to the scene vector table 107 to see if a scene vector corresponding to Sv is already stored. If it is already stored, the scene extraction unit 101 sets Uid in the user ID 10702 of the record in which the scene vector is stored, and sets the date portion of St (or the previous day if past 24:00) in the date 10703. If Sv is not stored in the scene vector table 107, the scene extraction unit 101 sets Sv in the time 10704 at the end of the scene vector table 107, sets Uid in the user ID 10702, and sets the date portion of St (of the previous day if past 24:00) in the date 10703. The scene extraction unit 101 further acquires the scene vector ID 10701 of the record, and searches the scene list 105 in order from the end to the list head thereof for a record with the user ID 10501 corresponding to Uid, and sets the acquired scene vector ID 10701 in the scene vector ID 10506 of the corresponding record. Similarly with respect to the event list 106, the scene extraction unit 101 sets the acquired scene vector ID 10701 in the scene vector ID 10606.

### (FIG. 24: Step S101006)

The scene extraction unit 101 sets the value of the i-th user ID 10301 of the IC card utilization history 103 in Uid, and sets the day's initial time “03:00” in the variable St representing the scene's start time, thus initializing Sv.

### (FIG. 24: Step S101007)

If i is greater than the number of histories stored in the IC card utilization history 103, the process ends; otherwise, the process goes to step S101008.

### (FIG. 24: Step S101008)

If the i-th terminal machine type 10304 of the IC card utilization history 103 is “entry ticket gate”, the process goes to step S101009; otherwise, the process goes to step S101019.

### (FIG. 24: Step S101009)

The scene extraction unit 101, if the terminal machine of the utilization history is an entry ticket gate in step S101008, determines that the scene transitioned, and stores, in the variable Et representing the scene's end time, the time stored in the i-th time 10302 of the IC card utilization history 103 that is decreased by one minute.

### (FIG. 24: Step S101010)

When the value of St indicates the day's initial scene (St=“03:00”), the process goes to step S101011; otherwise, the process goes to step S101013.

### (FIG. 24: Step S101011)

The scene extraction unit 101 acquires the i-th station name/shop name 10303 of the IC card history 103, refers to the corresponding record in the location information 210, acquires the location ID 21001 of the entry station and sets it in Pid.

### (FIG. 24: Step S101012)

The scene extraction unit 101 sets Uid in the user ID 10501 at the end of the scene list 105, sets “HOME” in the scene name 10502, sets the value set in St in the start time 10503, sets the value set in Et in the end time 10504, and sets the value of Pid in the location ID 10505 (the location ID of the day's first entry station).

### (FIG. 24: Step S101012: Supplementation)

When the ticket gate is entered for the first time in the day, it can be considered that the user stayed at home until immediately before that. Thus, the previous scene ((i−1)th scene) is extracted as a home scene.

### (FIG. 24: Step S101013)

The scene extraction unit 101 calculates the staying time (length of the scene) from the scene start time St and the end time Et. If the staying time is equal to or more than a predetermined time (such as 7 hours of more), the process goes to step S101014; otherwise, the process goes to step S101017.

### (FIG. 24: Step S101014)

The scene extraction unit 101 acquires a date from the time 10302 of the IC card utilization history 103, and further acquires the date of the history by referring to the day of the week 21102 of the calendar information 211. If the date is a weekday, the process goes to step S101015; otherwise, the process goes to step S101016.

### (FIG. 24: Step S101015)

If the ticket gate entry is for the second time or later in the day, and if the stay at the immediately preceding location lasted 7 hours or more on a weekday, it can be considered that the user was working until immediately before the entry. Thus, the scene extraction unit 101 extracts the scene “WORK” as the previous scene ((i−1)th scene). The scene extraction unit 101 sets each table value as in step S101012.

### (FIG. 24: Step S101016)

If the ticket gate entry is for the second time or later in the day, and if the stay at the immediately preceding location lasted 7 hours or longer on a day other than a weekday, it can be considered that the user was going out for a holiday until immediately before the entry. Thus, the scene extraction unit 101 extracts the scene “LEISURE” as the previous scene ((i−1)th scene). The scene extraction unit 101 sets each table value as in step S101012.

### (FIG. 24: Step S101017)

If the ticket gate entry is for the second time or later in the day, and if the stay at the immediately preceding location lasted less than 7 hours, it can be considered that the user was going out for other general purposes until immediately before the entry. Thus, the scene extraction unit 101 extracts the scene “OUTING” as the previous scene ((i−1)th scene). The scene extraction unit 101 sets each table value as in step S101012.

### (FIG. 24: Step S101018)

The scene extraction unit 101 sets the i-th time 10302 of the IC card utilization history 103 in the variable St representing the scene's start time, and then returns to step S101002.

(FIG. 24: step S101019)

If the i-th terminal machine type 10304 of the IC card utilization history 103 is “exit ticket gate”, the process goes to step S101020; otherwise, the process goes to step S101021.

### (FIG. 24: Step S101020)

If the user exited the ticket gate, the exit station is the scene location. Thus, the scene extraction unit 101 acquires the i-th station name/shop name 10303 of the IC card utilization history 103, acquires the corresponding location ID 21001 from the location information 210 and sets it in Pid, and then returns to step S101002.

### (FIG. 24: Step S101021)

If the i-th terminal machine type 10304 of the IC card utilization history 103 is “shop terminal”, the process goes to step S101022; otherwise, the process returns to step S101002.

### (FIG. 24: Step S101022)

If the utilization history is that within a shop, it can be considered that the user made payment using the electronic money function or the like. Thus, the scene extraction unit 101 sets the location ID 21001 of the shop in Pid, extracts the event “payment” and sets it in the event list 106, and then returns to step S101002. Specifically, the scene extraction unit 101 sets Uid in the user ID 10601 at the end of the event list 106, sets “payment” in the event name 10602, sets the i-th time 10302 of the IC card utilization history 103 in the time 10603, sets Pid in the location ID 10604, and sets the i-th amount 10305 of the IC card utilization history 103 in the amount 10605.

### (Process Sequence: Detailed Process Sequence of the Event Extraction Unit 102 in the Process Sequence: Scene Vector Generation Unit 10)

In step S102 of FIG. 20, the event extraction unit 102 extracts an event from the credit card utilization history 104 and stores the event in the event list 106. Specifically, the following process is implemented with respect to those of the histories stored in the credit card utilization history 104 that are to yet to be processed.

The event extraction unit 102 acquires the value of the card ID 10401 of the credit card utilization history 104, and acquires from the credit card owner information 20910 of the user information 209 information such as the owner's name, date of birth, sex, and address. Then, the event extraction unit 102 refers to the transit-system IC card user information 20900 of the user information 209, acquires from the user ID 20901 the ID corresponding to the user's name, date of birth, sex, and address, and sets the ID in the user ID 10601 at the end of the event list 106.

The event extraction unit 102 further sets “payment” in the event name 10602, and sets the time 10402 of the credit card utilization history 104 in the time 10603. Further, the event extraction unit 102 acquires, from the location information 210, the location ID 21001 of the shop name set in the shop name 10403 of the credit card utilization history 104, sets the location ID in the location ID 10604, and sets the amount 10404 of the credit card utilization history 104 in the amount 10605. The event extraction unit 102, using the user ID 10601 and the value of the time 10603 as keys, acquires from the scene vector table 107 the ID of the scene vectors including the time of the user, and sets the ID in the scene vector ID 10606.

### (Process Sequence: Detailed Process Sequence of the Life Pattern Extraction Unit 20)

Next, the detailed process sequence of the life pattern extraction unit 20 will be described with reference to a flow chart and screen examples.

### (Process Sequence: Detailed Process Sequence of the Life Pattern Extraction Condition Setting Unit 201 in the Life Pattern Extraction Unit 20)

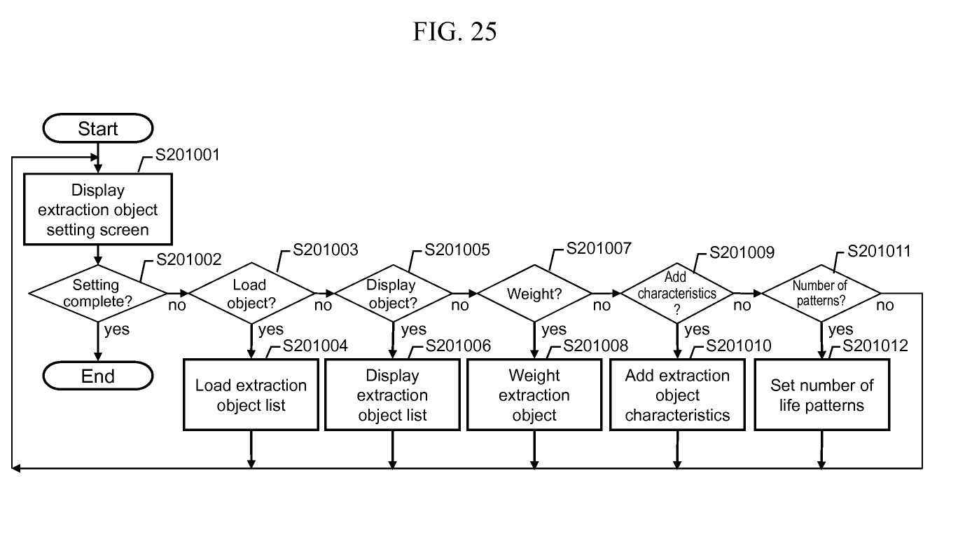

FIG. 25 is a flow chart of the detailed process sequence of step S201 implemented by the life pattern extraction condition setting unit 201. Hereafter, each step of FIG. 25 will be described.

The life pattern extraction condition setting unit 201 first displays an extracted object setting screen in step S201001. The screen configuration and the details of the input of extraction conditions in the present step by the analyst will be described below with reference to the drawings. If in step S201002, the analyst inputs an extraction condition and instructs completion of setting, the process ends. Otherwise, the process goes to step S201003. If the analyst in step S201003 instructs the reading of the list of IDs of the object persons for life pattern extraction, the process goes to step S201004; otherwise, the process goes to step S201005. In step S201004, the ID of the user as the object person is read from a file specified by the analyst. In step 201005, if the analyst instructs the reading of the extraction condition for a life pattern that has been generated in the past, the process goes to step S201006; otherwise, the process goes to step S201007. In step S201006, the extraction condition for the life pattern selected by the analyst is read. In step S201007, if the analyst instructs weighting, the process goes to step S201008; otherwise, the process goes to step S201009. In step 201008, the items (“when”, “who”, “where”, or “what scene”) that the analyst wishes to give weight to for life pattern extraction are specified. The specifying of the weighting will be described below with reference to the drawings. If in step S201009 the analyst instructs addition of a characteristic, the process goes to step S201010; otherwise, the process goes to step S201011. In step S201010, the characteristic that the analyst wishes to add is added. The addition of characteristics will be described below with reference to the drawings. If in step S201011 the analyst instructs the specifying of the number of patterns to be extracted, the process goes to step S201012; otherwise, the process returns to step S201001. In step S201012, the analyst specifies the number of life patterns to be extracted. The specifying of the number of life patterns will be described below with reference to the drawings.

### (Screen Example: Example of Life Pattern Extraction Condition Setting Screen in the Life Pattern Extraction Condition Setting Unit 201 of the Life Pattern Extraction Unit 20)

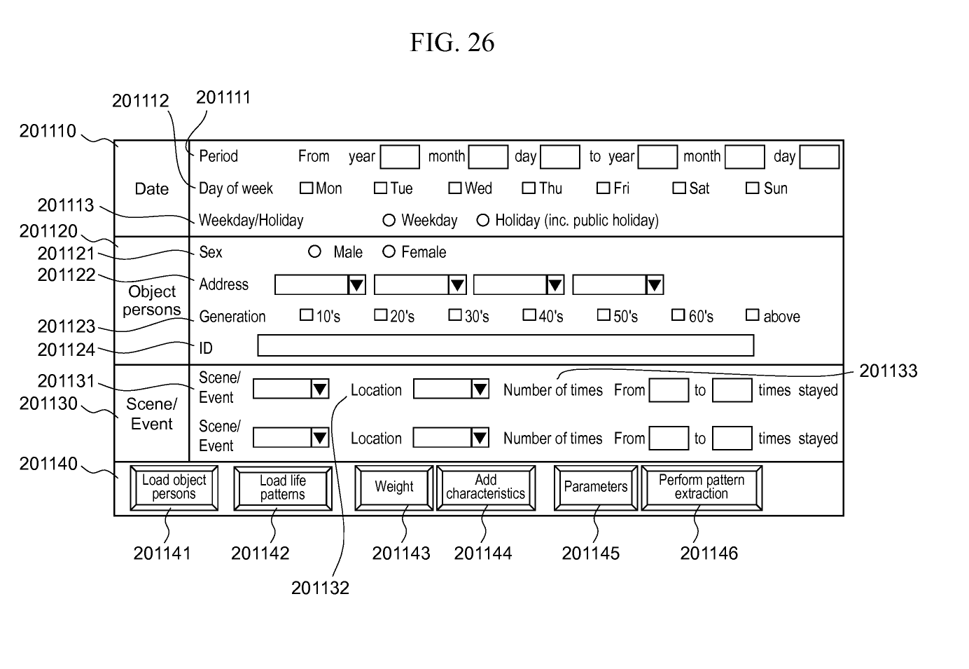

FIG. 26 illustrates an example of the life pattern extraction condition setting screen displayed by the life pattern extraction condition setting unit 201. The life pattern extraction condition setting screen includes a date setting area 201110, an object person setting area 201120, a scene/event setting area 201130, and an instruction button area 201140. Hereafter, conditions that the analyst can set in each area will be described. For ease of understanding, the process of the scene vector extracting step 202 regarding how a scene vector is extracted with respect to the set condition will also be described as needed.

The date setting area 201110 is an area for the analyst to set the period of extraction of a life pattern or the day of the week, and includes a period 201111, a day of the week 201112, and a weekday/holiday 201113. The period 201111 is an area for specifying the period of extraction of the life pattern. When the analyst specifies the period, the behavioral characteristics analysis device 1 extracts the life patterns only from the scene vectors matching the date of the specified period. While the specifying of the period 201111 is required in the present embodiment 1, this is not a limitation. When the period is not specified, the life patterns may be extracted from the scene vectors of all of the periods stored in the scene vector table 107. The day of the week 201112 is an area for selecting one or more days of the week for life pattern extraction. When the analyst selects the day of the week, the behavioral characteristics analysis device 1 extracts the life patterns only from the scene vectors matching the selected day of the week in the period specified in the period 201111. When the day of the week is not selected, the life patterns are extracted from all days of the week. The weekday/holiday 201113 is an area for selecting the type of the day for life pattern extraction. When the analyst selects the type of day, the behavioral characteristics analysis device 1 extracts the life patterns only from the scene vectors matching the selected type (weekday or holiday) in the period specified in the period 201111. When the type of day is not selected, the life patterns are extracted from the scene vectors of both weekdays and holidays.

The object person setting area 201120 is an area for the analyst to set the object person for life pattern extraction, and includes a sex 201121, an address 201122, a generation 201123, and an ID 201124. The sex 201121 is an area for selecting the sex of the object persons for life pattern extraction. When the analyst selects the sex, the behavioral characteristics analysis device 1 extracts the life patterns only from the scene vectors of the object person matching the selected sex. When the sex is not selected, the life patterns are extracted from the scene vectors of all object persons regardless of sex. The address 201122 is an area for selecting the address of the object persons for life pattern extraction. In the present embodiment 1, the address is selected from a list of the names of prefectural and city governments. However, this is not a limitation, and text input by the analyst, or selection of the names of municipalities are also possible. When the analyst selects the address, the behavioral characteristics analysis device 1 extracts the life patterns only from the scene vectors of the object person having the selected prefectural or city government as his address. When the address is not selected, the life pattern is extracted from the scene vectors of all of the object persons regardless of the prefectural or city governmental address. The generation 201123 is an area for selecting the generation of the object person for life pattern extraction. When the analyst selects one or more generations, the behavioral characteristics analysis device 1 extracts the life patterns only from the scene vectors of the object persons with the date of birth matching the selected generation. When the generation is not selected, the life patterns are extracted from the scene vectors of all of the object persons regardless of their date of birth. The ID 201124 is an area for specifying the ID of the object persons for life pattern extraction. When the analyst specifies one or more IDs, the behavioral characteristics analysis device 1 extracts the life patterns only from the scene vectors of the object person with the ID matching the specified ID. When the ID is not specified, the life pattern extracted from the scene vectors of all of the object persons regardless of the ID. The specifying of the ID by the analyst may be conducted through reading from a file.

The scene/event setting area 201130 is an area for the analyst to select a scene or event included in the scene vectors (transition of the day's scenes) for life pattern extraction, and includes a scene/event 201131, a location 201132, and a number of times 201133. The scene/event 201131 is an area for selecting the scene/event included in the scene vectors for life pattern extraction. When the analyst selects the scene (from the four of “HOME”, “WORK”, “LEISURE”, and “OUTING” in the present embodiment 1), or the event (“payment” or “deposit” in the present embodiment 1), the behavioral characteristics analysis device 1 extracts the life patterns only from the scene vectors including the selected scene or event. The location 201132 is an area for selecting the location where the scene/event included in the scene vectors for life pattern extraction took place. When the analyst specifies the location, the behavioral characteristics analysis device 1 extracts the life patterns only from the scene vectors including the location where the scene or event took place matching the specified location. More specifically, the behavioral characteristics analysis device 1 refers to the location information 210 so as to acquire the ID of the location input by the analyst, refers to the scene list 105 or the event list 106 so as to acquire the ID of the scene vectors including the location ID, and acquires from the scene vector table 107 the scene vectors and set them in the target scene vector table 205. The location may be specified not just by the location names stored in the designation 21002 of the location information 210 may also be specified by the classification name (“STATION”, “SHOP”, “FACILITY”) stored in the classification 21003, or the area name stored in the area 21004. When these are specified, the ID of the location corresponding to the selected classification or area is acquired, and the scene list 105 or the event list 106 is referenced. The number of times 201133 is an area for specifying the number of times that a scene or an event took place. When a period is specified in the period 201111 of the date setting area 201110, and when the scene or event and the location are set in the scene/event 201131 and the location 201132 of the scene/event setting area 201130, the life pattern is extracted only from the scene vectors of the user staying at the location as the scene or event the specified number of times in the period. In the screen example of FIG. 26, only two each of the scene/event 201131, the location 201132, and the number of times 201133 can be set in the scene/event setting area 201130. However, this is not a limitation, and the number of each of the scene/event 201131, the location 201132, and the number of times 201133 that can be set may be increased upon instruction from the analyst.

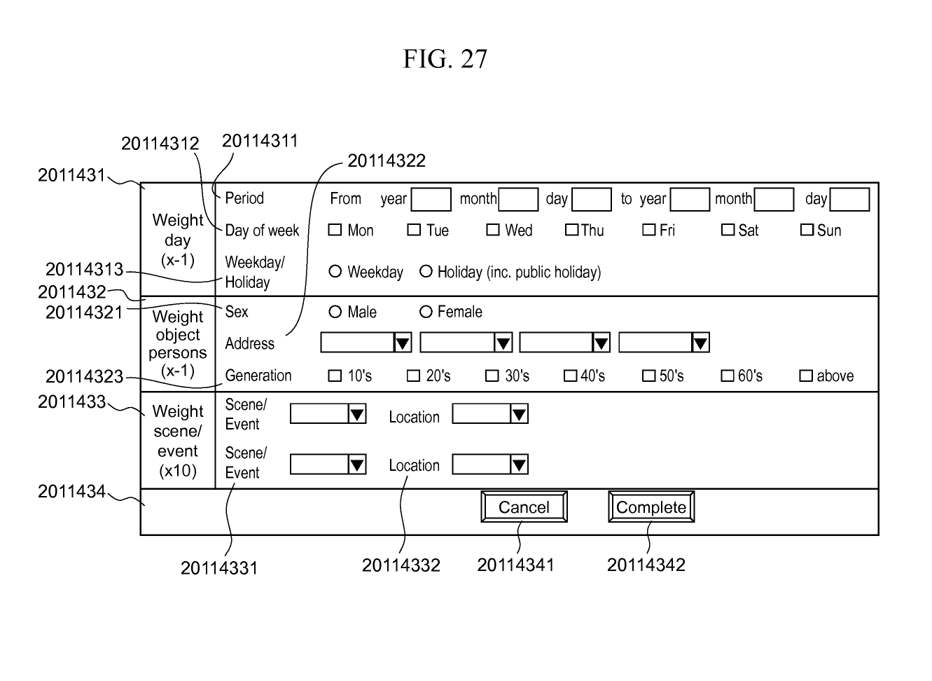

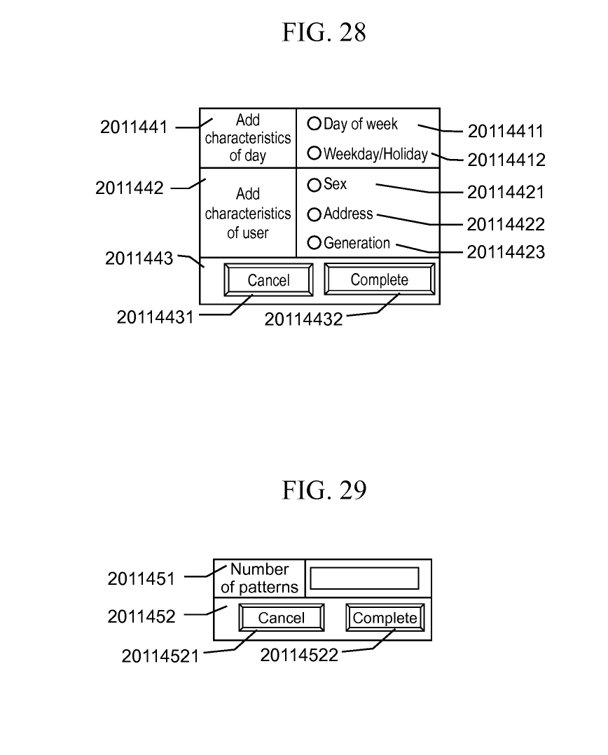

The instruction button area 201140 is an area for the analyst to instruct a life pattern extracting option, parameters, or performance of life pattern extraction, and includes an object person reading button 201141, a life pattern reading button 201142, a weighting button 201143, a characteristics addition button 201144, a parameter button 201145, and a pattern extract perform button 201146. When the analyst clicks the object person reading button 201141, the behavioral characteristics analysis device 1 displays a screen for specifying a file storing the ID of the object person. When the analyst specifies the file storing the object person ID, the behavioral characteristics analysis device 1 reads the file and displays it in the ID 201124 of the object person setting area 201120. When the analyst clicks the life pattern reading button 201142, the behavioral characteristics analysis device 1 displays a screen for selecting a life pattern that has been generated in the past. When the life pattern that has been generated in the past is selected by the analyst, the behavioral characteristics analysis device 1 reads the life pattern extraction condition and displays it in the life pattern extraction condition setting screen. When the analyst clicks the weighting button 201143, the behavioral characteristics analysis device 1 displays a weighting setting screen which will be described with reference to FIG. 27. The analyst weights a scene vector in the weighting setting screen. When the analyst clicks the characteristics addition button 201144, the behavioral characteristics analysis device 1 displays a characteristics addition setting screen which will be described with reference to FIG. 28. The analyst adds a characteristic to the scene vector in the characteristics addition setting screen. When the analyst clicks the parameter button 201145, the behavioral characteristics analysis device 1 displays a parameter setting screen which will be described with reference to FIG. 29. The analyst sets a life pattern extraction parameter in the parameter setting screen. When the analyst clicks the pattern extract perform button 201146, the behavioral characteristics analysis device 1 extracts scene vectors of the extraction object persons matching the condition set in the extraction condition setting screen, and executes clustering to extract a life pattern.

### (Screen Example: An Example of the Weighting Setting Screen in the Life Pattern Extraction Condition Setting Unit 201 of the Life Pattern Extraction Unit 20)

FIG. 27 illustrates an example of the weighting setting screen displayed by the life pattern extraction condition setting unit 201. The weighting setting screen includes a day-weighting setting area 2011431, an object person weighting setting area 2011432, a scene/event weighting setting area 2011433, and an instruction button area 2011434.

The day-weighting setting area 2011431 is an area for the analyst to set a period including the day to be weighted, a day of the week, or a weekday/holiday, and includes a period 20114311, a day of the week 20114312, and a weekday/holiday 20114313. When the analyst specifies the period 20114311, the behavioral characteristics analysis device 1 weights the scene vectors matching the date of the specified period. Specifically, when the weighting is specified, the scene vector extraction unit 202 multiplies each scene vector by a vector of which all values are “−1”. When the analyst selects the day of the week 20114312, the behavioral characteristics analysis device 1 weights the scene vectors matching the selected day of the week. Specifically, when the weighting is specified, the scene vector extraction unit 202 multiplies each scene vector by a vector of which all values are “−1”. When the analyst selects the weekday/holiday 20114313, the behavioral characteristics analysis device 1 weights the scene vector matching the selected one of the weekday and holiday (including holidays). Specifically, when the weighting is specified, the scene vector extraction unit 202 multiplies each scene vector by a vector of which all values are “−1”. By weighting the day as described above, the life pattern of the weighted day and the life pattern of the un-weighted day can be separately extracted. While in the weighting setting screen, the value of weighting of the day is “4”, this is not a limitation. Any value such that the vector whose value is a numerical value (“1”, “2”, “3”, or “4” in the present embodiment 1) representing a default scene and the vector matching the specified condition can be separated on vector space may be used.

The object person weighting setting area 2011432 is an area for the analyst to set the characteristics of the object persons that the analyst wishes to weight, and includes a sex 20114321, an address 20114322, and a generation 20114323. When the analyst selects the sex of the object person to be weighted in the sex 20114321, the behavioral characteristics analysis device 1 weights the scene vectors of the object person matching the selected sex. Specifically, when the weighting is specified, the scene vector extraction unit 202 multiplies each scene vector by a vector of which all values are “−1”. When the analyst selects the prefecture or city government of the address of the object person for weighting in the address 20114322, the behavioral characteristics analysis device 1 weights the scene vectors of the object persons having the selected prefecture or city government as the address. Specifically, when the weighting is specified, the scene vector extraction unit 202 multiplies each scene vector by a vector of which all values are “−1”. When the analyst selects the generation of the object persons to be weighted in the generation 20114323, the behavioral characteristics analysis device 1 weights the scene vectors of the object persons whose date of birth matches the selected generation. Specifically, when the weighting is specified, the scene vector extraction unit 202 multiplies each scene vector by a vector of which all values are “−1”. By weighting the object persons as described above, the life pattern of the weighted object person and the life pattern of the non-weighted object person can be separately extracted. While in the weighting setting screen the value of weighting of the object person is “−1”, this is not a limitation. Any value such that the vector whose value is a numerical value (“1”, “2”, “3”, or “4” in the present embodiment 1) representing a default scene and the vector that matches the specified condition can be separated on vector space may be used.

The scene/event weighting setting area 2011433 is an area for setting the designation and location of the scene or event the analyst wishes to weight, and includes a scene/event 20114331 and a location 20114332. When the analyst selects the scene/event 20114331, the behavioral characteristics analysis device 1 weights the time of the scene or event of the scene vectors including the selected scene or event. Specifically, when the weighting is specified, the scene vector extraction unit 202 multiplies the scene value corresponding to the time of the scene or event by “10”. When the analyst selects the location 20114332, the behavioral characteristics analysis device 1 weights the time of the scene or event, among the scene vectors, that took place at the specified location. Specifically, when the weighting is specified, the scene vector extraction unit 202 multiplies the scene value corresponding to the time of the scene or event by “10”.

In the screen example of FIG. 27, only two each of the scene/event 20114331 and the location 20114332 can be set in the scene/event weighting setting area 2011433. However, this is not a limitation, and the number of the scene/event 20114331 or the location 20114332 that can be set may be increased upon instruction from the analyst.

The instruction button area 2011434 is an area for the analyst to instruct cancellation or completion of the weighting, and includes a cancel button 20114341 and a complete button 20114342. When the analyst clicks the cancel button 20114341, the behavioral characteristics analysis device 1 clears all of the weighting settings that have been input so far, and returns to the life pattern extraction condition setting screen. When the analyst clicks the complete button 20114342, the behavioral characteristics analysis device 1 stores the weighting setting by the analyst and returns to the life pattern extraction condition setting screen.

### (Screen Example: An Example of the Characteristics Addition Setting Screen in the Life Pattern Extraction Condition Setting Unit 201 of the Life Pattern Extraction Unit 20)

FIG. 28 illustrates an example of the characteristics addition setting screen displayed by the life pattern extraction condition setting unit 201. As shown in FIG. 28, the characteristics addition setting screen includes a day characteristics addition setting area 2011441, a user characteristics addition setting area 2011442, and an instruction button area 2011443.

The day characteristics addition setting area 2011441 includes a day of the week 20114411 and a weekday/holiday 20114412. When the analyst selects the day of the week 20114411, the behavioral characteristics analysis device 1 adds a day of the week characteristic to the scene vector. Specifically, when the characteristics addition is specified, the scene vector extraction unit 202 refers to the date 10703 of the scene vector table 107, acquires from the calendar information 211 the day of the week corresponding to the date, generates vectors of 7 dimensions corresponding to Monday through Sunday, and sets 1 to the vector value of the corresponding day of the week and 0 to the rest and stores them in the characteristics 20506 of the target scene vector table 205. When the analyst selects the weekday/holiday 20114412, the behavioral characteristics analysis device 1 adds a characteristic representing the weekday/holiday to the scene vector. Specifically, when the addition of a characteristic is specified, the scene vector extraction unit 202 refers to the date 10703 of the scene vector table 107, acquires from the calendar information 211 the type of the weekday/holiday corresponding to the date, generates one dimensional vectors representing the type of the weekday and holiday, sets 1 to the vector value if the type is a weekday or 0 if otherwise, and stores the value in the characteristics 20506 of the target scene vector table 205.

The user characteristics setting area 2011442 includes a sex 20114421, an address 20114422, and a generation 20114423. When the analyst selects the sex 20114421, the behavioral characteristics analysis device 1 adds a characteristic representing the sex to the scene vector. Specifically, when the addition of a characteristic is specified, the scene vector extraction unit 202 refers to the user ID 10702 of the scene vector table 107, acquires the sex 20904 of the transit-system IC card user information 20900 of the user information 209, generates a 1-dimensional vector representing the sex, sets 1 to the vector value if the sex is male or 0 if otherwise, and sets the value in the characteristics 20506 of the target scene vector table 205. When the analyst selects the address 20114422, the behavioral characteristics analysis device 1 adds a characteristic representing the address of the user to the scene vector. Specifically, when the addition of a characteristic is specified, the scene vector extraction unit 202 refers to the user ID 10702 of the scene vector table 107, acquires the address 20905 of the transit-system IC card user information 20900 of the user information 209, generates a vector representing the address (in the present embodiment 1, the address is a vector of 5 dimensions having “Tokyo”, “Kanagawa Prefecture”, “Saitama Prefecture”, “Chiba Prefecture”, and “others” as the characteristics), sets 1 to the value of the characteristic corresponding to the user's address or 0 to the others, and sets the values in the characteristics 20506 of the target scene vector table 205. When the analyst selects the generation 20114423, the behavioral characteristics analysis device 1 adds a characteristic representing the generation to the scene vector. Specifically, when the addition of a characteristic is specified, the scene vector extraction unit 202 refers to the user ID 10702 of the scene vector table 107, acquires the date of birth 20903 of the transit-system IC card user information 20900 of the user information 209, generates a vector representing the generation (in the present embodiment 1, the generation is a vector of 7 dimensions having “10's”, “20's”, “30's”, “40's”, “50's”, “60's”, and “above” as the characteristics), sets 1 to the value of the characteristic corresponding to the user's age or 0 to the others, and sets the values in the characteristics 20506 of the target scene vector table 205.

The instruction button area 2011443 is an area for the analyst to instruct cancellation or completion of characteristics addition, and includes a cancel button 20114431 and a complete button 20114432. When the analyst clicks the cancel button 20114431, the behavioral characteristics analysis device 1 clears all of the characteristics addition settings that have been input so far, and returns to the life pattern extraction condition setting screen. When the analyst clicks the complete button 20114432, the behavioral characteristics analysis device 1 stores the characteristics addition settings by the analyst and returns to the life pattern extraction condition setting screen.

### (Screen Example: An Example of the Parameter Setting Screen of the Life Pattern Extraction Condition Setting Unit 201 of the Life Pattern Extraction Unit 20)

FIG. 29 illustrates an example of the parameter setting screen displayed by the life pattern extraction condition setting unit 201. The parameter setting screen includes a number of patterns setting area 2011451, and an instruction button area 2011452.

When the analyst specifics the number of patterns in the number of patterns setting area 2011451, the scene vector clustering unit 203 clusters the target scene vectors into a specified number of clusters. The instruction button area 2011452 is an area for the analyst to instruct cancellation or completion of the parameter setting, and includes a cancel button 20114521 and a complete button 20114522. When the analyst clicks the cancel button 20114521, the behavioral characteristics analysis device 1 clears all of the number of patterns settings that have been input so far, and returns to the life pattern extraction condition setting screen. When the analyst clicks the complete button 20114522, the behavioral characteristics analysis device 1 stores the number of patterns settings by the analyst, and returns to the life pattern extraction condition setting screen. When the analyst does not specify the number of patterns, in the present embodiment 1, the default number of clusters is 12; however, this is not a limitation.

### (Process Sequence: Detailed Process Sequence of the Scene Vector Extraction Unit 202 in the Life Pattern Extraction Unit 20)

In step S202, the scene vector extraction unit 202 extracts from the scene vector table 107 scene vectors matching the conditions set by the analyst in the life pattern extraction condition setting unit 201, while referring to the user information 209 and the calendar information 211 as needed. If the addition of a characteristic is set, the characteristic is added and stored in the time 20505 and the characteristics 20506 of the target scene vector table 205. Further, the user's ID is stored in the user ID 20502, the ID of the location where the scene or event took place is stored in the location ID 20503, and the date of the scene vector is stored in the date 20504. The scene vector extraction sequence, the weighting sequence, and the characteristics addition sequence with respect to each set condition have been described with reference to the description of the screen in the life pattern extraction condition setting unit 201, and therefore their description will be omitted.

### (Process Sequence: Detailed Process Sequence of the Scene Vector Clustering Unit 203 in the Life Pattern Extraction Unit 20)

In step S203, the scene vector clustering unit 203 executes clustering by applying the k-means method to the target scene vectors stored in the target scene vector table 205, and stores the clustering result in the clustering result table 20610 of the life pattern table 206. Specifically, the cluster ID is stored in the value of the pattern ID 20611 of the clustering result table 20610, and the average vector of the target scene vectors belonging to the cluster is stored in the average vector 20613 (the representative vector 20614 will be described below). Further, the number of the target scene vectors belonging to the cluster is stored in the vector count 20615, and the IDs of the target scene vectors are stored in the target scene vector ID 20616. Using the IDs of the target scene vectors belonging to the cluster as keys, the target scene vector table 205 is referenced, and the pattern ID is set in the pattern ID 20507 of the record with the value of the target scene vector ID 20501 corresponding to the target scene vector ID. The number of clusters in the clustering is the number of clusters set in the life pattern extraction condition setting unit 201; when not set, the number of clusters is 12, for example.

The sequence of generation of the representative scene vector 20614 of the clustering result table 20610 by the scene vector clustering unit 203 will be described. Specifically, for each of the generated clusters, the following process is implemented. First, the scene vectors belonging to the cluster is referenced, and the frequency of appearance of scenes or events is tabulated at each time. Of the scenes at each time, the scene (one or more) with the highest frequency, or with an occupancy ratio of 50% or more, for example, is determined as the typical scene of the time, and a representative vector having a numerical value representing the scene as the element value of the representative vector corresponding to the time is generated and stored in the representative scene vector 20614 of the clustering result table 20610.

### (Process Sequence: Detailed Process Sequence of the Life Pattern Display Unit 204 in the Life Pattern Extraction Unit 20)

The life pattern display unit 204 displays the life patterns extracted in steps S201 to S203. Hereafter, the process sequence of the life pattern display will be described with reference to a screen example.

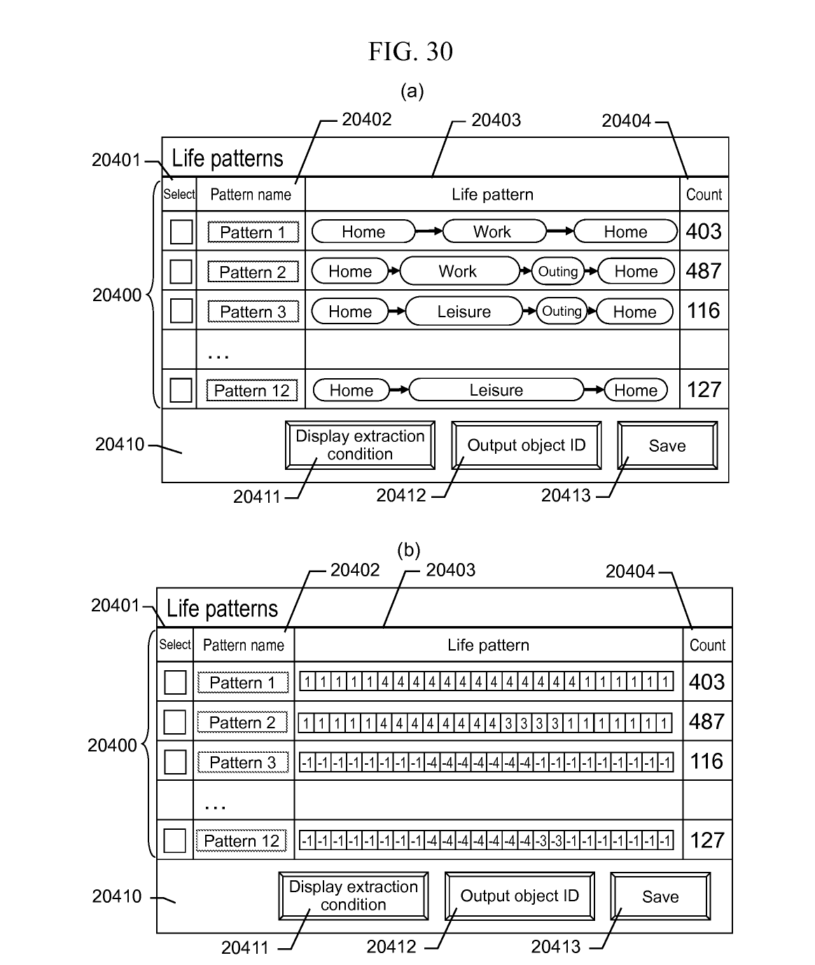

FIG. 30 illustrates an example of the screen displaying the extracted life patterns. The screen is a screen that expresses the clusters (=life patterns) generated in steps S201 to S203 as scene transitions in the same format as that of the scene vectors, thus displaying the clusters to the analyst. FIG. 30(a) is an example where the scene transitions are expressed by state transition diagrams. FIG. 30(b) is an example where the scene transitions are expressed by scene values.

As shown in FIG. 30(a), the life pattern display screen includes a life pattern display area 20400 and an instruction button area 20410.

The life pattern display area 20400 is an area for displaying the extracted life patterns, and includes a select check box 20401, a pattern name 20402, a life pattern 20403, and a count 20404. The select check box 20401 is a check box for the analyst to select a cluster when “object ID output” is executed. The pattern name 20402 is an area for displaying the pattern name. The pattern name displays the value stored in the pattern designation 20612 in the clustering result table 20610 of the life pattern table 206. When the analyst has not assigned pattern designations, automatically assigned character strings, such as “pattern 1”, “pattern 2”, and so on, are displayed. The character strings may be rewritten by the analyst as desired. For example, in FIG. 30(a), “pattern 1” is a “go-directly/return-home-directly pattern”, and “pattern 2” is a “stopping-off-on-way-home-from-work pattern”. The life pattern 204003 displays the extracted life patterns. Specifically, the scene values stored in the representative scene vector 20614 of the clustering result table 20610 are acquired, the color of nodes are set on a scene by scene basis, and the size of the nodes is set in accordance with the scene length (time length), and transitions between the scenes are expressed by arrows. The count 20404 displays the number of the target scene vectors belonging to the clusters. The number of the target scene vectors is acquired from the vector count 20615 in the clustering result table 20610.

The instruction button area 20410 includes an extraction condition display instruction button 20411, an object ID output instruction button 20412, and a save instruction button 20413. The extraction condition display instruction button 20411 is a button for instructing the display of the conditions set by the life pattern extraction condition setting unit 201. When the analyst clicks the button, the life pattern display unit 204 displays the life pattern extract setting screen shown in FIG. 26, and presents the conditions set for life pattern extraction to the analyst. The object person ID output instruction button 20412 is a button for outputting a file of the IDs of the users that appear in the cluster (life pattern) selected by the analyst. This function is provided to enable the acquisition of relevant user IDs when it is desired to analyze the users corresponding to the life pattern of interest to the analyst in greater detail or from another aspect. A list of the IDs of the users that is output may be utilized via the object person reading button 201141, for example. The IDs of the users that appear in the cluster selected by the analyst may be acquired by the following sequence. In the clustering result table 20610, the record of which the pattern ID 20611 corresponds to the ID of the pattern selected by the analyst is referenced, the target scene vector table 205 is referenced by acquiring the target scene vector ID stored in the target scene vector ID 20616 of the record, and the user ID stored in the user ID 20502 is acquired. The save instruction button 20413 is a button for instructing the saving of the extracted life pattern, which may be recorded with a designation the analyst can easily understand attached thereto, such as “—station staying pattern”.

FIG. 30(b) is an example of indicating the scene transitions by vector, where the color of the vector values is set on a scene by scene basis, with a numerical value representing the scene set for each time. The configuration and functions of the screen in FIG. 30(b) are similar to those of FIG. 30(a) and their description is omitted.

### (Process Sequence: Detailed Process Sequence of the Life Pattern Cluster Analysis Unit 30)

The detailed process sequence of the life pattern cluster analysis unit 30 will be described below.

### (Process Sequence: Detailed Process Sequence of the Life Pattern Cluster Analysis Condition Setting Unit 301 of the Life Pattern Cluster Analysis Unit 30)

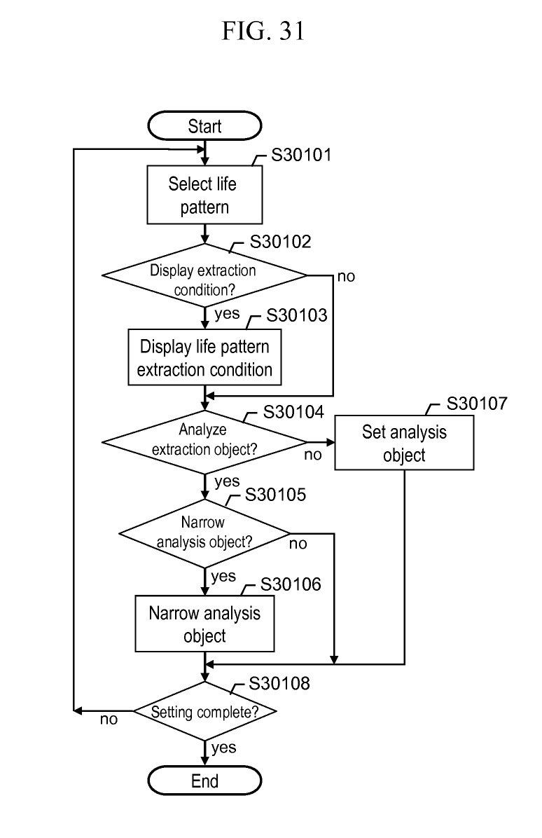

FIG. 31 is a flowchart of the detailed process sequence of step S301 implemented by the cluster analysis condition setting unit 301. Hereafter each step of FIG. 31 will be described.

The cluster analysis condition setting unit 301 receives the result of selection of the life pattern used for characterizing the analysis object (S30101). When the analyst instructs the display of extraction conditions for the selected life pattern, the process goes to step 30103; otherwise, the process skips to step S30104 (S30102). In step S30103, the extraction conditions for the selected life pattern are displayed to the analyst. The display of the extraction conditions will be described below with reference to the drawings. If in step S30104 the analyst instructs that the users or locations appearing in the scene vectors from which the life pattern has been extracted be made analysis objects, the process goes to step S30105; otherwise, the process goes to step S30107. In step S30105, if the analyst instructs to narrow the analysis objects, the process goes to step S30106; otherwise, the process skips to step S30108. In step S30106, the selected life pattern extraction conditions are displayed to the analyst, and the analyst narrows the conditions. The narrowing of the analysis objects will be described below. In step S30107, the analyst sets the analysis objects, and the process goes to step S30108. The setting of the analysis objects will be described later. In step S30108, if the analyst instructs ending the setting of the life pattern cluster analysis conditions, the process ends; otherwise, the process returns to step S30101.

### (Screen Example: An Example of the Life Pattern Cluster Analysis Condition Setting Screen in the Life Pattern Cluster Analysis Condition Setting Unit 301 of the Life Pattern Cluster Analysis Unit 30)

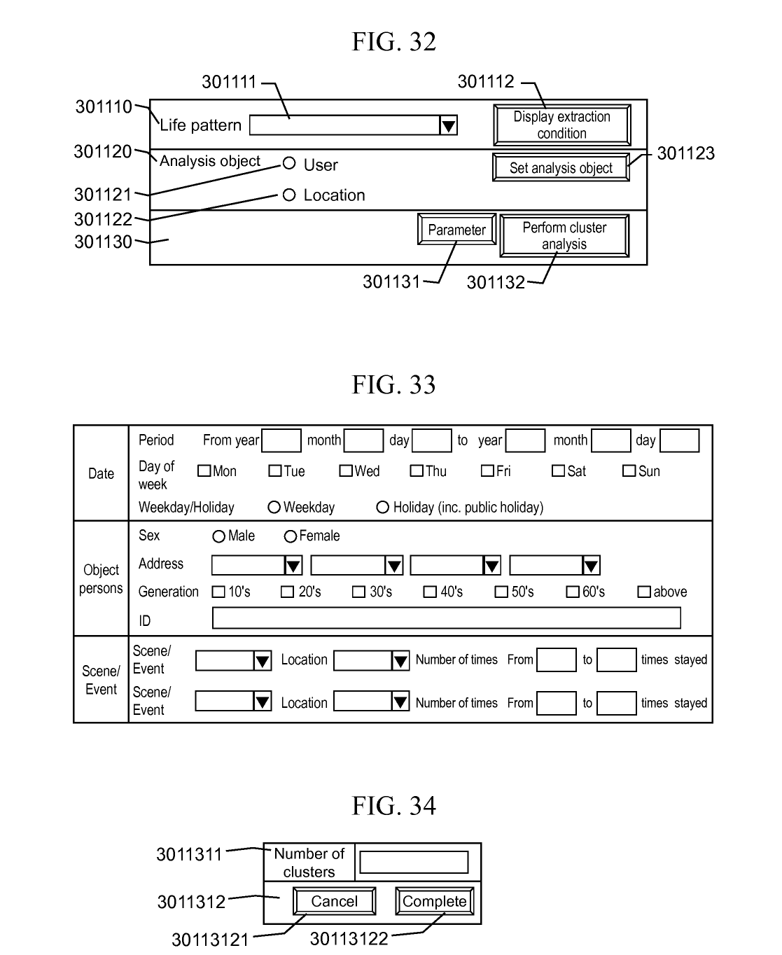

FIG. 32 illustrates an example of the life pattern cluster analysis condition setting screen displayed by the cluster analysis condition setting unit 301 in step S301. The life pattern cluster analysis condition setting screen includes a life pattern select area 301110, an analysis object setting area 301120, and an instruction button area 301130.

The life pattern select area 301110 includes a life pattern selection 301111 and an extraction condition display button 301112. The life pattern selection 301111 is an area for the analyst to select one of the generated life patterns that is to be used for characterizing the analysis objects. The extraction condition display button 301112 is a button for instructing the display of extraction conditions for the life pattern selected by the analyst. When the analyst clicks the extraction condition display button 301112, the behavioral characteristics analysis device 1 displays a life pattern extraction condition display screen described with reference to FIG. 33, and displays the selected life pattern extraction conditions.

The analysis object setting area 301120 includes a radio button 301121 for instructing that the analysis objects be users, a radio button 301122 for instructing that the analysis objects be locations, and an analysis object set button 301123. If the analyst clicks the analysis object set button 301123, the behavioral characteristics analysis device 1 displays an analysis object setting screen. The analysis object setting screen is similar to the life pattern extraction condition setting screen shown in FIG. 33, and therefore their detailed description is omitted. The analysis object setting screen displays selected life pattern extraction conditions selected by default. The analyst sets the analysis objects by modifying the extraction conditions. For example, when the life pattern extraction condition is “the life patterns for one month of persons who stayed at X station in Dec. 1, 2010”, the users' sex is narrowed down to female only, or “X station” is changed to “Y station”. When the analyst selects the radio button 301121 thus instructing that the analysis objects be users, the behavioral characteristics analysis device 1 makes the users matching the analysis conditions the analysis objects. On the other hand, when the analyst selects the radio button 301122 thus instructing that the analysis objects be locations, the behavioral characteristics analysis device 1 makes the locations that appeared in the scene vectors the analysis objects.

The instruction button area 301130 includes a parameter setting instruction button 301131, and a cluster analysis perform button 301132. When the analyst clicks the parameter setting instruction button 301131, the behavioral characteristics analysis device 1 displays the parameter setting screen shown in FIG. 34. The analyst sets life pattern extraction parameters in the parameter setting screen. When the analyst clicks the cluster analysis perform button 301132, the behavioral characteristics analysis device 1 extracts the analysis objects matching the conditions set in the analysis object setting area 301120, counts the frequency of appearance of life patterns, generates the feature vectors, and executes clustering, thus generating clusters.

FIG. 33 illustrates an example of the life pattern extraction condition display screen that is displayed when the extraction condition display button 301112 is clicked. FIG. 33 is the same as the configuration of the life pattern extraction condition setting screen shown in FIG. 26 (except for the instruction button area 201140), and therefore detailed description of FIG. 33 is omitted.

FIG. 34 illustrates an example of the parameter setting screen that is displayed when the parameter setting instruction button 301131 is clicked. The parameter setting screen includes a number of clusters setting area 3011311 and an instruction button area 3011312. When the analyst specifies the number of clusters in the number of clusters setting area 3011311, the feature vector clustering unit 303 clusters the feature vectors into the specified number of clusters. The instruction button area 3011312 is an area for the analyst to instruct cancellation or completion of cluster setting, and includes a cancel button 30113121 and a complete button 30113122. When the analyst clicks the cancel button 30113121, the behavioral characteristics analysis device 1 clears all of the settings of the number of clusters that have been input so far, and returns to the life pattern cluster analysis condition setting screen. When the analyst clicks the complete button 30113122, the behavioral characteristics analysis device 1 stores the setting of the number of clusters and returns to the life pattern cluster analysis condition setting screen. If the analyst does not specify the number of clusters, the present embodiment 1 sets 20 as the default number of clusters; however, this is not a limitation.

### (Process Sequence: Detailed Process Sequence of the Feature Vector Generation Unit 302 of the Life Pattern Cluster Analysis Unit 30)

The feature vector generation unit 302 generates in step S302 feature vectors which are the analysis objects characterized by the frequency of appearance of life patterns. Specifically, it is checked, with respect to the target scene vectors concerning the analysis objects, which life pattern each of the target scene vectors matches, and the number of the matching target scene vectors is counted on a life pattern basis. Then, vectors having the life pattern as the element number and the number of the matching the target scene vectors as the element value are generated.

The target scene vectors as the objects for the counting of the frequency may be the target scene vectors generated by life pattern extraction if the analysis object setting conditions are the same as the extraction conditions for the life pattern extraction. On the other hand, if the analysis object setting conditions are different from the life pattern extraction conditions, the target scene vectors for the analysis objects are generated by the same sequence as in the scene vector extraction unit 202, similarity is calculated to see which life pattern each of the target scene vectors matches, and then the target scene vectors are assigned to the life patterns with the highest similarity, followed by counting of the number of the matching target scene vectors life on a pattern by pattern basis.

The analysis objects are users or locations, as described above. When users are the analysis objects, the user IDs of the target scene vectors may be referenced, and the frequency of the matching life patterns may be counted on a user by user basis. When locations are the analysis objects, the location IDs are acquired from the scene vector table 107, the scene list 105, and the event list 106 using the user IDs and dates of the target scene vectors as keys, and the frequency of the matching life patterns is counted on a location by location basis.

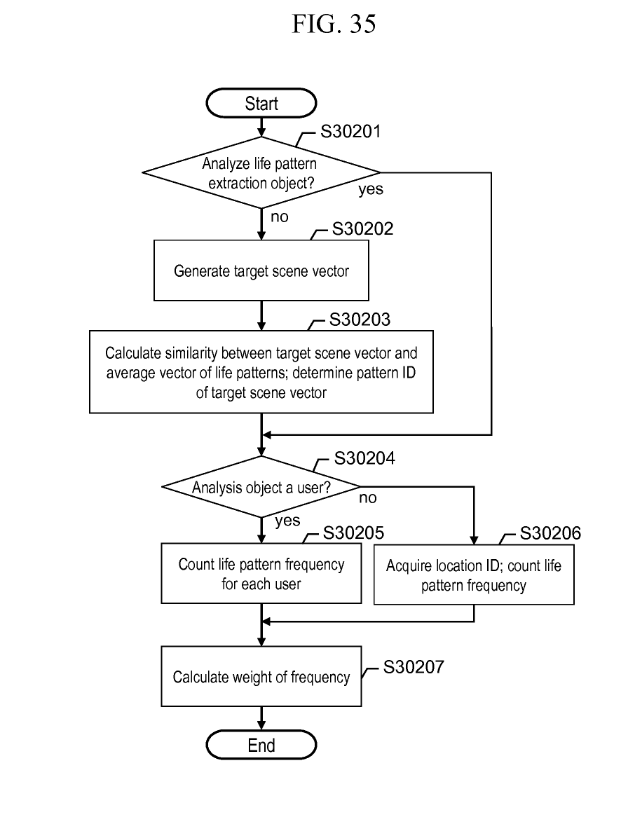

FIG. 35 is a flowchart of the detailed process sequence of step S302 implemented by the feature vector generation unit 302. Hereafter, each step of FIG. 35 will be described.

### (FIG. 35: Step S30201)

The feature vector generation unit 302 checks to see whether the life pattern extraction conditions selected by the cluster analysis condition setting unit 301 and the cluster analysis object setting conditions set in the cluster analysis object setting screen are the same. If they are the same, the process skips to step S30204; otherwise, the process goes to step S30202.

### (FIG. 35: Step S30202)

The feature vector generation unit 302 generates target scene vectors matching the cluster analysis conditions, and stores the matching vectors in the target scene vector table 205. The process sequence for generating the target scene vectors is similar to the process sequence of the scene vector extraction unit 202, and therefore its description is omitted.

### (FIG. 35: Step S30203)

The feature vector generation unit 302 implements the following process on each of the target scene vectors generated in step S30202. Similarity between the target scene vector and the average vector 20613 of each life pattern stored in the clustering result table 20610 is calculated, and the ID of the life pattern with the highest similarity is acquired and stored in the pattern ID 20507 of the target scene vector table 205. For the similarity between the target scene vector and the average vector of the life patterns, a method may be applied by which the distance (Euclid distance) between vectors is determined as the similarity.

### (FIG. 35: Step S30204)

When the analyst has selected users as the analysis objects, the process goes to step S30205; otherwise, the process goes to step S30206.

### (FIG. 35: Step S30205)

The feature vector generation unit 302 refers to the target scene vector table 205, acquires the frequency of appearance of life patterns on a user by user basis, and stores the frequency in the feature vector table 305. Specifically, the user ID is set in the analysis object 30502 of the feature vector table 305, and, if the user ID 20502 in the target scene vector table 205 is the same as the user ID, the life pattern ID stored in the pattern ID 20507 is acquired, and 1 is added to the value of the pattern ID in the life pattern ID 30503 in the feature vector table 305 that corresponds to the acquired pattern ID.

### (FIG. 35: Step S30206)

The feature vector generation unit 302 counts the frequency of appearance of the life patterns, as in step S30205. However, the counting is performed on the location ID rather than the user ID basis, and the frequency is stored in the feature vector table 305. Specifically, the location ID is set in the analysis object 305002 in the feature vector table 305. If the location ID 20503 of the target scene vector table 205 is the same as the location ID, the life pattern ID stored in the pattern ID 20507 is acquired, and 1 is added to the value corresponding to the acquired pattern ID in the life pattern ID 30503 in the feature vector table 305.

### (FIG. 35: Step S30207)

The feature vector generation unit 302 weights the counted frequency of appearance of the life patterns. Some life patterns may appear in many of the analysis objects, and some life patterns may appear only in specific analysis objects. The frequency of appearance of the former life patterns is not useful for characterization even if their frequency is high, and the latter should be considered important. Thus, the present embodiment 1 performs weighting such that the frequency of appearance of the former is decreased while the frequency of appearance of the latter is increased. Specifically, the tf-idf method in a vector space model is applied. The tf-idf method is a well-known art described in many literatures, and therefore its description is omitted.

### (Process Sequence: Detailed Process Sequence of the Feature Vector Clustering Unit 303 in the Life Pattern Cluster Analysis Unit 30)

The feature vector clustering unit 303 in step S303 executes clustering by applying the k-means method to the feature vectors stored in the feature vector table 305, and stores the result in the clustering result table 30610. Specifically, the cluster ID is stored in the value of the cluster ID 30611 in the clustering result table 30610, and the average vector of the feature vectors belonging to the cluster in the average vector 30613. The representative life pattern 30614 stores the ID of the life pattern characterizing the cluster. Specifically, the average vector of the feature vectors belonging to the cluster is referenced, and the element number with the vector value equal to or more than a threshold value, i.e., the ID of the life pattern, is acquired and stored. Further, the number of the feature vectors belonging to the cluster is stored in the vector number 30615, and the IDs of the feature vectors are stored in the feature vector ID 30616. The number of clusters in the clustering is the number of clusters set by the life pattern cluster analysis condition setting unit 301 (or 20 if not set).

### (Process Sequence: Detailed Process Sequence of the Cluster Display 304 in the Life Pattern Cluster Analysis Unit 30)

The cluster display unit 304 displays the generated cluster in step S304. Hereafter, the process sequence of the cluster display 304 will be described with reference to a screen example. In the following description, it is assumed that the life pattern list table 20600 has been searched by using the life pattern list IDs stored in the life pattern list ID 30604 of the cluster list table 30600 as keys, and the clustering result table 20610 corresponding to the life pattern list IDs has been acquired, and the clustering result table 20610 in which the life patterns used for cluster analysis are stored can be referenced.

FIG. 36 illustrates an example of the screen on which the cluster display unit 304 displays the clusters. As shown in FIG. 36, the cluster display screen includes a cluster display area 30400 and an instruction button area 30410.

The cluster display area 30400 is an area for displaying the generated clusters, and includes a select check box 30401, a cluster name 30402, a representative life pattern 30403, and a count 30404. The select check box 30401 is a check box for the analyst to select the cluster when performing “detailed analysis” and “object ID output”. The cluster name 30402 is an area for displaying the cluster names. The cluster names display the values stored in the cluster designation 30612 in the clustering result table 30610 of the cluster table 306. When the analyst has not assigned designations to the clusters, automatically assigned character strings, such as “cluster 1”, “cluster 2”, and so on, are displayed. The character strings may be rewritten at the discretion of the analyst. The representative life pattern 30403 displays the life patterns that characterize the clusters. Specifically, the IDs of the life patterns stored in the representative life pattern 30614 of the clustering result table 30610 are acquired, the clustering result table 20610 of the life pattern table 206 is search by using the life pattern IDs as keys, the representative vector 20614 corresponding to the life patterns is acquired, and a scene transition diagram similar to FIG. 30(a) is generated using the representative vector and displayed. The count 30404 displays the number of the feature vectors belonging to the clusters. The number of the feature vectors is acquired from the number of the feature vectors 30615 in the clustering result table 30610. In the cluster analysis, the feature vectors are generated for each user or location as the analysis object. Thus, the number of the feature vectors represents the number of the users or locations belonging to the clusters.

The instruction button area 30410 includes a detailed analysis instruction button 30411, an object ID output instruction button 30412, and a save instruction button 30413. The detailed analysis instruction button 30411 is a button for the analyst to instruct a detailed analysis of the clusters. The detailed analysis will be described later with reference to a screen example. The object ID output instruction button 30412 is a button for the analyst to instruct the output of a file of the IDs of the analysis objects belonging to the selected cluster. By selecting the cluster and outputting the file of the object IDs, the life patterns can be extracted in accordance with another condition with respect to the output IDs as the objects, or cluster analysis can be performed. The save instruction button 30413 is a button for the analyst to instruct saving of the clusters by assigning easy-to-understand designations to the clusters.

Next, the detailed analysis will be described. The detailed analysis is a function that is used when the analyst wishes to analyze the analysis objects belonging to each cluster in detail according to the characteristics and the like of the scene vectors. When the analyst selects the cluster in the cluster display screen and clicks the detailed analysis instruction button 30411, the detailed analysis screen is displayed.

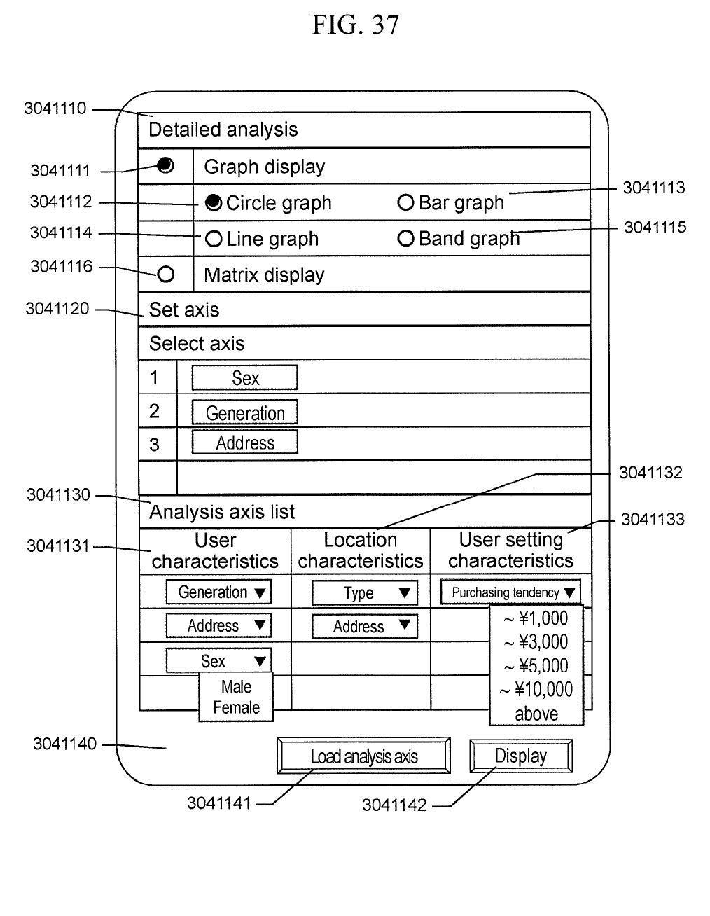

FIG. 37 illustrates an example of the detailed analysis. The detailed analysis screen includes a display format select area 3041110, an axis setting area 3041120, an analysis axis list 3041130, and an instruction button area 3041140.

In the display format select area 3041110, the analyst can select a graph display 3041111 or a matrix display 3041116. When the graph display 3041111 is selected, the contents of the characteristic of the selected cluster are displayed in a graph. The displayable graphs include a circle graph 3041112, a bar graph 3041113, a broken line graph 3041114, and a band graph 3041115; however, this is not a limitation. The graph display will be described later with reference to a screen example. When the matrix display is selected, the contents of the characteristics of the selected cluster are displayed in a matrix. The matrix display will be described later with reference to a screen example.

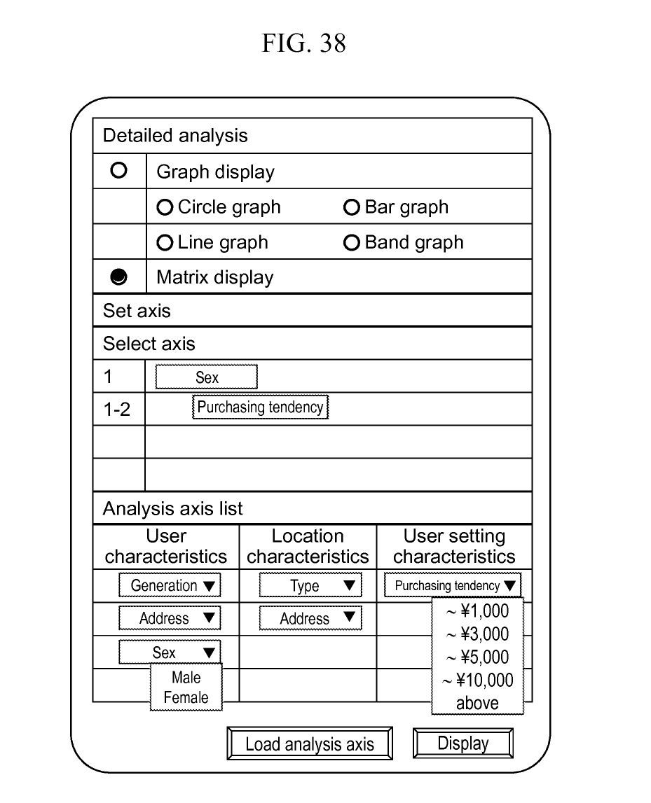

The axis setting area 3041120 is an area for the analyst to drag or drop, from an analysis axis list 3041130, an axis to be used as an aspect of analysis. A plurality of axes may be selected, and it can also be specified whether the respective selected axes are to be used independently or dependently on each other. Specifically, when the axis to be used is dragged from the analysis axis list 3041130 and dropped in the axis setting area 3041120, if the analyst drops the axis at the same level of an axis that is already set, the axes are independently used. On the other hand, if the analyst drops the axis at a level subordinate to the already set axis, the dropped axis is used as a subordinate axis to the already set axis. In the screen example of FIG. 37, the three axes of “sex”, “generation”, and “address” are set at the same level in the axis setting area 3041120. Thus, the behavioral characteristics analysis device 1 displays the “by male/female”, “by generation”, and “by address” contents of the cluster selected by the analyst. On the other hand, in a screen example of FIG. 38 which will be described later, the two axes of “sex” and “purchasing tendency” are set where “purchasing tendency” is set at a level subordinate to “sex”. Thus, the behavioral characteristics analysis device 1 divides the users belonging to the cluster selected by the analyst first into males and females, and then displays the males and females by purchasing tendency separately.

The analysis axis list 3041130 is an area for displaying the axis as the analysis aspect. The analysis axis has three types of user characteristics 3041131, location characteristics 3041132, and user set characteristics 3041133 set by the user. The user characteristics 3041131 are an axis that is effective when the analysis objects are users, and include the three types of generation, address, and sex. These may be acquired from the user information 209 using the user ID as a key. The location characteristics 3041132 are an axis that is effective when the analysis objects are locations, and include type and address. These may be acquired from the location information 210 using the location ID as a key. The user characteristics and location characteristics are axes prepared by the behavioral characteristics analysis device 1 in advance, whereas the user set characteristics are an axis set by the analyst. Specifically, data storing the IDs of the analysis objects (user IDs or location IDs) and their characteristics are prepared by the analyst beforehand, and the data are read via the detailed analysis screen, whereby the axis set by the user can be utilized. As an example of the user set axis, FIG. 37 shows “purchasing tendency”. This axis is an axis indicating the users' purchasing tendency, i.e., the tendency indicating what amounts are being used for purchases. The axis is read by generating data by the analyst analyzing to which type among “to ¥10000”, “to ¥3000”, and so on, the purchases belong to on a user ID basis, using some means (which is not described in the present specification).

The instruction button area 3041140 includes an analysis axis reading instruction button 3041141 and a display instruction button 3041142. The analysis axis reading instruction button 3041141 is a button for instructing the reading of the user set axis data from external data. The display instruction button 3041142 is a button for instructing the display of the details of the selected cluster in the display format and the analysis axes selected by the analyst.

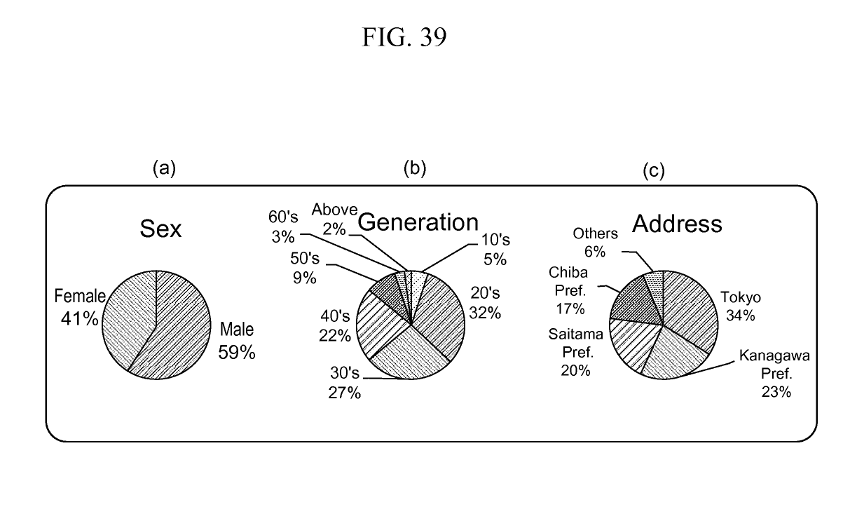

In FIG. 37, as an example of the detailed analysis, the analyst sets “sex”, “generation”, and “address” to independent axes, and instructs the circle graph display. In this state, when the analyst clicks the display instruction button 3041142, a screen shown in FIG. 39 is displayed, as will be described below.

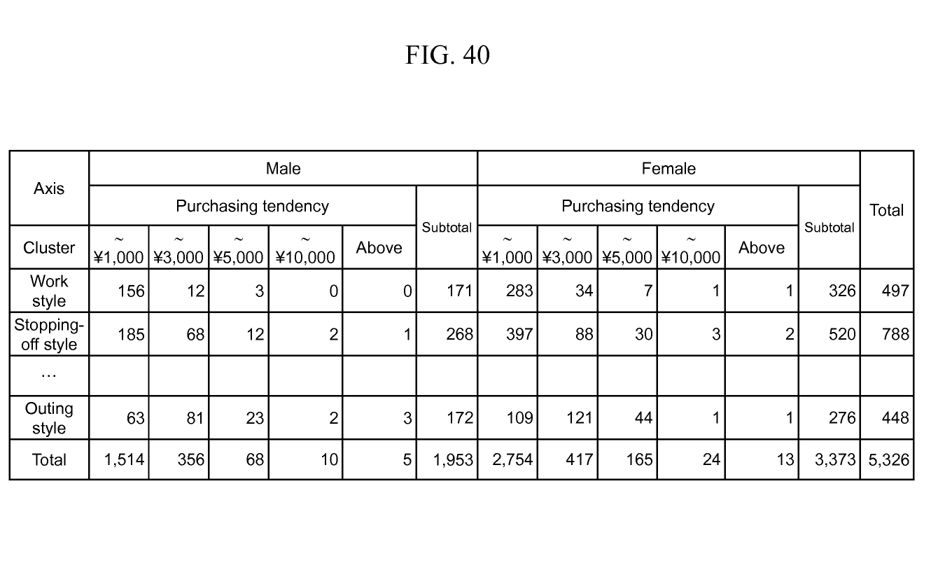

FIG. 38 illustrates an example of the detailed analysis screen. In this figure, the analyst has selected a plurality of clusters as an example of the detailed analysis, set “sex” to the first axis in the axis setting area 3041120, set “purchasing tendency” as a subordinate axis, and instructed the matrix display. In this state, when the analyst clicks the display instruction button 3041142, a screen shown in FIG. 40 is displayed.

FIG. 39 illustrates an example of the circle graph display. In the screen, the contents of the users belonging to the cluster selected by the analyst are displayed in the ratios by male/female in (a), by generation in (b), and by prefectural and city governments of the address in (c).

FIG. 40 illustrates an example of the matrix display. In the screen, the behavioral characteristics analysis device 1 divides the users belonging to the cluster selected by the analyst first by sex and then by purchasing tendency, displaying the number of corresponding persons in the respective cells.

### Embodiment 1

### Conclusion

As described above, the behavioral characteristics analysis device 1 according to the present embodiment 1 can provide the following effects.

### (1) Completeness and Scalability

According to the present invention, the day of the users is viewed as a scene transition, and the scene transition is expressed by scene vectors. In this way, the number of dimensions of the vectors is constant regardless of the number of the scenes that the users went through in the day, while the day of the users can be covered. Thus, the day of the users can be considered as objects exhaustively and in a scalable manner, regardless of the number of the users. The life patterns of the day of the users are extracted by clustering the scene vectors. Thus, the number of the life patterns can be kept within a reasonable range even if the number of the users is very large. Further, the analysis objects are characterized using the extracted life patterns as characteristics, so that it can be expected that the generated feature vectors are not sparse, and good clustering results can be obtained.

### (2) Analysis Diversity and Usability

The vectors representing the day's scene transition facilitate the weighting of the day or users of interest to the analyst, the weighting of the scene of interest in the day, or characteristics addition. Further, by using the day's life patterns, weekly patterns or monthly patterns can be extracted. Thus, the analyst can perform the behavior pattern extraction in accordance with the purpose of the analysis flexibly, and can perform a desired analysis easily.

### Embodiment 2

In embodiment 2 of the present invention, a configuration example will be described in which life patterns in a period having a certain period as the unit (such as a week or ten days) are extracted using a life pattern having the day as the unit, vectors having the frequency of appearance of the life patterns in the period as a feature quantity are generated, and multi-phase clustering that clusters users or locations is implemented. The behavioral characteristics analysis device 1 according to the present embodiment 2 has the same hardware configuration as that of the embodiment 1, and therefore its description is omitted.

### (Overall Configuration of System)

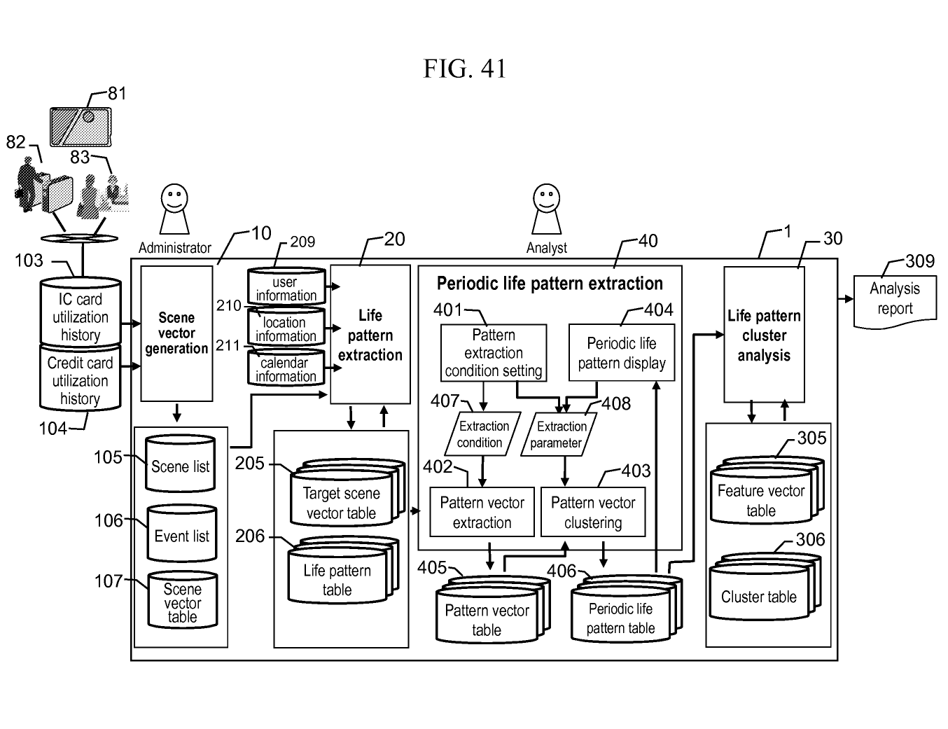

FIG. 41 is a configuration diagram of the behavioral characteristics analysis device 1 according to the present embodiment 2. The behavioral characteristics analysis device 1 according to the present embodiment 2 comprises largely the following four functions; namely, a scene vector generation unit 10, a life pattern extraction unit 20, a periodic life pattern extraction unit 40, and a life pattern cluster analysis unit 30. Of these functions, the scene vector generation unit 10, the life pattern extraction unit 20, and the life pattern cluster analysis unit 30 are similar to those of the behavioral characteristics analysis device 1 according to embodiment 1, and therefore their detailed description will be omitted.

### (Functional Configuration of System: Periodic Life Pattern Extraction Unit 40)

The periodic life pattern extraction unit 40 extracts the life patterns in a period by using the day's life patterns extracted by the life pattern extraction unit 20. The periodic life pattern extraction unit 40 receives the life pattern table 206 as an input, and outputs data to a pattern vector table 405 and a periodic life pattern table 406. The periodic life pattern extraction unit 40 also generates an extraction condition 407 and a parameter 408 as temporary data. The details of the input data are the same as those of the present embodiment 1. The details of the output data and an example of the temporary data will be described with reference to the drawings.

The periodic life pattern extraction unit 40 further includes the four functional units of a pattern extraction condition setting unit 401, a pattern vector extraction unit 402, a pattern vector clustering unit 403, and a periodic life pattern display unit 404. The details of these functional units will be described with reference to a flow chart.

### (Data Configuration: Pattern Vector Table 405)

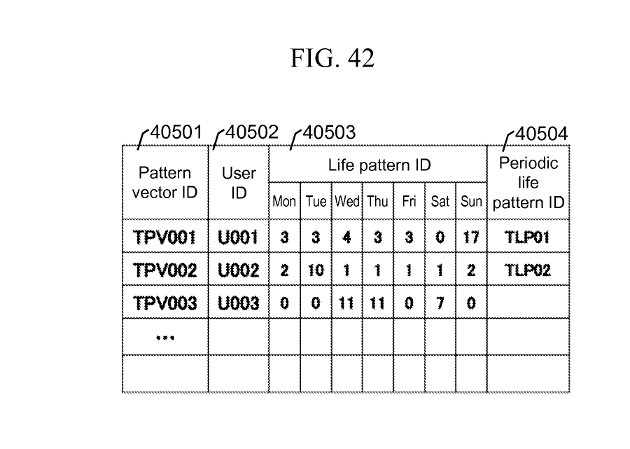

FIG. 42 illustrates a data configuration of the pattern vector table 405. The pattern vector table 405 is data storing pattern vectors representing an arrangement of the day's life patterns. The pattern vector table 405 includes a pattern vector ID 40501, a user ID 40502, a life pattern ID 40503, and a periodic life pattern ID 40504. The pattern vector ID 40501 stores IDs identifying the pattern vectors. The user ID 40502 stores the IDs of the users corresponding to the periodic life patterns. The life pattern ID 40503 stores the IDs of the day's life patterns in the period. The periodic life pattern ID 40504 stores the IDs of the periodic life patterns extracted as a result of clustering of the pattern vectors.

### (Data Configuration: Periodic Life Pattern Table 406)

The periodic life pattern table 406 stores the result of clustering of the pattern vectors. In the present embodiment 2, as in embodiment 1, the k-means method is used as the clustering algorithm. The number of the generated clusters is specified as a periodic life pattern extraction parameter. The IDs of the generated clusters is automatically assigned by the algorithm.

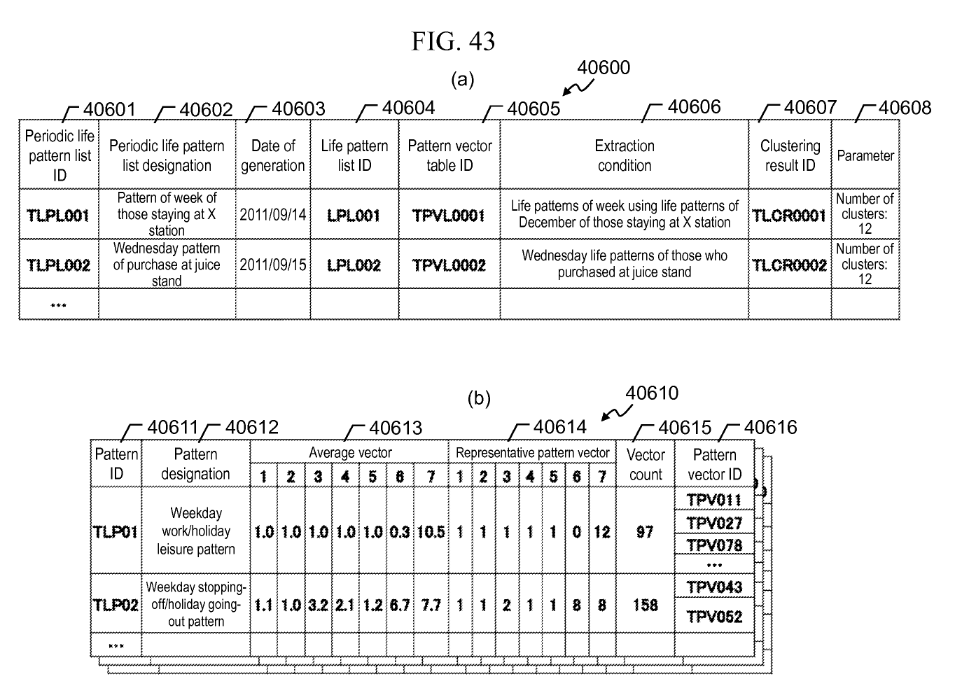

FIG. 43 illustrates a data configuration of the periodic life pattern table 406. The periodic life pattern table 406 includes a periodic life pattern list table 40600 shown in FIG. 43(a), and a clustering result table 40610 shown in FIG. 43(b).

The periodic life pattern list table 40600 is a table storing the extraction conditions or parameters and the like for the periodic life patterns that have been generated so far. The clustering result table 40610 is generated each time the periodic life pattern extraction unit 40 performs the clustering of the pattern vectors. The generated clustering result table 40610 is identified by the ID stored in the clustering result ID 40607 of the periodic life pattern list table 40600, and is saved in the absence of a deletion instruction from the analyst.

The periodic life pattern list table 40600 includes a periodic life pattern list ID 40601, a periodic life pattern list designation 40602, a date of generation 40603, a life pattern list ID 40604, a pattern vector table ID 40605, an extraction condition 40606, a clustering result ID 40607, and a parameter 40608. The periodic life pattern list ID 40601 stores the IDs for identifying the extraction conditions or clustering results stored in the periodic life pattern list table 40600. The periodic life pattern list designation 40602 stores the designations assigned to the extraction conditions or clustering results by the analyst for ease of understanding. The life pattern list designation 40602, in its initial state, stores the periodic life pattern list IDs. The date of generation 40603 stores the dates of clustering. The life pattern list ID 40604 stores the life pattern list ID 20601 in the life pattern table 206 in which the day's life patterns used for pattern vector generation is stored. The pattern vector table ID 40605 stores the IDs identifying the pattern vector table 405 as the object of clustering. The extraction condition 40606 stores the conditions set by the analyst for pattern vector generation. In FIG. 43, the extraction conditions stored in the extraction condition 40606 are described in natural sentences, such as “ . . . of December of persons who stayed at X station . . . ”, this is merely for ease of understanding. In practice, the extraction conditions are lists of groups of conditions and values set by the pattern extraction condition setting unit 401. The clustering result ID 40607 stores the ID assigned to the clustering result table 40610 in which the result of clustering of the pattern vectors is stored. The parameter 40608 stores the parameters set by the analyst for pattern vector clustering.

The clustering result table 40610 includes a pattern ID 40611, a pattern designation 40612, an average vector 40613, a representative pattern vector 40614, a vector count 40615, and a pattern vector ID 40616. The pattern ID 40611 stores the ID assigned to each cluster by the pattern vector clustering unit 403. The pattern designation 40612 stores the designation assigned to each cluster by the analyst for ease of understanding. The pattern designation 40612, in its initial state, stores the pattern IDs. The average vector 406013 stores the average vectors of the pattern vectors belonging to the cluster. The representative pattern vector 40614 stores the pattern vectors representing the clusters. The representative pattern vector 40614 is a vector for display to the analyst which represents the feature of the cluster. The representative pattern vectors are generated by the same sequence as the sequence in which the scene vector clustering unit 203 generates the representative vectors. The vector count 40615 stores the count of the pattern vectors belonging to the cluster. The pattern vector ID 40616 stores the IDs of the pattern vectors belonging to the cluster. The pattern vectors are stored in the pattern vector table 405.

### (Temporary Data: Extraction Condition 407)

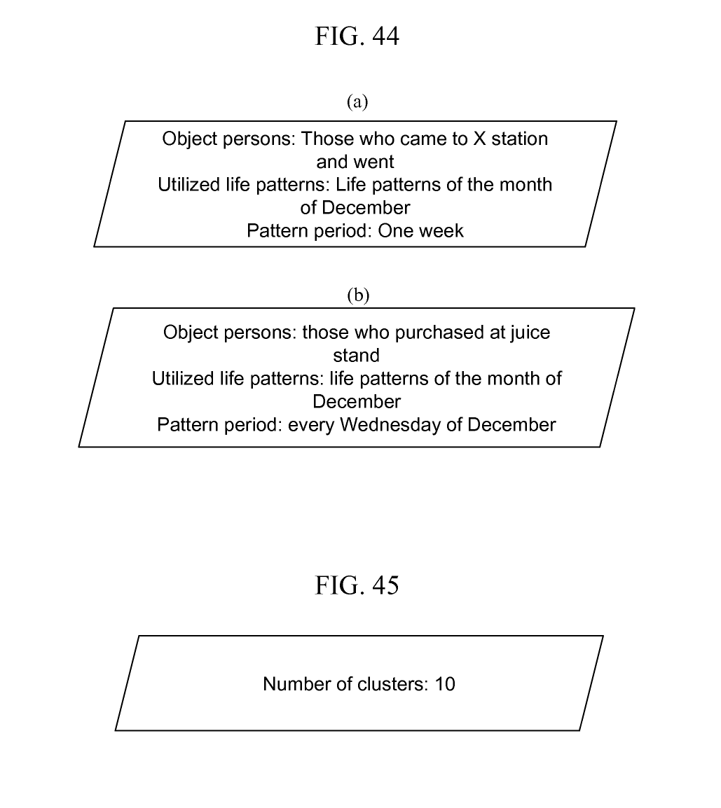

FIG. 44 illustrates an example of the extraction condition 407. The extraction condition 407 is temporary data of the pattern vector extraction conditions set by the analyst that have been stored by the periodic life pattern extraction unit 40.

### (Temporary Data: Extraction Parameter 408)

FIG. 45 illustrates an example of the extraction parameter 408. The extraction parameter 408 is temporary data of the pattern vector clustering conditions set by the analyst that have been stored by the periodic life pattern extraction unit 40.

### (Process Sequence)

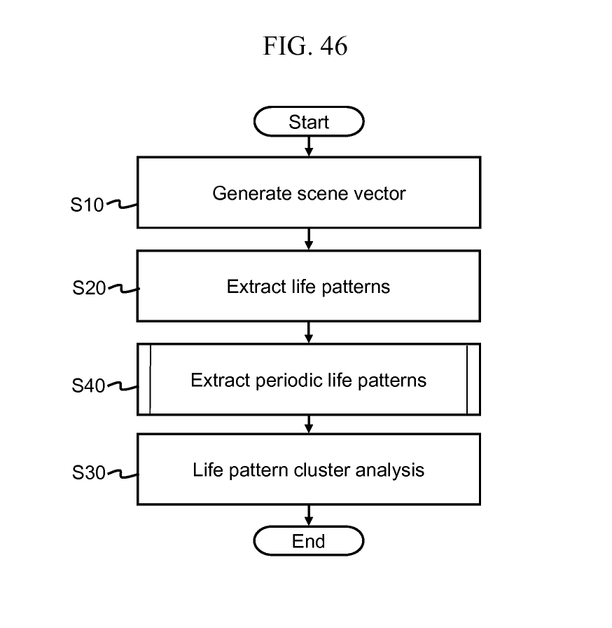

In the following, the process sequence of the behavioral characteristics analysis device 1 according to the present embodiment 2 will be described with reference to FIGS. 46 to 50.

### (Process Sequence: Overall Process Sequence)

FIG. 46 is a flow chart of the process sequence of the behavioral characteristics analysis device 1 according to the present embodiment 2. The scene vector generation in step S10 and the life pattern extraction in step S20 are similar to those according to embodiment 1, and therefore their description will be omitted. Between steps S20 and S30, step S40 is newly added.

In step S40, the behavioral characteristics analysis device 1 extracts the patterns in a period (arrangement of days) specified by the analyst, using the day's life patterns extracted in step S20. Then, the behavioral characteristics analysis device 1 generates the feature vectors of the analysis objects using the periodic life patterns extracted in step S40, and generate analysis object clusters by performing clustering (S30).

### (Process Sequence of the Periodic Life Pattern Extraction Unit 40)

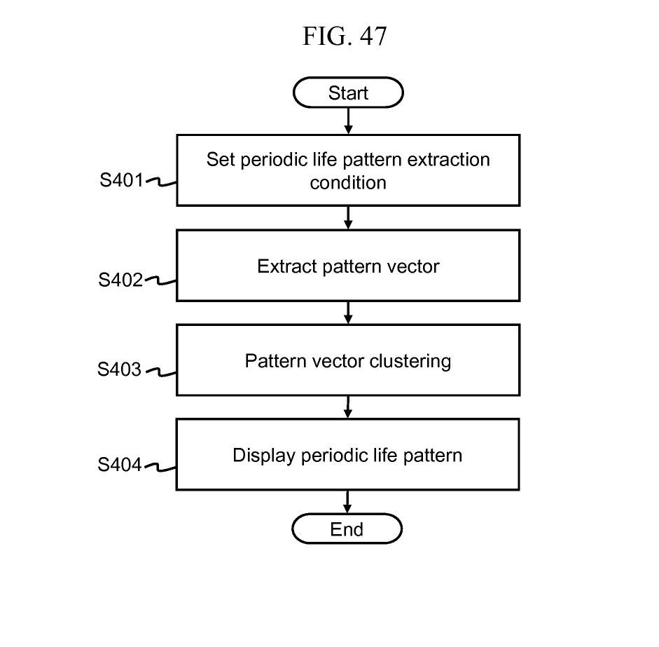

FIG. 47 is a flow chart of the process sequence of the periodic life pattern extraction unit 40. Hereafter, each step of FIG. 47 will be described.

### (FIG. 47: Step S401)

The pattern extraction condition setting unit 401 of the periodic life pattern extraction unit 40 sets conditions for extracting the pattern vectors as the objects of clustering that have been specified by the analyst, and clustering parameters, and delivers the extraction conditions to the pattern vector extraction unit 402 and the parameters to the pattern vector clustering unit 403.

(FIG. 47: step S402)

The pattern vector extraction unit 402 refers to the clustering result table 20610 using, as a key, the day's life pattern list IDs included in the delivered conditions, and acquires the IDs of the day's life patterns in an object period of the object persons matching the extraction conditions. The pattern vector extraction unit 402 then generates the pattern vectors and stores them in the pattern vector table 405, and delivers the table ID and the pattern vector extraction conditions to the pattern vector clustering unit 403.

### (FIG. 47: Step S403)

The pattern vector clustering unit 403 stores the delivered parameters, the ID of the pattern vector table, the pattern vector extraction conditions, and the date of clustering in the periodic life pattern list table 40600, acquires, using the ID of the pattern vector table as a key, the clustering object pattern vectors from the pattern vector table 405, performs clustering in accordance with the parameters, stores the result in the clustering result table 40610, and delivers the ID of the periodic life pattern list table 40600 to the periodic life pattern display unit 404.

### (FIG. 47: Step S404)

The periodic life pattern display unit 404 acquires, using the ID of the delivered periodic life pattern list table 40600 as a key, the periodic life pattern list table 40600 and the periodic life patterns generated from the clustering result table 40610, and displays them to the analyst.

### (Screen Example: An Example of the Periodic Life Pattern Extraction Condition Setting Screen in the Periodic Life Pattern Extraction Condition Setting Unit 401 of the Periodic Life Pattern Extraction Unit 40)

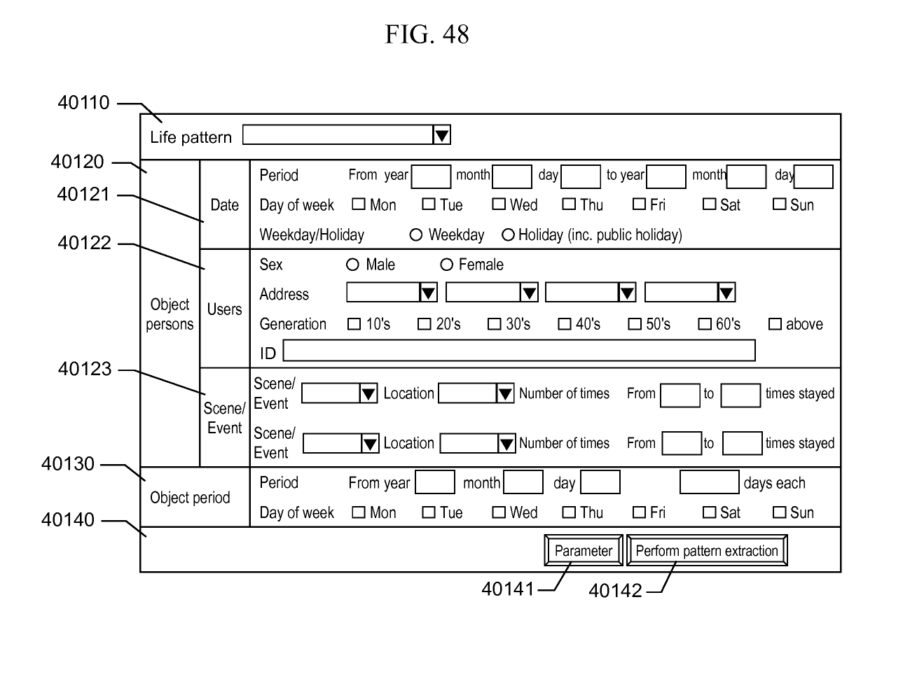

FIG. 48 illustrates an example of the periodic life pattern extraction condition setting screen in the pattern extraction condition setting unit 401. The periodic life pattern extraction condition setting screen includes a life pattern select area 40110, an object person setting area 40120, an object period setting area 40130, and an instruction button area 40140.

The life pattern select area 40110 is an area for selecting the life patterns used for periodic life pattern extraction. When the analyst selects one of the life patterns that have been extracted so far, the extraction conditions for the life pattern are displayed in the object person setting area 40120. During the periodic life pattern extraction, an analysis needs to be performed to see which life pattern the day of the object person in the object period matches. Thus, during the periodic life pattern extraction, the object persons that can be selected are limited to those within the object persons of which the day's life patterns have been extracted. When an analysis object is newly set, the target scene vector for the object person may be generated, and similarity to the life patterns that have already been extracted may be calculated and assigned. However, in the present embodiment 2, the object persons are limited as described above. The analyst sets the object persons for periodic life pattern extraction by narrowing the conditions displayed in the object person setting area 40120. When the displayed life pattern extraction conditions are used as they are, all of the object persons from which the life patterns have been extracted provide the object persons for periodic life pattern extraction. The object period is also limited to within the period of extraction of the life patterns selected by the analyst.

The analyst makes a setting in the object period setting area 40130 as to how many days' worth of the patterns are to be extracted and from when. Optionally, the day of the week may be selected. When the day of the week is selected, the pattern vectors are generated for only those days of the week that have been set as the objects in the set period.

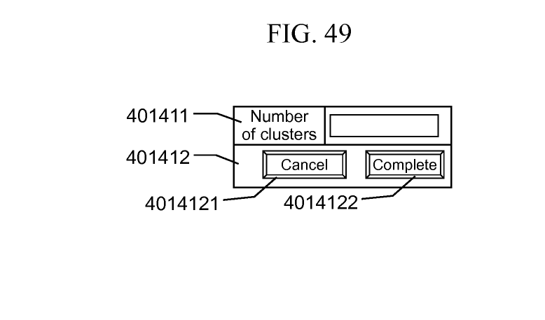

The instruction button area 40140 includes a parameter setting instruction button 40141 and a pattern extract perform button 40142. When the analyst clicks the parameter setting instruction button 40141, the behavioral characteristics analysis device 1 displays a parameter setting screen shown in FIG. 49. The analyst sets periodic life pattern extraction parameters in the parameter setting screen. When the analyst clicks the pattern extract perform button 40142, the behavioral characteristics analysis device 1 extracts the life patterns matching the conditions set in the life pattern select area 40110 and the object person setting area 40120, and generates clusters by performing clustering.

FIG. 49 illustrates an example of the parameter setting screen displayed when the parameter setting instruction button 40141 is clicked. The parameter setting screen includes a number of clusters setting area 401411 and an instruction button area 401412. When the analyst specifies the number of clusters in the number of clusters setting area 401411, the pattern vector clustering unit 403 clusters the feature vectors into the specified number of clusters. The instruction button area 401412 is an area for the analyst to instruct cancellation or completion of cluster setting, and includes a cancel button 4014121 and a complete button 4014122. Their operations are similar to those described with reference to FIG. 34.

### (Process Sequence: Detailed Process Sequence of the Pattern Vector Extraction Unit 402 in the Periodic Life Pattern Extraction Unit 40)

The process sequence of the pattern vector extraction unit 402 will be described. In the following description, it is assumed that the period condition in the periodic life pattern extraction conditions is the life pattern of a week (life pattern from Monday through Sunday).

First, IDs based on the similarity between patterns are assigned to the day's life patterns selected by the analyst in the periodic life pattern extraction conditions. While the scene vector clustering unit 203 utilizes the number of clusters automatically assigned by the algorithm as the pattern IDs, the pattern IDs are reassigned based on the similarity between the clusters. Specifically, the average vector of the cluster corresponding to each pattern (the average of the scene vectors belonging to the cluster) is acquired from the average vector 20613 in the life pattern table 206, its length is calculated, the patterns are sorted in order of decreasing value, and IDs starting from 1 are assigned in the order of the sorting results. Alternatively, an arbitrary one of the average vectors is selected, similarity (such as a Euclid distance) between the remaining vectors and the selected vector is calculated, the remaining vectors are sorted in order of decreasing value, and IDs starting from 1 are assigned in the order of the results (the first being the selected vector).

Then, using the reassigned pattern IDs, the pattern ID 20507 in the target scene vector table 205 is rewritten. Specifically, the list IDs of the target scene vectors are acquired from the target scene vector table ID 20604 in the life pattern table 206, the target scene vector table 205 corresponding to the list IDs are acquired, and the pattern ID 20507 in the target scene vector table 205 is rewritten to the reassigned ID. Then, the target scene vector table 205 is sorted using the user as a first key and the date as a second key.

The pattern extraction condition setting unit 401 implements the following process for each of the object persons that have been set. First, the users' scene vectors are divided into seven days in order of date, and vectors of 7 dimensions having the IDs (reassigned IDs) of the life patterns to which the scene vectors belong as characteristics values are generate and stored in the life pattern ID 40503 in the pattern vector table 405. When the period of scene vector extraction is not a multiple of 7, a remainder less than the seven days (7 dimensions) may be produced. In the present example, such remainders are disregarded. When there is a date having no corresponding scene vector, the value of the day is set to “0”.

### (Process Sequence: Detailed Process Sequence of the Pattern Vector Clustering Unit 403 in the Periodic Life Pattern Extraction Unit 40)

The pattern vector clustering unit 403 performs clustering by applying the k-means method to the pattern vectors stored in the pattern vector table 405, and stores the clustering result in the clustering result table 40610. Specifically, the cluster ID is stored in the value of the pattern ID 40611 in the clustering result table 40610, and the average vector of the pattern vectors belonging to the cluster is stored in the average vector 40613. In the representative vector 40614, the representative vector of the pattern vectors belonging to the cluster is stored. The representative vector generation sequence is similar to the representative vector generation sequence of the target scene vector clustering 20610 according to embodiment 1. Further, the number of the pattern vectors belonging to the cluster is stored in the vector count 40615, and the ID of the pattern vector is stored in the pattern vector ID 40616. Further, using the IDs of the pattern vectors belonging to the cluster as keys, the pattern vector table 405 is referenced, and the pattern ID is set in the life pattern ID 40503 of the record with the value in the pattern vector ID 40501 corresponding to the pattern vector ID. The number of clusters in the clustering is the number of clusters set in the pattern extraction condition setting unit 401 (or 10 if not set).

### (Process Sequence: Detailed Process Sequence of the Periodic Life Pattern Display Unit 404 in the Periodic Life Pattern Extraction Unit 40)

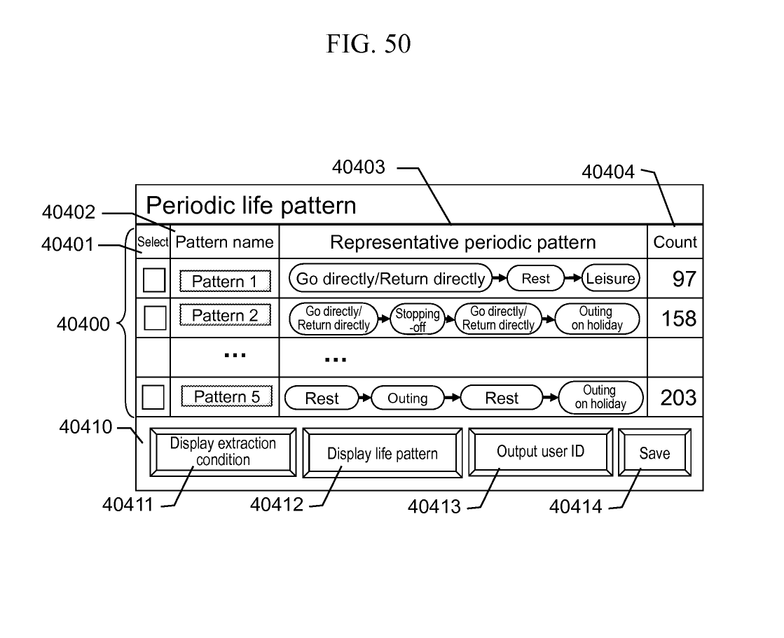

FIG. 50 illustrates an example of a screen presented to the analyst in which the generated cluster is expressed as a transition of the day's pattern by the periodic life pattern display unit 404. The periodic life pattern display screen includes a periodic pattern display area 40400 and an instruction button area 40410.

The periodic pattern display area 40400 is an area for displaying the generate periodic life patterns, and includes a select check box 40401, a pattern name 40402, a representative period pattern 40403, and a count 40404. The select check box 40401 is a check box for the analyst to select a cluster when “user ID output” is performed. The pattern name 40402 is an area for displaying the pattern name. The pattern name displays the value stored in the pattern designation 40612 in the clustering result table 40610 of the periodic life pattern table 406. When the analyst has not assigned designations to the clusters, automatically assigned character strings, such as “pattern 1”, “pattern 2”, and so on are displayed. The character strings may be arbitrarily rewritten by the analyst. For example, in FIG. 50, “pattern 1” is a “weekday work/holiday leisure pattern”, and “pattern 2” is a “weekday stopping-off/holiday going-out pattern”. The representative period pattern 40403 displays the periodic life pattern characterizing the cluster. Specifically, the life pattern ID stored in the pattern ID 40611 of the clustering result table 40610 is acquired, the clustering result table 20610 is searched using the life pattern ID as a key, the pattern designation 20612 corresponding to the life pattern is acquired, and the transition diagram of the day's life patterns shown in FIG. 50 is generated using the representative pattern vector 40614 and displayed. The count 40404 displays the number of the pattern vectors belonging to the cluster. The number of the pattern vectors is acquired from the vector count 40615 in the clustering result table 40610. The periodic life pattern extraction unit 40 generates the pattern vectors on a user by user basis. Thus, the number of the pattern vectors is the number of the users belonging to the cluster.

The instruction button area 40410 includes an extraction condition display instruction button 40411, a life pattern display instruction button 40412, a user ID output instruction button 40413, and a save instruction button 40414. The extraction condition display instruction button 40411 is a button for the analyst to instruct the display of the conditions set by the pattern extraction condition setting unit 401. When the analyst clicks the button, the periodic life pattern display unit 404 displays the periodic life pattern extraction setting screen shown in FIG. 48, and presents the setting conditions for periodic life pattern extraction to the analyst. The life pattern display instruction button 40412 is a button for the analyst to instruct the display of the life patterns used as the periodic life patterns. When the analyst clicks the button, the periodic life pattern display unit 404 acquires the life pattern list ID 40604 in the periodic life pattern table 406, refers to the life pattern list ID 20601 of the life pattern table 206, acquires the list of corresponding day's life patterns, and displays the life patterns on the day's life pattern display screen shown in FIG. 30. The user ID output instruction button 40413 is a button for instructing the file output of the IDs of the users matching the patterns selected by the analyst. When the analyst selects the pattern in the select check box 40401 and clicks the user ID output instruction button 40413, the periodic life pattern display unit 404 refers to the periodic life pattern table 406, acquires the selected pattern vector ID 40616, refers to the pattern vector ID 40501 in the pattern vector table 405, acquires the corresponding user ID 40502, and outputs the user ID in a file. In this way, the periodic life patterns can be extracted using the users of the output IDs as the objects and under another condition. The save instruction button 40414 is a button for the analyst to instruct saving of the patterns assigned with easy-to-understand designations.

### Embodiment 2

### Conclusion

As described above, the behavioral characteristics analysis device 1 according to the present embodiment 2 can further extract, from the day's life patterns included in the set of persons, life patterns over a certain period, and then analyze the analysis objects using the extracted life patterns.

### Embodiment 3

In embodiment 3 of the present invention, a configuration example will be described that includes a content deliver function where the analyst analyzes the users' behavioral characteristics, the users or locations for which the effect of a content to be delivered can be expected are selected, and the content is delivered. The hardware configuration of the behavioral characteristics analysis device 1 is the same as that of embodiment 1, and therefore its description will be omitted.

### (Overall Configuration of System)

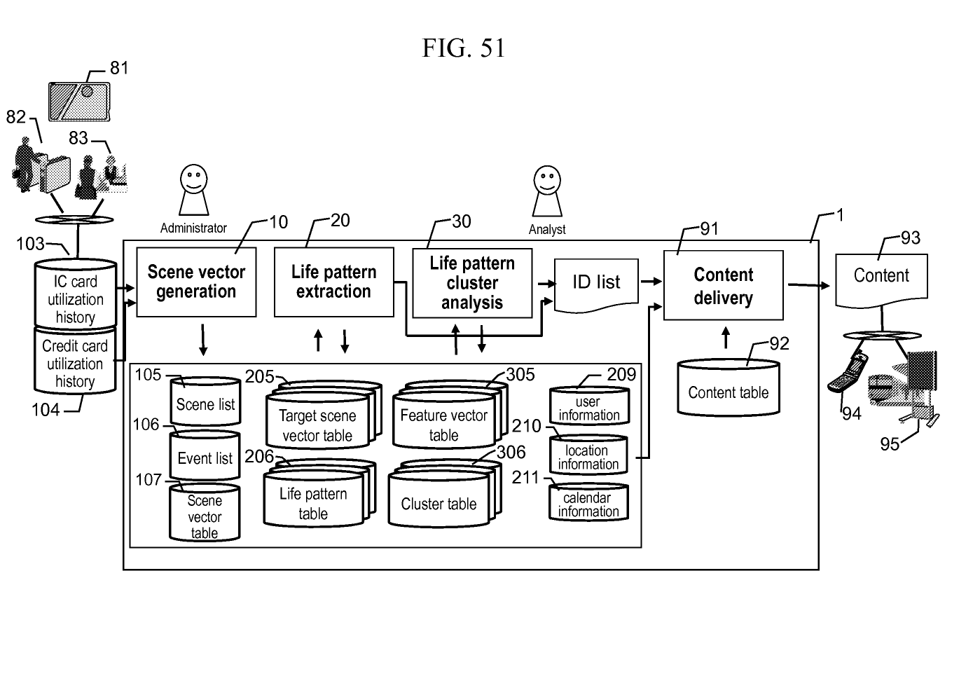

FIG. 51 illustrates an overall configuration of the behavioral characteristics analysis device 1 according to the present embodiment 3. The behavioral characteristics analysis device 1 according to the present embodiment 3 largely includes the next four functions, namely: a scene vector generation unit 10; a life pattern extraction unit 20; a life pattern cluster analysis unit 30; and a content delivery unit 91. The scene vector generation unit 10, the life pattern extraction unit 20, and the life pattern cluster analysis unit 30 are similar to those of embodiment 1, and therefore their detailed description will be omitted.

The content delivery unit 91 delivers a content selected by the analyst with respect to the IDs of the users or locations extracted by the life pattern extraction unit 20 or the life pattern cluster analysis unit 30. The content table 92 is data storing the content for delivery. The content 93 is data transmitted to a portable telephone 94 of a user or a digital signage 95 at a station. The data is displayed by these devices, and may include shop advertisements within the station premises, or local information about the station's neighborhood. The portable telephone 94 is a portable telephone of the user of the transit-system IC card, and its e-mail address is stored in the e-mail 20907 of the user information 209. The digital signage 95 is an information providing device installed at the station or a public facility, and its installed location is tied with the location stored in the location information 210. Namely, when the content 93 is transmitted to the e-mail 21006 stored in the location information 210, the content is displayed on the digital signage installed at the location.

### (Process Sequence)

The process sequence of the behavioral characteristics analysis device 1 according to the present embodiment 3 will be described. The scene vector generation unit 10 generates scene vectors in advance by using the IC card utilization history 103 and the credit card utilization history 104 in which the user's behavior history is accumulated. Then, the life pattern extraction unit 20 extracts the scene vectors matching the conditions specified by the analyst and performs clustering, thus extracting life patterns. The life pattern cluster analysis unit 30 generates a feature vector of the analysis objects using the extracted life patterns, and generates clusters of the analysis objects by performing clustering. When the analyst, based on the result of processing by the life pattern extraction unit 20 or the life pattern cluster analysis unit 30, has discovered a user or location to which content is to be delivered, the ID of the user or location is output to an appropriate file or the like in the form of an ID list. The content delivery unit 91 transmits the content to the portable telephone 94 of the user corresponding to the ID, or to the digital signage 95 at the location corresponding to the ID.

For example, the life pattern cluster analysis unit 30 outputs the ID list of the user IDs of females in their 20's to 30's having, as a main life pattern, a “stopping-off pattern” such that they stop off at the x station on their way home from work. In this case, the content delivery unit 91 acquires the mail addresses corresponding to the user IDs from the user information 209. When the analyst specifies, from the content table 92, the content of an advertisement for a shop (such as a general store) for young females that has newly opened in the station building of the x station, the content delivery unit 91 delivers the content to the mail address.

### Embodiment 3

### Conclusion

As described above, the behavioral characteristics analysis device 1 according to the present embodiment 3 can deliver the content suitable for the user or location on the basis of the result of life pattern analysis.

While the invention by the present inventors has been specifically described with reference to the embodiments, the present invention is not limited to the embodiments. It should be obvious that various modifications may be made without departing from the scope of the invention. For example, the configuration of an embodiment may be combined with, or replaced by, the configuration of another embodiment.

The respective configurations, functions, process units, or the like may be entirely or partly implemented by hardware by, for example, being designed in the form of an integrated circuit, or they may be implemented by software by having a processor perform programs for realizing their respective functions. Information about the programs, tables, and the like for realizing the functions may be stored in storage devices such as a memory or a hard disk, or in storage media such as an IC card or a DVD.

### REFERENCE SIGNS LIST

1 behavioral characteristics analysis device
10 scene vector generation unit
20 life pattern extraction unit
30 life pattern cluster analysis unit
40 periodic life pattern extraction unit
91 content delivery unit
92 content table
101 scene extraction unit
102 event extraction unit
103 IC card utilization history
104 credit card utilization history
105 scene list
106 event list
107 scene vector table
201 pattern extraction condition setting unit
202 scene vector extraction unit
203 scene vector clustering unit
204 life pattern display unit
205 target scene vector table
206 life pattern table
207 extraction condition
208 extraction parameter
209 user information
210 location information
211 calendar information
301 cluster analysis condition setting unit
302 feature vector generation unit
303 feature vector clustering unit
304 cluster display unit
305 feature vector table
306 cluster table
307 analysis condition
308 analysis parameter
309 analysis report
401 pattern extraction condition setting unit
402 pattern vector extraction unit
403 pattern vector clustering unit
404 periodic life pattern display unit

1. A behavioral characteristics analysis device comprising:
a scene extraction unit that extracts, from history data recording a behavior history of a group of persons, a scene in which a person belonging to the group of persons behaved;
a scene vector generation unit that expresses a transition of the scenes extracted by the scene extraction unit for each person as scene vectors having a time band of a day as an element number and a value representing the scene corresponding to the element number as an element value, and that stores scene vector data describing the scene vectors in a storage device;
a life pattern extraction unit that extracts a transition pattern of the scenes by clustering the scene vectors, thus extracting the transition pattern as a life pattern included in the group of persons; and
a life pattern analysis unit that clusters analysis objects by characterizing the analysis objects by the frequency of appearance of the life pattern in the history data in association with the analysis objects.

2. The behavioral characteristics analysis device according to claim 1, wherein the scene extraction unit estimates a purpose of the behavior history based on an occurrence location, an occurrence time band, and a duration of the behavior history described by the history data, so as to extract a scene corresponding to the purpose from the history data.

3. The behavioral characteristics analysis device according to claim 2, wherein:
the scene extraction unit, when the history data indicates an entry into a ticket gate of a station, extracts the behavior history immediately before the station entry as a scene indicating a presence of the person at home if the station entry is an initial station entry of the day, or extracts the behavior history immediately before the station entry as a scene indicating an outing of the person if the station entry is not the initial station entry of the day; and
when the scene indicating the outing of the person is extracted, if the behavior history immediately before the station entry indicates a stay on a weekday at the same location for longer than a predetermined time, the scene is extracted as a scene indicating that the person was working, and if the behavior history immediately before the station entry indicates a stay on a day other than a weekday at the same location for longer than the predetermined time, the scene is extracted as a scene indicating that the person was out for pleasure.

4. The behavioral characteristics analysis device according to claim 1, wherein the scene vector generation unit, when assigning a value that can be used as a value representing the scene as the element value of the scene vector, implements the assigning such that a distance between the scenes on a vector space has a magnitude in accordance with the frequency of appearance or meaning of the scene.

5. The behavioral characteristics analysis device according to claim 1, wherein the life pattern extraction unit, upon reception of an instruction to extract the life patterns that include a specific scene, extracts the life patterns only from those of the scene vectors that include the specific scene.

6. The behavioral characteristics analysis device according to claim 1, wherein the life pattern extraction unit, upon reception of an instruction to extract the life patterns suitable for a specific analysis purpose, converts the element value of a part of the elements of the scene vectors that matches the analysis purpose into a value different from the other element values of the scene vectors belonging to the same life patterns.

7. The behavioral characteristics analysis device according to claim 6, wherein the life pattern extraction unit extracts the scene vectors after the conversion and the scene vectors belonging to the same life patterns before the conversion as mutually different life patterns.

8. The behavioral characteristics analysis device according to claim 1, wherein the life pattern extraction unit, upon reception of a request for a drill down extraction of the life patterns suitable for a specific analysis purpose, adds an additional characteristic corresponding to the analysis purpose to the scene vectors.

9. The behavioral characteristics analysis device according to claim 8, wherein the life pattern analysis unit, upon reception of an instruction to extract those of the scene vectors belonging to the life patterns suitable for the specific analysis purpose after the clustering of the analysis objects, further extracts from the analysis objects after the clustering the scene vectors to which the additional characteristic corresponding to the analysis purpose is added.

10. The behavioral characteristics analysis device according to claim 1, wherein the life pattern extraction unit identifies the most typical transition of the scenes in the extracted life patterns, and outputs the transition for each of the life patterns in a visualized manner.

11. The behavioral characteristics analysis device according to claim 10, wherein:
the life pattern extraction unit refers to the vectors representing the transition of the scenes belonging to a cluster generated by the clustering, and selects one of the scenes in each time band in the cluster that has the highest frequency as a typical scene in the cluster in the time band;
the life pattern extraction unit generates, as a feature of the cluster, the scene vector having a value representing the typical scene as the element value corresponding to the time band; and
the life pattern analysis unit clusters the analysis objects by characterizing the analysis objects by the frequency of matching of the analysis objects with the feature of the cluster in the history data.

12. The behavioral characteristics analysis device according to claim 1, wherein:
the life pattern extraction unit further clusters, from the extracted life patterns, an arrangement of the day's life patterns of the set of persons in a certain period so as to extract a typical life pattern of the set of persons in the period as a periodic life pattern; and
the life pattern analysis unit clusters the analysis objects by characterizing the analysis objects with a frequency of appearance of the periodic life pattern in association with the analysis objects in the history data.

13. The behavioral characteristics analysis device according to claim 1, comprising a content delivery unit that delivers content information corresponding to the life pattern to a location corresponding to the life pattern.

14. A behavioral characteristics analysis method comprising:
a scene extracting step of extracting scenes from history data recording a behavior history of a group of persons;
a step of expressing a transition, for each person, of the scenes extracted in the scene extracting step as a scene vector having a time band of a day as an element number and a value representing the scene corresponding to the time band as an element value corresponding to the element number, and storing scene vector data describing the scene vector in a storage device;
a step of extracting a transition pattern of the scenes by clustering the scene vectors, thereby extracting the transition pattern as a life pattern of the group of persons; and
a step of clustering analysis objects by characterizing the analysis objects with a frequency of appearance of the life pattern in association with the analysis objects in the history data.
